(19) United States
(12) Patent Application Publication
(10) Pub. No.: US 2026/0079514 A1
(43) Pub. Date: Mar. 19, 2026

(54) LOW-DROPOUT VOLTAGE CONTROL WITH ADAPTABLE LOAD SHARING

(71) Applicant: Texas Instruments Incorporated, Dallas, TX (US)

(72) Inventors: Divya Kaur, Delhi (IN); Sri Navaneethakrishnan Easwaran, Plano, TX (US); Angelo William Pereira, Allen, TX (US); Srinivasan Venkataraman, Irving, TX (US); Antti Veli Johannes Piila, Richardson, TX (US)

(21) Appl. No.: 18/886,287

(22) Filed: Sep. 16, 2024

(51) Int. Cl. G05F 1/575; G01R 19/00; G01R 19/10

(52) U.S. Cl. CPC G05F 1/575; G01R 19/0038; G01R 19/10

(57) ABSTRACT

Load sharing techniques for voltage regulators. In an example, the techniques may be implemented in an LDO voltage regulator configured to provide load sharing with a single driver for internal and external pass elements using a pair of variable voltage dividers to adjust the load sharing based on load current. In other examples, a calibrated voltage source can be used to replace one of the variable voltage dividers. Calibration circuitry and methodologies for determining the value of the calibrated voltage source are also described. In still other examples, a single variable voltage divider can be used, with no calibrated voltage source, by constraining the external pass element to be weaker than the internal pass element. In any such examples, the internal and external pass elements can be implemented, for instance, with either n-type or p-type power transistors, and with similar transistor technologies or diverse transistor technologies (e.g., FETs and BJTs).

### TECHNICAL FIELD

This description relates to linear voltage regulators, and more particularly, to low-dropout (LDO) voltage regulators.

### BACKGROUND

The direct current (DC) output voltage provided by a standard power supply to a load can vary due to any number of factors such as transient conditions, environmental conditions, and changing load conditions. In such cases, a linear voltage regulator can be coupled between the power supply and the load and used to provide a regulated DC output voltage to the load. In this manner, the output voltage of the linear voltage regulator remains unaffected by abrupt or otherwise transient changes in the input supply voltage and the load current. One type of linear regulator is a low-dropout (LDO) voltage regulator which generally includes a stable reference voltage (e.g., bandgap voltage reference), a differential amplifier (sometimes just called an amplifier), and a pass element (e.g., a field effect transistor, sometimes referred to as power FET or passFET). An LDO voltage regulator is a relatively simple and low-cost way to derive a low magnitude, stable power supply from an unregulated input supply voltage (such as a battery output). Responsive to the input supply voltage dropping below the dropout mode threshold voltage, the regulator enters dropout mode and ceases to regulate against further reductions in input supply voltage. So, during dropout mode, the output voltage generally equals the input supply voltage minus the voltage drop across the pass element. Dropout mode ends responsive to the input supply voltage ramping to a level that is above the dropout mode threshold. The circuitry of the LDO voltage regulator may be implemented within an integrated circuit chip. The pass element may be on-chip or external to the chip, and may be p-type or n-type. A number of non-trivial issues remain with LDO voltage regulators.

### SUMMARY

An example circuit includes an input voltage terminal, an output voltage terminal, a feedback voltage terminal, and an output signal terminal. The circuit further includes a pass element coupled between the input voltage terminal and the output voltage terminal, and having a control terminal. The pass element is an n-type pass element. The circuit further includes an error amplifier having a first amplifier input, a second amplifier input, and an amplifier output. The first amplifier input is coupled to a reference voltage terminal, and the second amplifier input is coupled to the feedback voltage terminal. The circuit further includes a load sharing circuit having an input, a first output, and a second output. The input of the load sharing circuit is coupled to the amplifier output. The first output of the load sharing circuit is coupled to the control terminal of the pass element, and the second output of the load sharing circuit is coupled to the output signal terminal.

Another example circuit includes an input voltage terminal, an output voltage terminal, a feedback voltage terminal, and an output signal terminal. The circuit further includes a pass element coupled between the input voltage terminal and the output voltage terminal, and having a control terminal. The pass element is an n-type pass element. The circuit further includes an error amplifier configured to generate an error amplifier output voltage based on a feedback voltage at the feedback voltage terminal and a reference voltage. The circuit further includes a first impedance divider including a first variable impedance and configured to generate a first drive voltage at the control terminal of the pass element, based on the error amplifier output voltage. The circuit further includes a second impedance divider including a second variable impedance and configured to generate a second drive voltage at the output signal terminal, based on the error amplifier output voltage.

An example system includes a first n-type pass element coupled between an input voltage terminal and an output voltage terminal, and having a control terminal. The system further includes a second n-type pass element coupled between the input voltage terminal and the output voltage terminal, and having a control terminal. The system further includes an error amplifier having a first amplifier input, a second amplifier input, and an amplifier output. The first amplifier input is coupled to a reference voltage terminal, and the second amplifier input is coupled to a feedback voltage terminal. The system further includes a first impedance divider coupled between the amplifier output and a ground terminal, and including an output coupled to the control terminal of the first n-type pass element. The first impedance divider further includes a first variable impedance coupled between the output of the first impedance divider and the ground terminal. The system further includes a second impedance divider coupled between the amplifier output and the ground terminal, and including an output coupled to the control terminal of the second n-type pass element. The second impedance divider further includes a second variable impedance coupled between the amplifier output and the output of the second impedance divider.

Another example circuit includes an input voltage terminal, an output voltage terminal, a feedback voltage terminal, and an output signal terminal. The circuit further includes a pass element coupled between the input voltage terminal and the output voltage terminal, and having a control terminal. The pass element is a p-type pass element. The circuit further includes an error amplifier having a first amplifier input, a second amplifier input, and an amplifier output. The first amplifier input is coupled to a reference voltage terminal, and the second amplifier input is coupled to the feedback voltage terminal. The circuit further includes a load sharing circuit having an input, a first output, and a second output. The input of the load sharing circuit is coupled to the amplifier output. The first output of the load sharing circuit is coupled to the control terminal of the pass element, and the second output of the load sharing circuit is coupled to the output signal terminal.

Another example circuit includes an input voltage terminal, an output voltage terminal, a feedback voltage terminal, and an output signal terminal. The circuit further includes a pass element coupled between the input voltage terminal and the output voltage terminal, and having a control terminal. The pass element is a p-type pass element. The circuit further includes an error amplifier configured to generate an error amplifier output voltage based on a feedback voltage at the feedback voltage terminal and a reference voltage. The circuit further includes a first impedance divider including a first variable impedance and configured to generate a first drive voltage at the control terminal of the pass element, based on the error amplifier output voltage. The circuit further includes a second impedance divider including a second variable impedance and configured to generate a second drive voltage at the output signal terminal, based on the error amplifier output voltage.

Another example system includes a first p-type pass element coupled between an input voltage terminal and an output voltage terminal, and having a control terminal. The system further includes a second p-type pass element coupled between the input voltage terminal and the output voltage terminal, and having a control terminal. The system further includes an error amplifier having a first amplifier input, a second amplifier input, and an amplifier output. The first amplifier input is coupled to a reference voltage terminal, and the second amplifier input is coupled to a feedback voltage terminal. The system further includes a first impedance divider and a second impedance divider. The first impedance divider is coupled between the amplifier output and the input voltage terminal, and includes an output coupled to the control terminal of the first p-type pass element. The first impedance divider further includes a first variable impedance coupled between the output of the first impedance divider and the input voltage terminal. The second impedance divider is coupled between the amplifier output and the input voltage terminal, and includes an output coupled to the control terminal of the second p-type pass element. The second impedance divider further includes a second variable impedance coupled between the amplifier output and the output of the second impedance divider.

Another example circuit includes an input voltage terminal, an output voltage terminal, and an output signal terminal. The circuit further includes an error amplifier having an amplifier output. The circuit further includes a pass element coupled between the input voltage terminal and the output voltage terminal, and having a control terminal and a threshold voltage. The circuit further includes a calibration circuit configured to determine the difference between the pass element threshold voltage and an external pass element threshold voltage.

Another example circuit includes an input voltage terminal, an output voltage terminal, a feedback voltage terminal, and an output signal terminal. an input voltage terminal. The circuit further includes a pass element coupled between the input voltage terminal and the output voltage terminal, and having a control terminal. The circuit further includes an error amplifier having a first amplifier input, a second amplifier input, and an amplifier output. The first amplifier input is coupled to a reference voltage terminal, and the second amplifier input is coupled to the feedback voltage terminal. The circuit further includes a load sharing circuit having an input, a first output, and a second output. The input of the load sharing circuit is coupled to the amplifier output, the first output of the load sharing circuit is coupled to the control terminal of the pass element, and the second output of the load sharing circuit is coupled to the output signal terminal. The load sharing circuit includes an impedance divider coupled between the amplifier output and one of a ground terminal or the input voltage terminal, the impedance divider having an output coupled to the first output of the load sharing circuit.

An example method includes a method for calibrating a voltage regulator system. The method includes: disabling a first pass element coupled between an input voltage terminal of the voltage regulator system and an output voltage terminal of the voltage regulator system. The method further includes generating a load current at the output voltage terminal, the load current passing through a second pass element coupled between the input voltage terminal and the output voltage terminal. The method further includes determining a voltage difference between a threshold voltage of the first pass element and a threshold voltage of the second pass element. The method further includes applying the voltage difference to a control terminal of the first pass element or a control terminal of the second pass element.

### BRIEF DESCRIPTION OF THE DRAWINGS

FIG. 1 is a block diagram of a circuit that includes a low-dropout (LDO) voltage regulator configured for load sharing, in an example.

FIGS. 2A-D each graphically depicts a load sharing scheme carried out by the LDO voltage regulator of FIG. 1, in an example.

FIG. 3 is a schematic diagram of an n-type LDO voltage regulator configured for load sharing, in an example.

FIG. 4 is a schematic diagram of an n-type LDO voltage regulator configured for load sharing, in another example.

FIGS. 5A-D each is a schematic diagram of an n-type LDO voltage regulator configured for load sharing, in another example.

FIG. 6 is a schematic diagram of an n-type LDO voltage regulator configured for load sharing, in another example.

FIG. 7 is a schematic diagram of a p-type LDO voltage regulator configured for load sharing, in an example.

FIG. 8 is a schematic diagram of a p-type LDO voltage regulator configured for load sharing, in another example.

FIGS. 9A-D each is a schematic diagram of a p-type LDO voltage regulator configured for load sharing, in another example.

FIG. 10 is a schematic diagram of a p-type LDO voltage regulator configured for load sharing, in another example.

FIG. 11 is a flow diagram of a method for load sharing in an LDO voltage regulator, in an example.

FIG. 12A is a schematic diagram of an n-type LDO voltage regulator configured for load sharing using a calibrated voltage source, in an example.

FIG. 12B is a schematic diagram of a p-type LDO voltage regulator configured for load sharing using a calibrated voltage source, in an example.

FIG. 13A is a flow diagram of a method for calibrating an LDO voltage regulator configured for load sharing, in an example.

FIG. 13B is a flow diagram of a method for determining the voltage difference between external and internal pass element threshold voltages for the method of FIG. 13A, in an example.

FIG. 14A is a schematic diagram of an n-type LDO voltage regulator configured for load sharing using a calibrated voltage source, the LDO voltage regulator in a calibration mode and including calibration circuitry configured to determine the value of the calibrated voltage source, in an example.

FIG. 14B is a schematic diagram of a p-type LDO voltage regulator configured for load sharing using a calibrated voltage source, the LDO voltage regulator in a calibration mode and including calibration circuitry configured to determine the value of the calibrated voltage source, in an example.

FIG. 14C is a flow diagram of a method for calibrating an LDO voltage regulator configured for load sharing as shown in FIGS. 14A-B, in an example.

FIG. 14D is a schematic diagram of an n-type LDO voltage regulator configured for load sharing using a calibrated voltage source, the LDO voltage regulator in a voltage regulation mode that employs the calibrated voltage source determined using the calibration circuitry of FIG. 14A, in an example.

FIG. 14E is a schematic diagram of a p-type LDO voltage regulator configured for load sharing using a calibrated voltage source, the LDO voltage regulator in a voltage regulation mode that employs the calibrated voltage source determined using the calibration circuitry of FIG. 14B, in an example.

FIG. 15 is a schematic diagram of calibration circuitry configured to determine the value of the calibrated voltage source, in another example.

FIG. 16 is a schematic diagram of an LDO voltage regulator configured for load sharing using a calibrated voltage source, in another example.

FIGS. 17A-C each is a schematic diagram of an LDO voltage regulator configured for load sharing using an external n-type pass element that is constrained with respect to an internal n-type pass element, in an example.

FIGS. 18A-C each is a schematic diagram of an LDO voltage regulator configured for load sharing using an external p-type pass element that is constrained with respect to an internal p-type pass element, in an example.

FIG. 19 is a block diagram of an electronic system that includes an LDO voltage regulator configured for load sharing, in an example.

### DETAILED DESCRIPTION

Load sharing techniques for linear voltage regulator applications are described herein. In an example, the techniques may be implemented in an LDO voltage regulator configured to provide load sharing with a single driver (error amplifier) for internal and external pass elements using a complementary pair of variable voltage dividers to auto adjust the load sharing based on load current. In other examples, a calibrated voltage source can be used to replace one of the variable voltage dividers. Calibration circuitry and methodologies for determining the value of the calibrated voltage source are also described herein. In still other examples, a single variable voltage divider can be used, with no calibrated voltage source, by constraining the external pass element to be weaker than the internal pass element. In any of these examples, the internal and external pass elements can be implemented, for instance, with either n-type or p-type power transistors, and with similar transistor technologies (e.g., FETs or BJTs) or diverse transistor technologies (e.g., FET and BJT). Many variations and configurations will be apparent in light of this disclosure.

### General Overview

As described above, a number of non-trivial issues remain with LDO voltage regulators. For example, the power dissipated in the passFET is proportional to the product of the load current and the difference between the input and output voltages (I_{LOAD}*[V_{IN}-V_{OUT}]), and may give rise in die temperature when the load current increases. The increased heat can damage the die, and thus sets an inherent current limit and/or necessitates thermal management. For example, one possible solution is to design the LDO voltage regulator to accommodate the higher current and higher thermal budget. For instance, a large on-chip passFET can be used, along with wider metal lines and a low thermal resistance junction-to-ambient package (low theta-JA, possibly in conjunction with heat sink). But such a solution increases chip area and leaves less thermal budget for other power modules in the circuitry. Another solution is to use an external passFET, which allows for an increase in the current carrying capability of the LDO voltage regulator, better (lower) on-resistance (e.g., RDSon of the external passFET), and a relatively wide range of user programmable load current. However, such regulators provide less flexibility, as they cannot be powered up without the external passFET connected. Also, such regulators suffer from low bandwidth, because the gate capacitance of the external passFET adds a pole, which in turn necessitates compensation. As such, external compensation componentry and/or high quiescent current is needed to push out the pole to higher frequencies, because a load tracking zero cannot be added. Still another solution might be to use parallel LDO voltage regulators, but such a solution would require a current balancing loop at the system level as well as the cost of multiple LDO voltage regulators.

Thus, LDO voltage regulator techniques are described herein for adaptively sharing load current between internal and external pass elements. In an example, an LDO voltage regulator is configured with an integrated or internal pass element that allows for start-up and low load current support in a stabile fashion. The LDO voltage regulator further includes load sharing circuitry (or circuit, used interchangeably) configured to adaptively transfer high load current to an external pass element. The load sharing circuitry receives a control or drive voltage from an error amplifier of the LDO voltage regulator, and generates a first control signal for controlling the internal pass element, and a second control signal for controlling the external pass element. In one such example, responsive to the load current being less than or equal to a first current threshold (referred to herein as I_{STB}, which represents the current level that the internal pass element can handle without any load sharing needed and with no stability issues), the load sharing circuitry is configured to cause all of the load current to be provided via the internal pass element. In this case, the external pass element (if present) can be held in its off state or otherwise disabled by the load sharing circuitry. Also, responsive to the load current being greater than I_{STB}, the load sharing circuitry is configured to cause a first portion of the load current to be provided via the internal pass element, and a second or remaining portion of the load current to be provided via the external pass element. Furthermore, responsive to the load current being greater than a second current threshold (referred to herein as I_{LIM_INT}, which represents the maximum current level that the internal pass element can safely handle), the load sharing circuitry is configured to limit the first portion of the load current provided by the internal pass element to I_{LIM_INT}, and to cause a second or remaining portion of the load current to be provided via the external pass element.

In some cases, each of the internal pass element and the external pass element is an n-type transistor device (e.g., NMOS power FET or NPN power BJT). In some other cases, each of the internal pass element and the external pass element is a p-type transistor device (e.g., PMOS power FET or PNP power BJT). In still other cases, the internal and external pass elements may be different transistor technologies, such as the example case where one of the internal and external pass elements is a power FET and the other one of the internal and external pass elements is a power BJT.

In any such cases, the load sharing circuitry may include a variable impedance divider that is configured to adaptively adjust the voltage at the control terminal of a given pass element, based on the load current. In some such cases, there is a first variable impedance divider having its output coupled to the control terminal of the internal pass element, and a second variable impedance divider having its output coupled to the control terminal of the external pass element (or otherwise coupled to a terminal that is couplable to the external pass element control terminal). The variable impedance dividers can be controlled to cause the adaptive load sharing as described above and below.

In other cases, there may be only one variable impedance divider. In one such example case, the variable impedance divider has its output coupled to the control terminal of the internal pass element, and the control terminal of the external pass element can be coupled directly to the error amplifier output (or otherwise without an intervening impedance divider). Because one of the internal or external pass elements may be stronger than the other one, one of the pass elements will conduct more (or less) current than the other one, without some further intervention. Thus, and according to an example, a voltage source configured to compensate for the difference in strength between the internal and external pass elements can be applied to one of the pass elements, thus allowing the internal and external pass elements to be controlled so as to cause the adaptive load sharing as variously described herein. In some such examples, a calibration circuit may be used to determine the difference between the internal pass element threshold voltage and the threshold voltage of a given external pass element. The determined voltage difference can then be applied (e.g., as a voltage source) to the control terminal of the internal or external pass element, to compensate for the strength difference. Alternatively, if the internal pass element is constrained to be stronger than the given external pass element, then no such calibration or voltage source is needed.

The techniques described herein may provide a number of advantages or benefits. For instance, an LDO voltage regulator configured for load sharing between internal and external pass elements as variously described herein may provide low quiescent current, because the external pass element need not carry any current below the stability current (I_{STB}) threshold. Moreover, bandwidth is improved at such lower load currents, as the gate capacitance of the external pass element is not engaged. Additionally, the voltage regulator can start-up and support light loads, without needing any external pass element to be connected. Furthermore, the voltage regulator need not be configured internally for high temperature (thus saving die area and reducing need for thermal management), as higher load currents can be handled by the external pass element. Numerous variations and configurations will be apparent based on the example embodiments described herein.

### Circuit Architecture

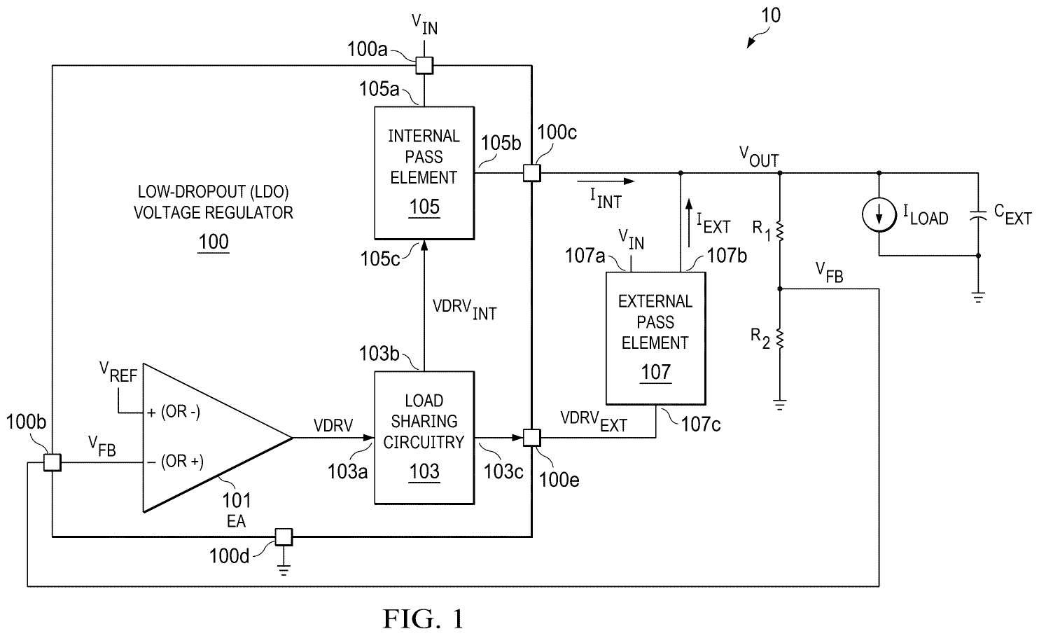

FIG. 1 is a block diagram of a circuit 10 that includes a low-dropout (LDO) voltage regulator 100 configured for load sharing, in an example. As shown, voltage regulator 100 includes an error amplifier (EA) 101, load sharing circuitry 103, and an internal pass element 105, all of which may be populated on a given substrate, such as on or otherwise part of an integrated circuit die within an integrated circuit package (e.g., ceramic flat pack with leads, dual in-line, ball grid array, pin grid array, land grid array, leaded chip carrier, quad flat no lead, to name a few examples), or on or otherwise part of a printed circuit board (e.g., single-sided, double-sided, multilayer, flex, to name a few examples), or on or otherwise part of any other suitable substrate upon which circuitry may be formed and/or populated. As further shown, each of an external pass element 107, a resistor network including R₁ and R₂, and an output capacitor C_{EXT} are operatively coupled to voltage regulator 100. Pass element 107 is referred to as external pass element 107, because it is external to voltage regulator 100 (e.g., external to the integrated circuit package of regulator 100). Resistors R₁ and R₂ and/or output capacitor C_{EXT} may also be external to regulator 100 as shown, but in other examples may be integrated within regulator 100. Each of internal pass element 105 and external pass element 107 is coupled between the input voltage terminal and the output voltage terminal, and includes a control terminal. An electronic system to be powered may also be coupled to the output voltage terminal, represented here as load current I_{LOAD}. The electronic system may be configured to suit any number of applications (e.g., automotive systems, computing systems, communications systems, gaming systems, household appliances and consumer electronic systems, mobile electronic systems such as smartphones, or any other application that utilizes regulated power). Other examples of circuit 10 may include additional componentry not shown and/or be configured differently.

In more detail, voltage regulator 100 receives an input voltage V_{IN} at an input voltage terminal 100a and a feedback voltage V_{FB} at a feedback voltage terminal 100b, and provides a regulated output voltage V_{OUT} at an output voltage terminal 100c. The resistor network including R₁ and R₂ is coupled between the output voltage terminal 100c and a ground terminal 100d, and provides V_{FB}. Error amplifier 101 receives V_{FB} at one of its input terminals, and a reference voltage (V_{REF}) at its other input terminal, and provides a drive voltage (VDRV) at its output. V_{FB} is a scaled down version the voltage at the output voltage terminal. V_{REF} can be generated, for example, by a bandgap voltage reference or other stable voltage source, and may be integrated with voltage regulator 100, or coupled thereto. As further shown in FIG. 1, internal pass element 105 has its first and second current terminals 105a and 105b (e.g., source/drain terminals for a FET pass element, or emitter/collector terminals for a BJT pass element) coupled to terminals 100a and 100c of voltage regulator 100, respectively; and external pass element 107 has its first and second current terminals 107a and 107b (e.g., source/drain terminals for a FET pass element, or emitter/collector terminals for a BJT pass element) coupled to terminals 100a and 100c of voltage regulator 100, respectively. Load sharing circuitry 103 receives VDRV at its input terminal 103a and is configured to generate a first drive voltage VDRV_{INT} and a second drive voltage VDRV_{EXT} at its first output terminal 103b and its second output terminal 103c, respectively. As further shown, the first drive voltage VDRV_{INT} is applied to the control terminal 105c of internal pass element 105, and the second drive voltage VDRV_{EXT} is applied to an output signal terminal 100e of voltage regulator 100, which is in turn coupled to the control terminal 107c of external pass element 107.

For purposes of clarity and reducing figure clutter, some of the numerical reference labels used in FIG. 1 are not repeated in subsequent figures. More generally, reference labels used in one figure may not be used in another figure, but may still be applicable. This Detailed Description may refer to descriptive phrases rather than the corresponding numerical label, as further detailed in Table 1. Similar expressions not listed in Table 1, but that convey the same meaning, may also be used.

TABLE 1
Numerical Reference Label and Corresponding Descriptive Phrases Index

| Numerical label | Corresponding descriptive phrases that may be used instead |
|---|---|
| 100a | input voltage terminal, or V_{IN} terminal, or V_{IN} node |
| 100b | feedback voltage terminal, or V_{FB} terminal, or V_{FB} node |
| 100c | output voltage terminal, or V_{OUT} terminal, or V_{OUT} node |
| 100d | ground terminal, ground node, or ground, or V_{RTN} |
| 100e | output signal terminal of voltage regulator, or VDRV_{EXT} terminal, or |
| | VDRV_{EXT} node |
| 103a | load sharing circuitry 103 (LSC) input terminal, or LSC input, or input of |
| | LSC, or VDRV input of LSC |
| 103b | 1^{st} LSC output terminal, or 1^{st} LSC output, or 1^{st} output of LSC, or |
| | VDRV_{INT} output of LSC |
| 103c | 2^{nd} LSC output terminal, or 2^{nd} LSC output, or 2^{nd} output of LSC, or |
| | VDRV_{EXT} output of LSC |
| 105a | 1^{st} current terminal of internal pass element 105/105n/105p (IPE), or 1^{st} |
| | terminal of IPE, or source terminal of IPE, or drain terminal of IPE, or |
| | emitter terminal of IPE, or collector terminal of IPE, or source of IPE, or |
| | drain of IPE, or emitter of IPE, or collector of IPE |
| 105b | 2^{nd} current terminal of IPE, or 2^{nd} terminal of IPE, or source terminal of |
| | IPE, or drain terminal of IPE, or emitter terminal of IPE, or collector |
| | terminal of IPE, or source of IPE, or drain of IPE, or emitter of IPE, or |
| | collector of IPE |
| 105c | control terminal of IPE, or gate terminal of IPE, or base terminal of IPE, |
| | or gate of IPE, or base of IPE |
| 107a | 1^{st} current terminal of external pass element 107/107n/107p (EPE), or 1^{st} |
| | terminal of EPE, or source terminal of EPE, or drain terminal of EPE, or |
| | emitter terminal of EPE, or collector terminal of EPE, or source of EPE, |
| | or drain of EPE, or emitter of EPE, or collector of EPE |
| 107b | 2^{nd} current terminal of EPE, or 2^{nd} terminal of EPE, or source terminal of |
| | EPE, or drain terminal of EPE, or emitter terminal of EPE, or collector |
| | terminal of EPE, or source of EPE, or drain of EPE, or emitter of EPE, or |
| | collector of EPE |
| 107c | control terminal of EPE, or gate terminal of EPE, or base terminal of |
| | EPE, or gate of EPE, or base of EPE |

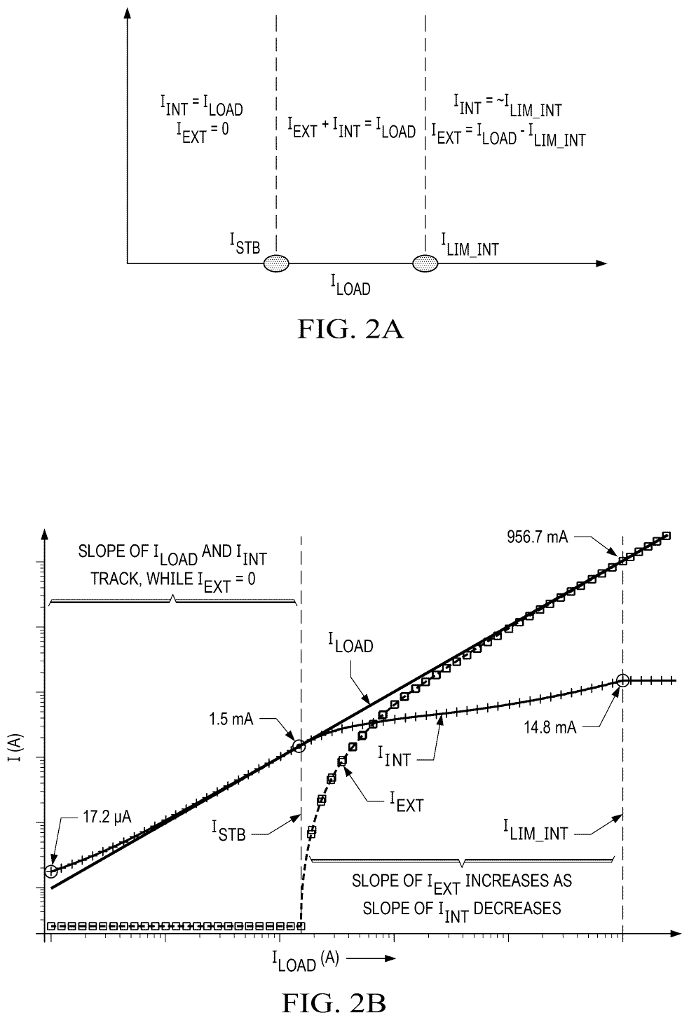

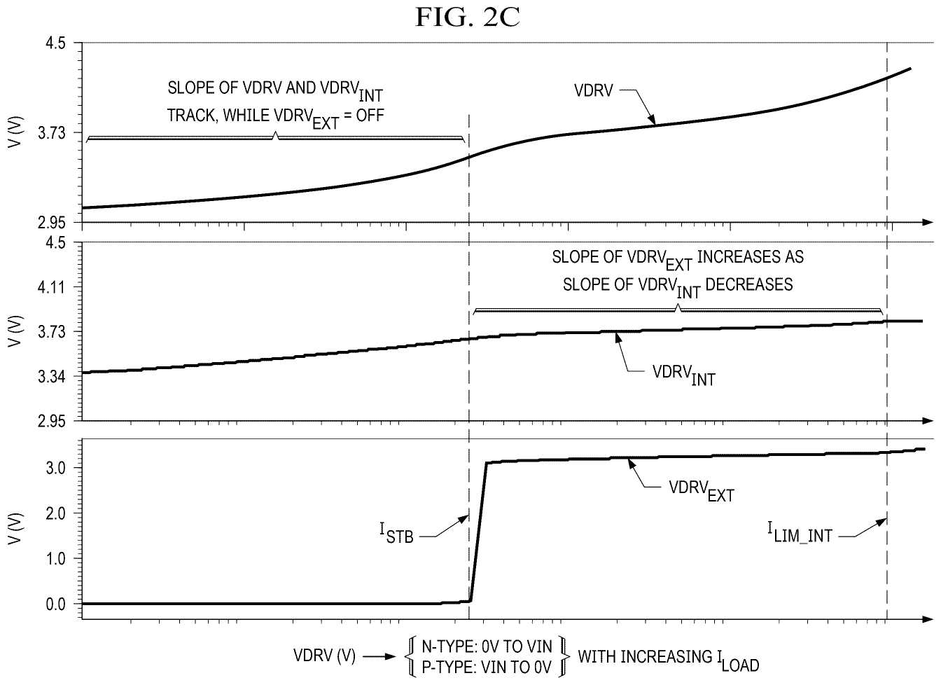

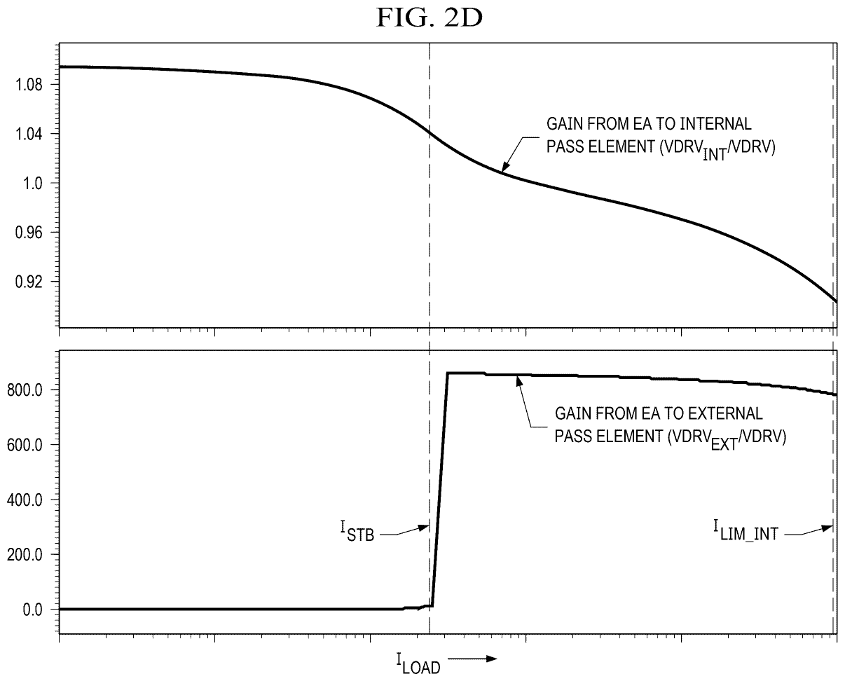

Load sharing circuitry 103 is configured to implement a load sharing scheme, based on the load current I_{LOAD}. FIGS. 2A-D graphically depict an example of one such load sharing scheme. With reference to FIGS. 1 and 2A, responsive to the load current I_{LOAD} being less than or equal to a first current threshold I_{STB}, load sharing circuitry 103 is configured to cause all (or substantially all) of the load current I_{LOAD} to be provided via internal pass element 105. Threshold I_{STB} can be fixed for a given application or may be user-configurable, and represents the current level that internal pass element 105 can handle without any load sharing needed and with no stability issues. In this case, external pass element 107 (when present) can be held in its off state or otherwise disabled by load sharing circuitry 103. For instance, in one such example case, load sharing circuitry 103 sets VDRV_{INT} to a value that fully turns on internal pass element 105, and sets VDRV_{EXT} to a value that fully turns off external pass element 107. In this state or mode of operation, the current I_{INT} provided by internal pass element 105 is equal (or substantially equal) to the load current I_{LOAD}, and the current I_{EXT} provided by external pass element 105 is equal (or substantially equal) to zero (e.g., I_{INT}=I_{LOAD}; I_{EXT}=0). As used in this context, the phrases “substantially all” and “substantially equal” refer to the possibility that small or otherwise acceptable amounts of load current I_{LOAD} may be leaked or otherwise sourced by external pass element 107 (e.g., less than 2% or 1% of I_{LOAD}). Different applications may have different amounts of such leakage current, or none.

With further reference to FIGS. 1 and 2A, responsive to the load current I_{LOAD} being greater than I_{STB}, load sharing circuitry 103 is configured to cause a first portion of the load current I_{LOAD} to be provided via internal pass element 105 (with this portion designated as I_{INT}), and a second or remaining portion of the load current I_{LOAD} to be provided via external pass element 107 (with this portion designated as I_{EXT}). For instance, in one such example case, load sharing circuitry 103 sets VDRV_{INT} to a value that partially turns on internal pass element 105 which in turn allows internal pass element 105 to pass I_{INT}, and sets VDRV_{EXT} to a value that partially turns on external pass element 107 which in turn allows external pass element 107 to pass I_{EXT}. In this state or mode of operation, the current I_{INT} provided by internal pass element 105 plus the current I_{EXT} provided by external pass element 105 is equal (or substantially equal) to the load current I_{LOAD} (e.g., I_{INT}+I_{EXT}=I_{LOAD}). As used in this context, the phrase “substantially equal” refers to the possibility that small or otherwise acceptable amount(s) of I_{INT} and/or TEXT may be leaked or otherwise not provided to the given load (e.g., less than 2% or 1% of I_{LOAD}). As described above, different applications may have or otherwise tolerate different parasitic scenarios and/or amounts of such leakage current, or have no such leakage current.

With further reference to FIGS. 1 and 2A, load sharing circuitry 103 is further configured to limit the current provided by internal pass element 105 to I_{LIM_INT}, and to cause any remaining portion of the load current I_{LOAD} to be provided via external pass element 107. Threshold I_{LIM_INT} can be fixed for a given application or may be user-configurable, and represents the maximum current level that the internal pass element 105 can safely handle. For instance, in one such example case, load sharing circuitry 103 limits VDR V_{INT} to a value which in turn limits the current passing through internal pass element 105 to I_{LIM_INT}, and sets VDRV_{EXT} to a value which in turn drives external pass element 107 to provide a remaining balance of the load current I_{LOAD}. In this state or mode of operation, the current I_{INT} passing through internal pass element 105 is equal (or substantially equal) to I_{LIM_INT}, and external pass element 105 provides a balance of the load current I_{LOAD} (e.g., I_{INT}=I_{LIM_INT}; I_{EXT}=I_{LOAD}-I_{LIM_INT}). As used in this context, the phrase “substantially equal” refers to the possibility that a small or otherwise acceptable deviation from I_{LIM_INT} may be tolerated (e.g., within 2% or 1% of I_{LIM_INT}). Also, I_{LIM_INT} may be provided with a built-in margin (e.g., 10 microamps to 100 microamps) that favors a current limit just below the actual maximum current rating, as indicated by the tilde. Different applications may have different margins and maximum currents.

FIG. 2B illustrates plots of the currents I_{INT}, I_{EXT}, and I_{LOAD}, according to some examples. As shown, when I_{LOAD} is less than I_{STB}, the slopes (rise/run) of the I_{LOAD} and I_{INT} plots substantially track with one another, as internal pass element 105 provides all of I_{LOAD} and external pass element 107 remains off (and thus, I_{EXT} is equal to zero, and the slope of the TEXT plot is zero or flat). After I_{LOAD} crosses the I_{STB} threshold, external pass element 107 begins to conduct and source a portion of I_{LOAD}, such that the slope of the TEXT plot increases as the slope of the I_{INT} plot decreases. As further shown in FIG. 2B, after I_{LOAD} crosses the I_{LIM_INT} threshold, the slope of the corresponding I_{INT} plot flattens out (goes to zero) and any further increase in I_{LOAD} is provided by way of I_{EXT}. This example shows that each of the currents I_{INT} and TEXT is associated with a rate of change relative to changes in load current I_{LOAD}, and that the rate of change of current I_{INT} decreases as the rate of change of current TEXT increases. Example current values are shown, with I_{LOAD} ranging from below 17.2 microamps (μA) to over 956.7 milliamps (mA), with I_{STB} set to about 1.5 mA, and I_{LIM_INT} set to about 15 mA. Other examples may have a different range of operation and/or different thresholds.

FIG. 2C illustrates plots of the voltages VDRV, VDRV_{INT}, and VDRV_{EXT}, according to some examples. As shown, when I_{LOAD} is less than I_{STB}, the slopes of the plots for the corresponding VDRV and VDR V_{INT} drive voltages substantially track with one another, as internal pass element 105 provides all of I_{LOAD} and external pass element 107 remains off (e.g., VDRV_{EXT} has a slope of zero and is equal to 0 volts for n-type, or V_{IN} for p-type). As I_{LOAD} increases past the I_{STB} threshold, and VDRV correspondingly increases in drive strength (e.g., away from 0 volts for n-type, and toward 0 volts for p-type), the slope of the VDRV_{EXT} plot increases as the slope of the VDRV_{INT} plot decreases. As further shown in FIG. 2C, after I_{LOAD} crosses the I_{LIM_INT} threshold, the slope of the corresponding VDRV_{INT} plot flattens out (goes to zero) and any further increase in I_{LOAD} is provided by way of an increase in drive strength of VDRV_{EXT}. This example shows that each of the drive voltages VDRV_{INT} and VDRV_{EXT} is associated with a rate of change relative to changes in VDRV generated by error amplifier 101, and that the rate of change of VDRV_{INT} decreases as the rate of change of VDRV_{EXT} increases. Example drive voltage ranges are shown for n-type and p-type pass elements, with n-type drive voltage ranging from 0 volts (full off state) to V_{IN} (full on state), and with p-type drive voltage ranging from V_{IN} (full off state) to 0 volts (full on state). Other examples may have a different range of operation and/or different thresholds.

FIG. 2D illustrates plots of the gain of the VDRV_{INT} path (from error amplifier 101 output to the control terminal of internal pass element 105, referred to as gain plot VDRV_{INT}/VDRV), and the gain of the VDRV_{EXT} path (from error amplifier 101 output to the control terminal of external pass element 107, referred to as gain plot VDRV_{EXT}/VDRV), according to some examples. As shown, when I_{LOAD} is less than I_{STB}, the plot for the gain of the VDRV_{EXT} path is flat or zero, as internal pass element 105 provides all of I_{LOAD} and external pass element 107 remains off. As I_{LOAD} increases past the I_{STB} threshold, the gain of the VDRV_{EXT} path increases as the gain of the VDRV_{INT} path decreases. This example shows that the gain from the error amplifier 101 output to the internal pass element 105 decreases as the gain from the error amplifier 101 output to the external pass element 107 increases, respectively, relative to increases in I_{LOAD} (or relative to increases in VDRV generated by error amplifier 101) once I_{LOAD} crosses the I_{STB} threshold, for at least a period of time.

In an example, the transition from internal pass element 105 only to load sharing between internal pass element 105 and external pass element 107 when the load current I_{LOAD} exceeds I_{STB} can be carried out in the analog domain. Likewise, any adaptive load sharing between internal pass element 105 and external pass element 107 when the load current I_{LOAD} is between I_{STB} and I_{LIM_INT}, or when the load current I_{LOAD} exceeds I_{LIM_INT}. can be carried out in the analog domain. For instance, in some such examples, load sharing circuitry 103 is configured with a pair of analog impedance dividers that allow for seamless adaptive and stable transfer of load current I_{LOAD} between internal pass element 105 and external pass element 107. Other examples may use only one analog impedance divider, in conjunction with a calibrated voltage source. Still other examples may use only one analog impedance divider, in conjunction with a constraint that internal pass element 105 be stronger than external pass element 107. Such examples are further described below. In any such cases, the analog-based load sharing schemes variously described herein are inherently stabile.

The output capacitor C_{EXT} can be any capacitor suitable for a given application. The internal and external pass elements 105 and 107 can be any suitable pass elements, such as n-type metal oxide semiconductor field effect transistors (NMOS FETs), p-type metal oxide semiconductor field effect transistors (PMOS FETs), n-type bipolar junction transistors (NPN BJTs), or p-type bipolar junction transistors (PNP BJTs). In some examples, internal and external pass elements 105 and 107 are different transistor technologies. For example, one of the internal and external pass elements 105 and 107 is a BJT, and the other of the internal and external pass elements 105 and 107 is a FET. In such a hybrid configuration, the two different transistors would be either p-type (e.g., PMOS and PNP) or n-type (e.g., NMOS and NPN). More generally, pass elements 105 and 107 can be implemented with any suitable transistor or pass element technology. The error amplifier 101 can be any suitable error amplifier circuit configured to provide a drive voltage for a pass element. The coupling of the inputs to error amplifier depend on the type of pass elements as well as internal configuration of error amplifier 101. For example, for a voltage regulator 100 having an n-type pass elements, V_{REF} can be applied to the non-inverting input (+), and V_{FB} can be applied to the inverting input (−) of error amplifier. These inputs can be reversed for a voltage regulator 100 having p-type pass elements (V_{REF} is applied to the inverting input and V_{FB} is applied to the non-inverting input). Also, if error amplifier 101 includes an odd number of inversion stages, then these above stated couplings may be reversed. Any error amplifier technology may be used.

N-Type LDO Voltage Regulator with Load Sharing Circuitry

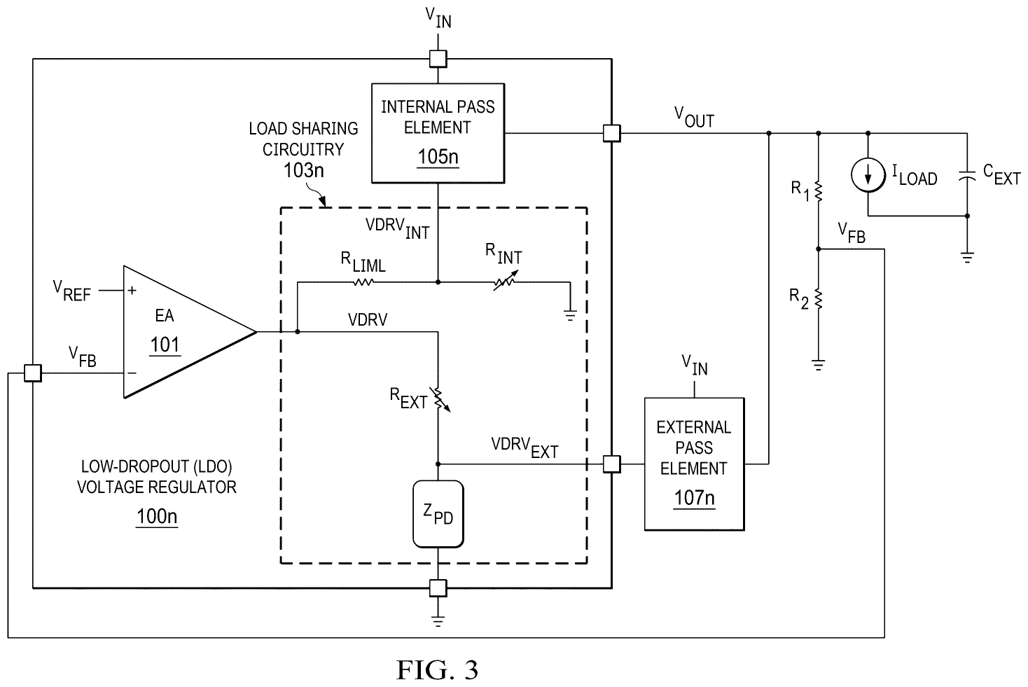

FIG. 3 is a schematic diagram of an n-type LDO voltage regulator 100n configured for load sharing, in an example. As shown, voltage regulator 100n is an example voltage regulator 100 of FIG. 1, where voltage regulator 100n is an n-type voltage regulator. In particular, voltage regulator 100n includes n-type load sharing circuitry 103n and an n-type internal pass element 105n, and is coupled with an n-type external pass element 107n. Other componentry, such as error amplifier 101, resistors R₁ and R₂, and capacitor C_{EXT} may be the same as described above with reference to FIG. 1. The above relevant description of FIGS. 1 and 2A-D is equally applicable here.

With further reference to the example of FIG. 3, V_{REF} and V_{FB} are applied to the non-inverting and inverting inputs, respectively, of the error amplifier 101, which in turn generates drive signal VDRV from those inputs. The V_{REF} and V_{FB} inputs may be reversed (V_{REF} and V_{FB} are applied to the inverting and non-inverting inputs, respectively), depending on how many inverting stages are configured within amplifier 101. Each of internal pass element 105n and external pass element 107n may be, for instance, any kind of an n-type power transistor, such as an NMOS FET, a gallium nitride (GaN) FET, or an NPN BJT, or any other type of power device suitable for an n-type pass element. The pass element configuration may be homogeneous or a hybrid configuration. An example homogeneous pass element configuration is, for instance, where both internal pass element 105n and external pass element 107n are NMOS FETs. An example hybrid pass element configuration is, for instance, where one of internal pass element 105n and external pass element 107n is an NMOS FET and the other is an NPN BJT.

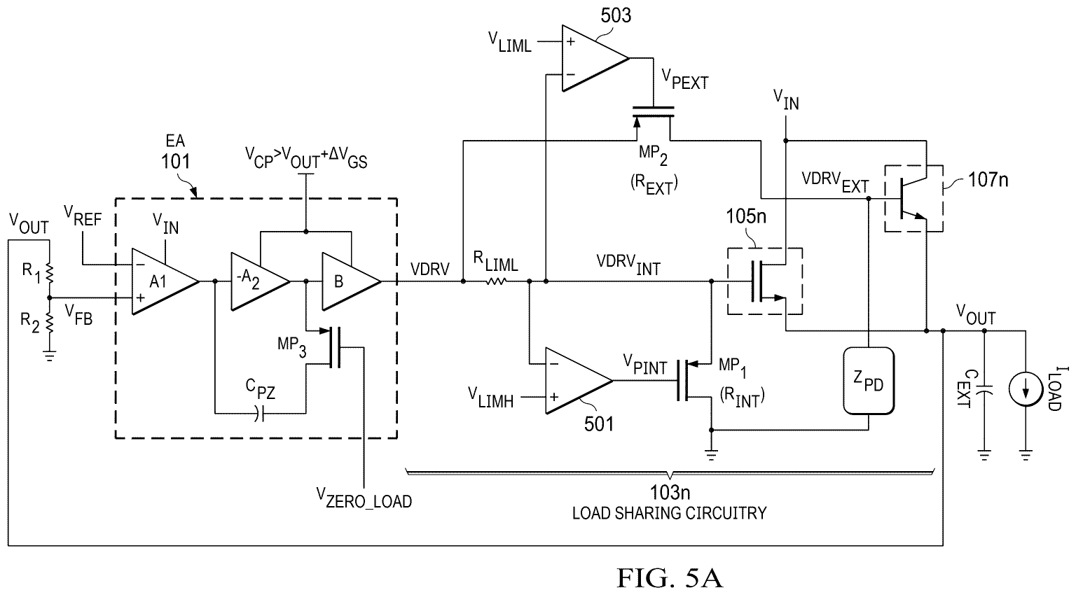

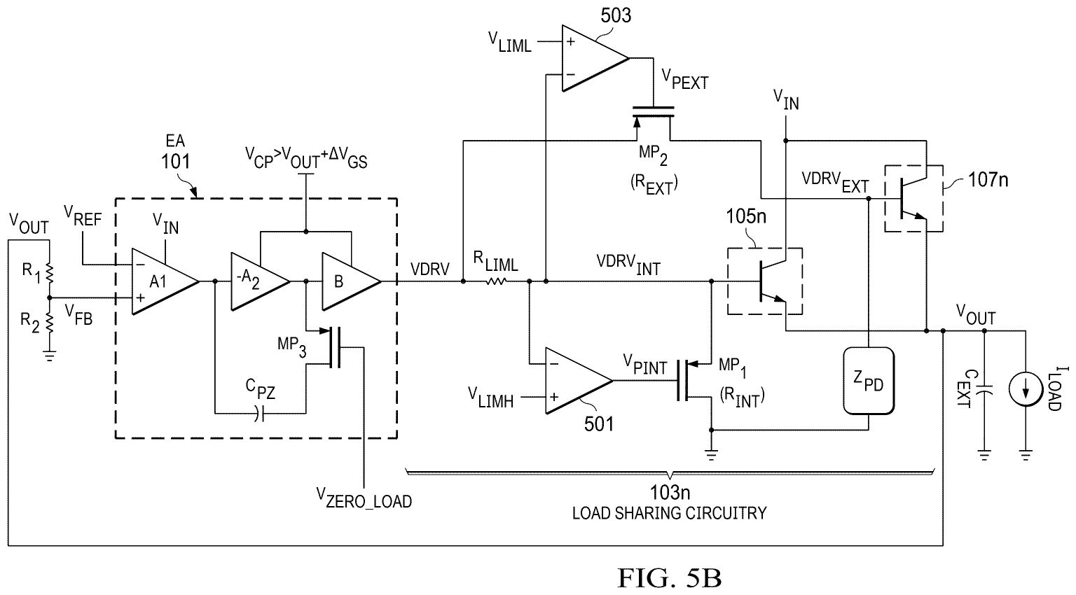

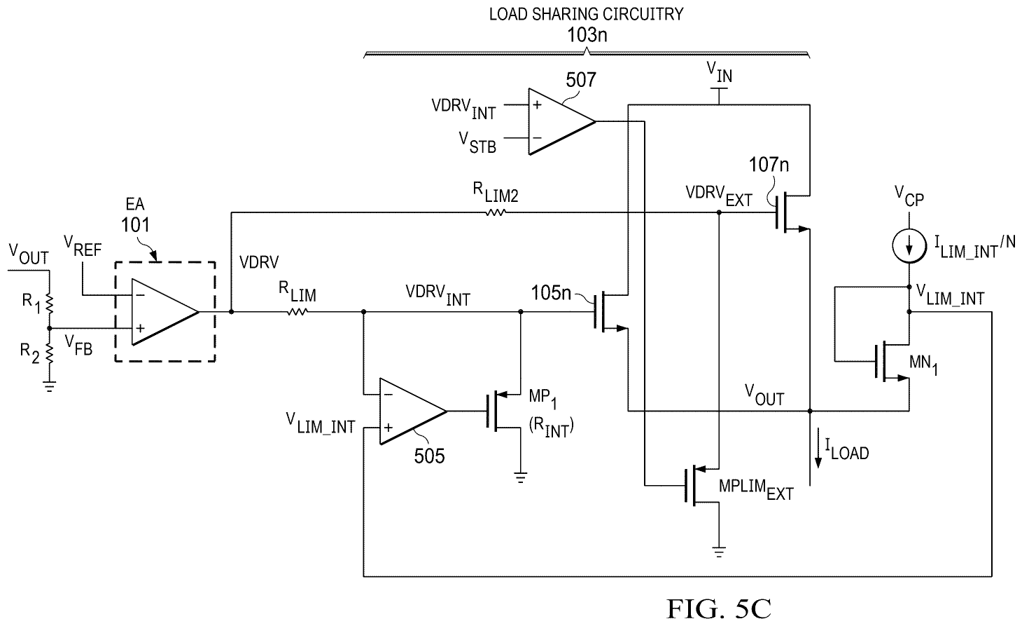

As similarly described above with respect to FIG. 1, load sharing circuitry 103n receives VDRV from error amplifier 101 and is configured to generate a first drive voltage VDRV_{INT} and a second drive voltage VDRV_{EXT}. In this example of FIG. 3, load sharing circuitry 103n generates the first drive voltage VDRV_{INT} and the second drive voltage VDRV_{EXT} from VDRV using a complementary pair of variable voltage dividers, also referred to herein as variable impedance dividers (used interchangeably). Each voltage divider is coupled between the output of error amplifier 101 and the ground terminal, and has its output coupled to the control terminal of one of internal pass element 105n and external pass element 107n. In more detail, a first impedance divider includes resistor R_{IMI}, and variable resistor R_{INT} serially coupled between the output of amplifier 101 and the ground terminal, and provides the first drive voltage VDRV_{INT} at its output (node between R_{LIML} and R_{INT}), which is in turn is coupled to the control terminal of internal pass element 105n. Also, a second impedance divider includes variable resistor R_{EXT} and pull-down impedance circuit Z_{PD} serially coupled between the output of amplifier 101 and the ground terminal, and provides the second drive voltage VDRV_{EXT} at its output (node between R_{EXT} and Z_{PD}), which is in turn coupled to the control terminal of external pass element 107n via an output signal terminal of voltage regulator 100. Generally, the first and second impedance dividers can be implemented with any passive and/or active components. Such a configuration beneficially allows single loop control for two uncorrelated outputs, by splitting one output (VDRV) into two outputs (VDRV_{INT} and VDRV_{EXT}) using load dependent voltage dividers. Compensation is relatively simpler using one control loop, rather than multiple control loops, as is further described below with reference to FIGS. 5A-D and 6.

As further shown in FIG. 3, the location of the variable resistance in each divider is different, and as such, the dividers may be thought of as being complementary to one another. In more detail, variable resistor R_{INT} of the first divider is coupled between the output of the first divider and the ground terminal (bottom position of the divider), and variable resistor R_{EXT} of the second divider is coupled between the output of amplifier 101 and the output of the second divider (top position of the divider). The resistance (or impedance, used interchangeably) values of R_{INT} and R_{EXT} are load dependent. Specifically, the resistances of R_{EXT} and R_{INT} reduce as I_{LOAD} increases. As I_{LOAD} increases, external pass element 107n becomes stronger, and internal pass element 105n becomes weaker.

In more detail, when the load current I_{LOAD} increases, the error amplifier 101 output voltage VDRV increases, and the resistances of R_{EXT} and R_{INT} transition (e.g., in a relatively linear fashion) from high impedance to low impedance. As variable resistor R_{INT} transitions from relatively high impedance to relatively low impedance, the current through R_{LIML} increases thus increasing the voltage drop across R_{LIML}, which in turn decreases the gain from the error amplifier 101 output to the control terminal of internal pass element 105n. In contrast, as variable resistor R_{EXT} transitions from relatively high impedance to relatively low impedance, the current through Z_{PD} increases thus increasing the voltage drop across Z_{PD}, which in turn increases the gain from the error amplifier 101 output to the control terminal of external pass element 107n. In this manner, for n-type voltage regulator 100n, the slope of a plot of VDRV_{INT} itself, or the slope of a plot of the gain associated with the VDRV_{INT} drive path, decreases as VDRV increases in drive strength (as shown in FIGS. 2C and 2D, respectively); also, the slope of a plot of VDRV_{EXT} itself, or the slope of a plot of the gain associated with the VDRV_{EXT} drive path, increases as VDRV increases in drive strength (as shown in FIGS. 2C and 2D, respectively). Z_{PD} may be, for example, a resistor, a current source, a degenerated natural transistor, or a degenerated depletion transistor, to name a few examples.

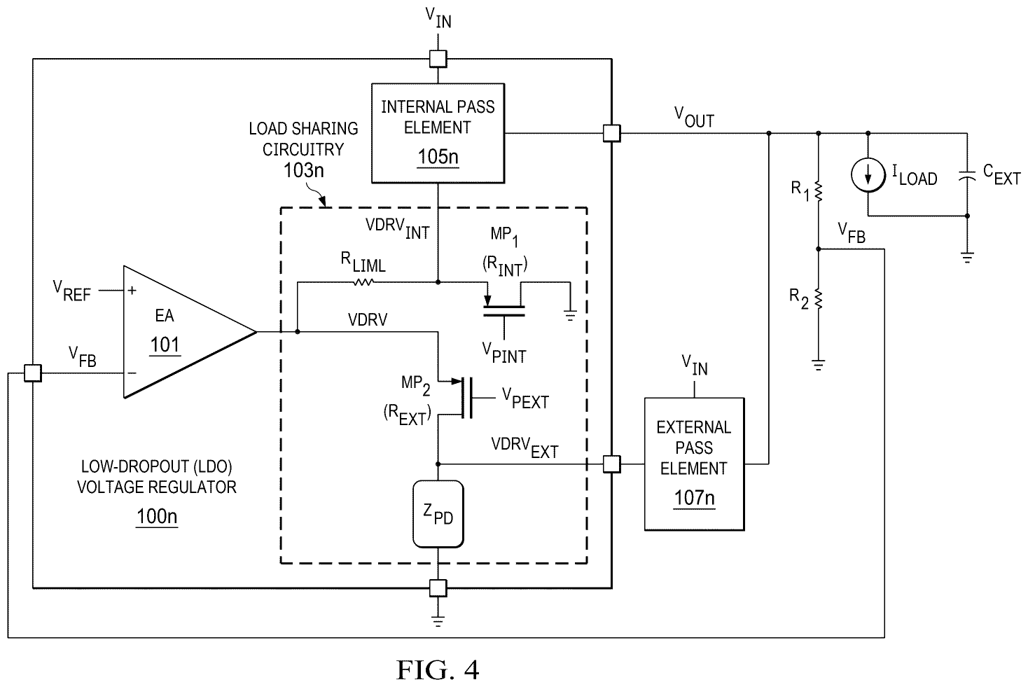

FIG. 4 is a schematic diagram of an n-type LDO voltage regulator 100n configured for load sharing, in another example. As shown, this example is similar to the example of FIG. 3, except that the variable resistors R_{EXT} and R_{INT} of load sharing circuitry 103n are implemented with p-type FETs MP₁ and MP₂. The above relevant description of FIGS. 1-3 is equally applicable here. In an example, FETs MP₁ and MP₂ may be, for instance, PMOS FETs, although other transistor technologies may be used. The drain of MP₁ is coupled to the ground terminal and the source of MP₁ is coupled to the control terminal of internal pass element 105n, and the drain of MP₂ is coupled to the control terminal of external pass element 107n and the source of MP₂ is coupled to the output of amplifier 101. The gate (control terminal) of MP₁ is coupled to a node at which V_{PINT} is provided (the output of the first divider), and the gate of MP₂ is coupled to a node at which V_{PEXT} is provided (the output of the second divider). In this example, V_{PINT} and V_{PEXT} may be fixed for the given application, and do not vary with load current; rather, it is the source voltage of FETs MP₁ and MP₂ that varies with load current in this example. Each of V_{PINT} and V_{PEXT} may be, for instance, theoretically or empirically set to reflect the constraints of the fixed current thresholds I_{STB} and I_{LM INT} for the given application, as described above with reference to FIG. 2A.

In operation of such an n-type configuration, when load current I_{LOAD} increases, the error amplifier 101 output voltage VDRV increases, and the source-to-drain on resistances (RSD ON) of FETs MP₁ and MP₂ transition (e.g., in a relatively linear fashion) from high impedance to low impedance. As RSD ON of FET MP₁ transitions from relatively high impedance to relatively low impedance, the current through R_{LIML} increases thus increasing the voltage drop across R_{LIML}, which in turn decreases the gain from the error amplifier 101 output to the control terminal of internal pass element 105n. In contrast, as RSD ON of FET MP₂ transitions from relatively high impedance to relatively low impedance, the current through Z_{PD} increases thus increasing the voltage drop across Z_{PD}, which in turn increases the gain from the error amplifier 101 output to the control terminal of external pass element 107n. In this manner, for n-type voltage regulator 100n, the slope of a plot of VDRV_{INT} itself, or the slope of a plot of the gain associated with the VDRV_{INT} drive path, decreases as VDRV increases (as shown in FIGS. 2C and 2D, respectively); also, the slope of a plot of VDRV_{EXT} itself, or the slope of a plot of the gain associated with the VDRV_{EXT} drive path, increases as VDRV increases (as shown in FIGS. 2C and 2D, respectively).

FIG. 5A is a schematic diagram of an n-type LDO voltage regulator configured for load sharing, in another example. As shown, this example is similar to the example of FIG. 4, except that an active control circuit is provided in load sharing circuitry 103n for generating the V_{PINT} and V_{PEXT}, and error amplifier 101 is configured with load dependent zero for pole zero compensation. Each of these different features is further described below. In addition, in this example, internal pass element 105n is implemented with an NMOS FET, and external pass element 107n is implemented with an NPN BJT. The drain of internal pass element 105n is coupled to the V_{IN} terminal and the source of internal pass element 105n is coupled to the V_{OUT} terminal, and the gate (control terminal) of internal pass element 105n is coupled to the output of error amplifier 101 via resistor R_{LIML}. The collector of external pass element 107n is coupled to the V_{IN} terminal and the emitter of external pass element 107n is coupled to the V_{OUT} terminal, and the base (control terminal) of external pass element 107n is coupled to the output of error amplifier 101 via variable resistor R_{EXT} (which in this example is implemented with FET MP₂). The example n-type LDO voltage regulator of FIG. 5B is similar to the example of FIG. 5A, except internal pass element 105n is implemented with an NPN BJT rather than a NMOS FET. In that example, the collector of internal pass element 105n is coupled to the V_{IN} terminal and the emitter of internal pass element 105n is coupled to the V_{OUT} terminal, and the base (control terminal) of internal pass element 105n is coupled to the output of error amplifier 101 via resistor R_{LIML}. The above relevant description with respect to FIGS. 1-4 is equally applicable here.

As shown in this example, the active control circuit for generating V_{PINT} and V_{PEXT} includes comparators 501 and 503, wherein the inverting inputs of comparators 501 and 503 are coupled to the control terminal of internal pass element 105n, and the non-inverting inputs of comparators 501 and 503 are respectively each coupled to bias or voltage source nodes set to threshold (turn-on) voltages V_{LIMH} and V_{LIML}. An example operation is as follows. When I_{LOAD} is less than I_{STB}, VDRV is less than V_{LIMH} and V_{LIML}, and the output signals V_{PINT} and V_{PEXT} are both high thus disabling or turning off each of p-type FETs MP₁ and MP₂, such that VDRV is equal to VDRV_{INT}, and all of I_{LOAD} is provided by internal pass element 105n. When I_{LOAD} increases, VDRV also increases, and when VDRV_{INT} at the control terminal of internal pass element 105n exceeds the voltage threshold V_{LIMH}, the output signal V_{PINT} of comparator 501 transitions from high to low, thus causing the p-type FET MP₁ to turn on. This allows current to flow through R_{LIML} thus creating a voltage drop across R_{LML}, which in turn reduces the gain from the output of error amplifier 101 to internal pass element 105n. The inverse happens for external pass element 107n. More specifically, when VDRV_{INT} at the control terminal of internal pass element 105n exceeds the voltage threshold (turn-on) V_{LIML}, the output signal V_{PEXT} of comparator 503 transitions from high to low, thus causing the p-type FET MP₂ to turn on. This allows current to flow through Z_{PD} thus creating a voltage drop across Z_{PD} which in turn increases the gain from the output of error amplifier 101 to external pass element 107n. This complementary action of the dividers allows for a relatively low impedance transfer of current between the two pass elements and thus facilitates system stability. In this example, rather than V_{PINT} and V_{PEXT} being fixed, V_{LIMH} and V_{LIMI}, may be fixed for the given application, and do not vary with load current. Each of V_{LIMH} and V_{LIMI}, may be, for instance, theoretically or empirically set to reflect the constraints of the fixed current thresholds I_{STB} and I_{LIM_INT} for the given application, as described above with reference to FIG. 2A.

With further shown in FIGS. 5A-B, error amplifier 101 in this example includes an error amplifier stage A1, an inverting amplifier stage A2, and a low impedance buffer stage B. In this example, amplifier stage A1 is biased with V_{IN}, and each of amplifier stage A2 and buffer stage B is biased via a charge pump voltage or boost stage (V_{CP}). V_{CP} can be any voltage level high enough to satisfy the overdrive requirement of n-type pass elements 105n and 107n (e.g., V_{CP}=V_{OUT}+ΔV_{GS}). Such a bias allows, for example, the gate of internal pass element 105n to be pulled up higher than its drain, thus broadening the input range of the LDO voltage regulator. If such range in output voltage is not needed, then V_{IN} may be used for stages A2 and B as well, rather than V_{CP}. As further shown in this example, a pole zero compensation network, which includes capacitor C_{PZ} and FET MP₃ serially coupled with one another, is coupled from the input of stage A2 to the output of stage A2. In this example, MP₃ is a PMOS FET having its drain coupled to C_{PZ} and its source coupled to the output of stage A2. The gate of MP₃ receives a load tracking control voltage V_{ZERO_LOAD}. In operation, when I_{LOAD} increases, V_{ZERO_LOAD} decreases which in turn decreases the resistance of FET MP₃ (or otherwise pushes MP₃ towards its low impedance or on state) and allows C_{PZ} to provide compensation. In contrast, when I_{LOAD} decreases, VERO LOAD increases which in turn increases the resistance of MP₃ (or otherwise pushes MP₃ towards its high impedance or off state), which effectively opens the compensation path so that C_{PZ} doesn't compete with C_{EXT} and cause instability at lower load currents (and lower switching frequencies).

FIG. 5C is a schematic diagram of an n-type LDO voltage regulator configured for load sharing, in another example. The load sharing concept is similar to examples of FIGS. 5A-B, with some differences in biasing and operation, as described here. The above relevant description is equally applicable here. As shown in this example, internal pass element 105n and external pass element 107n are both NMOS FETs, and first and second impedance dividers of load sharing circuitry of 103n are effectively provided by R_{LIM} and MP₁ (first divider) and R_{LIM2} and MPLIM_{EXT} (second divider). P-type FET MPLIM_{EXT} has its source coupled to the control terminal of external pass element 107n, and its drain coupled to the ground terminal. R_{LIM2} is coupled between the output of amplifier 101 and the control terminal of external pass element 107n. FET MP₁ is controlled by comparator 505, which in this example has its inverting input coupled to the node between resistor R_{LIM} and the control terminal of pass element 105n, its non-inverting input coupled to the gate and drain of FET MN₁ so that it receives threshold voltage V_{LIM_INT}, and its output coupled to the control terminal of FET MP₁. FET MPLIM_{EXT} is controlled by comparator 507, which has its non-inverting input coupled to the node between resistor R_{LIM} and the control terminal of pass element 105n, its inverting input set to V_{STB} (which corresponds to the desired I_{STB}), and its output coupled to the control terminal of FET MPLIM_{EXT}. As further shown, V_{LIM_INT} is set by driving the maximum current I_{LIM_INT} (scaled by N) through FET MN₁. FET MN₁ is a replica (e.g., correlated or matched) to internal pass element 105n, which is N times larger than FET MN₁ (where N is an integer of 2 or more). For instance, in some such examples, the width-to-length (W/L) ratio of internal pass element 105n is N times larger than the W/L ratio of FET MN₁, wherein width W and length L are the channel parameters (actual dimensions of the current carrying area) of the respective transistors. R_{LIM2} can be, for example, a resistor as shown, or other resistive element (e.g., a transistor having a control terminal voltage that provides a source-to-drain resistance).

An example operation is as follows. When VDRV_{INT} at the gate of internal pass element 105n is less than V_{STB}, the output of comparator 507 is low and turns on MPLIM_{EXT}, which in turn pulls the gate of external pass element 107n low, thus keeping FET 107n turned off. This allows internal pass element 105n to carry load current I_{LOAD} until the threshold I_{STB} is met. Once VDRV_{INT} goes greater than V_{STB}, the output of comparator 507 goes high and MPLIM_{EXT} turns off, which in turn allows the gate voltage of FET 107n to rise thus allowing FET 107n to turn on (so it can start carrying a portion of the load current I_{LOAD}). When VDRV_{INT} goes above V_{LIM_INT}, the output of comparator 505 output goes low thereby turning on FET MP₁, which in turn causes FET MP₁ to start drawing current through R_{LIM}. This allows maintaining V_{LIM_INT} at the gate of internal pass element 105n, which in turn limits the current through internal pass element 105n to I_{LIM_INT}.

FIG. 5D is a schematic diagram of an n-type LDO voltage regulator configured for load sharing, in another example. The load sharing concept is similar to examples of FIGS. 5A-C, with some differences in biasing and operation, as described here. The above relevant description is equally applicable here. As shown in this example, internal pass element 105n is an NMOS FET, external pass element 107n is an NPN BJT, and first and second impedance dividers of load sharing circuitry of 103n are effectively provided by R_{LIM} and MP₁ (first divider) and R_{LIM2} and MPLIM_{EXT} (second divider). Similar to the example of FIG. 5C, V_{LIM_INT} is set by driving the maximum current I_{LIM_INT} (scaled by N) through FET MN₁. FET MN₁ is a replica (e.g., correlated or matched) to internal pass element 105n, which is N times larger than FET MN₁ (where N is an integer of 2 or more). For instance, in some such examples, the width-to-length (W/L) ratio of internal pass element 105n is N times larger than the W/L ratio of FET MN₁, wherein width W and length L are the channel parameters (actual dimensions of the current carrying area) of the respective transistors. R_{LIM2} can be, for example, a resistor as shown, or other resistive element, and is coupled between the current source I_{LIM_INT}/N and the gate and drain of FET MN₁. Further in this example, FET MP₁ has its control terminal coupled to the gate and drain of FET MN₁ SO that it directly receives threshold voltage V_{LIM_INT}. P-type FET MPLIM_{EXT} has its source coupled to the output of amplifier 101, its drain coupled to the control terminal of external pass element 107n, and its control terminal coupled to the node between R_{LIM2} and current source I_{LIM_INT}/N, such that it receives V_{LIM_INT2}.

An example operation is as follows. At low I_{LOAD} (connected to V_{OUT}) when VDRV is less than (V_{LIM_INT}+V_{TH} of MP₁), then MPLIM_{EXT} is off and I_{LOAD} is supported only by internal pass element 105n. As I_{LOAD} increases, VDRV increases, and eventually MPLIM_{EXT} turns on passing VDRV to the base of external pass element 107n, to support higher current. At the same time, MP₁ also turns on (because V_{LIM_INT2}>V_{LIM_INT}), thereby reducing the gain from VDRV to VDRV_{INT}, which in turn allows external pass element 107n to carry higher current. In this manner, the variable gain divider circuitry provided by R_{LIM}, MP₁, R_{LIM2}, and MPLIM_{EXT} reduces gain for internal pass element 105n as I_{LOAD} increases, and increases gain for external pass element 107n as I_{LOAD} increases. In more detail: as I_{LOAD} increases, VDRV provided by amplifier 101 goes up, and both MP₁ and MPLIM_{EXT} turn on; when MPLIM_{EXT} turns on, it increases gain (VDRV_{EXT}/VDRV) of the VDRV_{EXT} path; and when MP₁ turns on it reduces gain (VDRV_{INT}/VDRV) of the VDRV_{INT} path. The complementary gain adjustment to the respective paths is further illustrated in FIG. 2D. As further shown in FIG. 5D, a relatively small current source I_{BIAS3} may be provided through resistor R_{LIM} forms a DC bias voltage (in parallel to the gate/base driver, amplifier 101) that may be used to provide an additional bias voltage for internal pass element 105n, which may be helpful, for instance, at very low load currents (e.g., I_{LOAD}<100 microamps). A similar benefit may be provided by current source I_{BIAS2}, coupled between the control terminal of external pass element 107n and the ground terminal. Other examples may be configured differently.

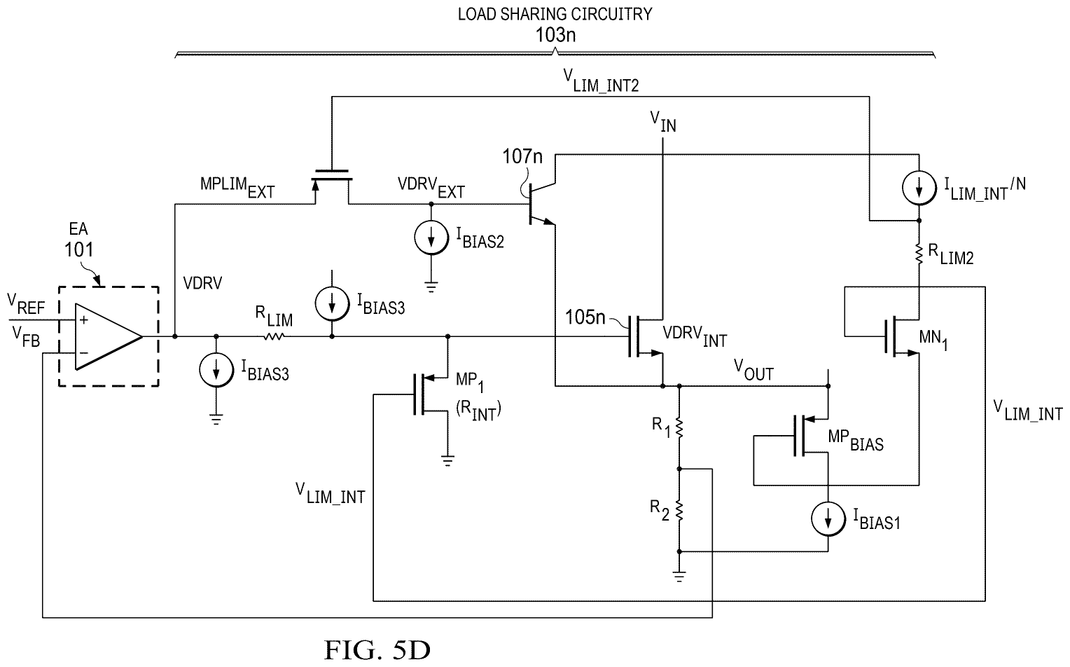

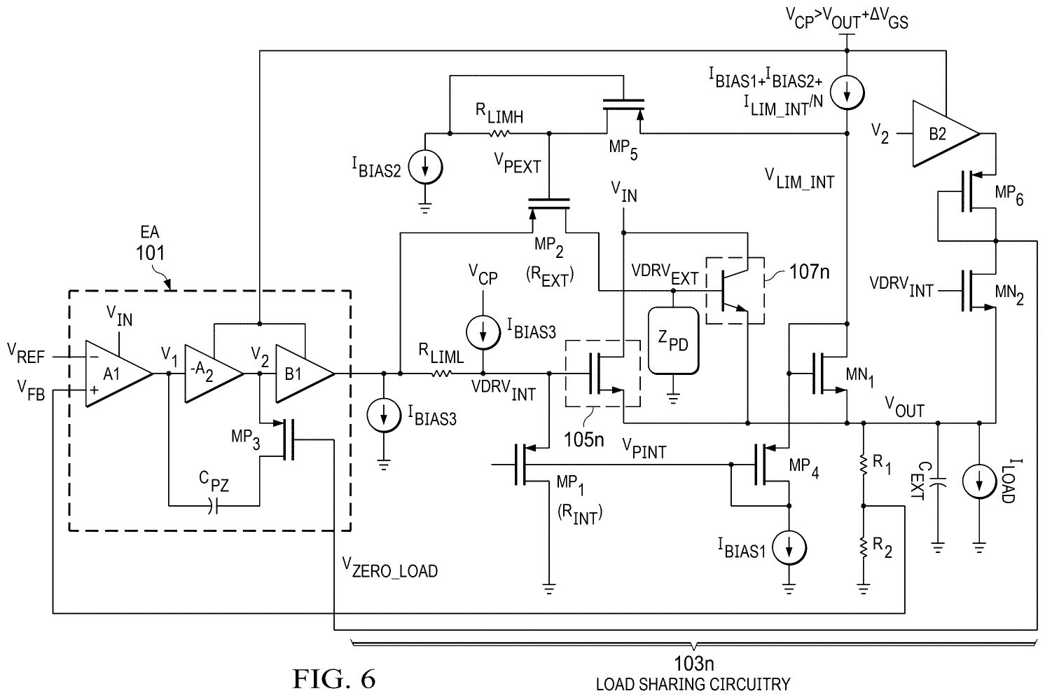

FIG. 6 is a schematic diagram of an n-type LDO voltage regulator configured for load sharing, in an example. As shown, this example is similar to the examples of FIGS. 5A-B, except that the active comparator-based control circuit for generating V_{PINT} and V_{PEXT} is effectively replaced with resistors and current sources, in load sharing circuitry 103n. In more detail, the example of FIG. 5A, V_{LIMH} and V_{LIMI}, are more like turn-on thresholds in a comparator representation. In contrast, in this example of FIG. 6, resistors R_{LMI}, and R_{LIMH}, and current sources I_{BIAS1} are I_{BIAS2}, are used to adaptively set the trip points such that FETs MP₁ and MP₂ turn on at the desired set points. In this context, PMOS FETs MP₄, MP₅, and MP₆, and NMOS FETs MN₁ and MN₂ allow for sensing and tracking. Each of these different features is further described below. The above relevant description with respect to FIGS. 1-5D is equally applicable here.

With further reference to FIG. 6, FET MN₁ is coupled between the V_{OUT} terminal and the V_{CP} terminal (or the V_{IN} terminal in other examples not needing a higher charge pump voltage), and has its gate coupled to its drain, and its source coupled to the V_{OUT} terminal. FET MN₁ is a scaled down replica of internal pass element 105n, wherein internal pass element 105n is N times larger, N being an integer of 2 or more. For instance, in some such examples, the width-to-length (W/L) ratio of internal pass element 105n is N times larger than the W/L ratio of FET MN₁, wherein width W and length L are the channel parameters (actual dimensions of the current carrying area) of the respective transistors. FET MP₄ has its gate coupled to its drain and the gate of FET MP₁, and its source coupled to the gate and drain of FET MN₁. Current source I_{BIAS1} is coupled between the drain of FET MP₄ and the ground terminal. FET MPs is coupled between the ground terminal and the V_{CP} terminal (or V_{IN} terminal), and has its gate coupled to its drain via resistor R_{LIMH}, its source coupled to the V_{CP} terminal (or V_{IN} terminal), and its drain coupled to the gate of FET MP₂. Current source I_{BIAS2} is coupled between the ground terminal and the gate of FET MP₅ (such that R_{LIMH} is between I_{BIAS2} and the drain of FET MP₅). In some such examples, FET MP₁ and FET MP₄ may be matched or correlated with one another, and FET MP₂ and FET MPs may be matched or correlated with one another. Current source I_{BIAS3} through resistor R_{LML}. forms a DC bias voltage (in parallel to the gate/base driver, amplifier 101) that may be used to provide an additional bias voltage for internal pass element 105n, which may be helpful, for instance, at very low load currents (e.g., I_{LOAD}<100 microamps). Other examples may be configured differently.

With reference to the example of FIG. 6, the expressions for the control voltages V_{PINT} and V_{PEXT} for FETs MP₁ and MP₂, respectively, are as follows.

$${V}_{PINT} = {V}_{LIM\_INT} - {V}_{GS\_MP 4} \qquad ( Equation 1 )$$

$$K = ( W / {L}_{M P 1} ) / ( W / {L}_{M P 4} ) \qquad ( Equation 2 )$$

$${V}_{PEXT} = {V}_{LIM\_INT} - {V}_{GS\_MP 5} + {I}_{BIAS 2} * {R}_{LIMH} \qquad ( Equation 3 )$$

V_{LIM_INT} is a replica bias referenced to V_{OUT}, and that is dependent on the I_{LIM_INT} for the given application, and effectively ensures that internal pass element 105n only carries a current that is less than or equal to I_{LIM_INT}. Recall that I_{LIM_INT} represents the maximum current level that internal pass element 105n can safely handle. Also, W/L represents the respective width-to-length ratio of FETs MP₁ and MP₄, wherein width W and length L are the dimensions of the current carrying channel area of the respective transistors.

In more detail, the charge pump voltage V_{CP} is used to provide a scaled down version of the maximum current I_{LIM_INT} into replica FET MN₁, which creates a replica bias V_{LIM_INT} referenced to V_{OUT}, and that is dependent on the I_{LIM_INT} for the given application. For instance, if FET MN₁ is N times smaller than pass element 105n (e.g., based on W/L ratios as described above), then the pumped current is equal to I_{LIM_INT}/N. The resulting bias V_{LIM_INT} is then used to provide V_{PINT} via resistor R_{LIML}, FET MP₄, and I_{BIAS1}, and V_{PEXT} via resistor R_{LIMH}, FET MP₅, and I_{BIAS2}. When FETs MP₁ and MP₄ are matched, FET MP₄ effectively cancels out process variation of FET MP₁ (such that V_{LIM_INT} is subjected to one PMOS down via MP₄ and one PMOS up via MP₁), so that the corresponding bias at the gate of internal pass element 105n accurately reflects I_{LIM_INT}. Similarly, when FETs MP₂ and MP₅ are matched, FET MP₅ effectively cancels out process variation of FET MP₂ (such that V_{LIM_INT} is subjected to one PMOS down via MP₅ and one PMOS up via MP₂), so that the corresponding bias at the gate of external pass element 107n accurately reflects I_{LIM_INT}.

With further reference to the example of FIG. 6, load sensing circuitry is provided to allow for pole zero compensation and load tracking. In more detail, a replica buffer stage B2 receives signal V2 provided at the output of the A2 stage of error amplifier 101. Like buffer stage B1, buffer stage B2 may also be biased with V_{CP}, or V_{IN}. PMOS FET MP₆ has its gate coupled to its drain, and its source coupled to the output of buffer stage B2. NMOS FET MN₂ is a scaled down replica of internal pass element 105n (e.g., 105n is K times larger than MN₂, wherein K is an integer of 2 or more, and in a similar manner to 105n being N times larger than MN₁ as described above, with that relevant discussion being equally applicable there), and has it gate coupled to the gate of the internal pass element 105n, its drain coupled to the drain of FET MP₆, and its source coupled to the V_{OUT} terminal. Such a configuration provides a scaled down version of the load current I_{LOAD}, for load sensing. As described above, when I_{LOAD} increases, V_{ZERO_LOAD} at the drains of FETs MP₆ and MN₂ decreases which in turn decreases the resistance of FET MP₃ (or otherwise pushes MP₃ towards its low impedance or on state) and allows C_{PZ} to provide compensation for higher load currents. In contrast, when I_{LOAD} decreases, V_{ZERO_LOAD} increases which in turn increases the resistance of MP₃ (or otherwise pushes MP₃ towards its high impedance or off state), which effectively opens the compensation path so that C_{PZ} doesn't compete with C_{EXT} and cause instability at lower load currents.

P-Type LDO Voltage Regulator with Load Sharing Circuitry

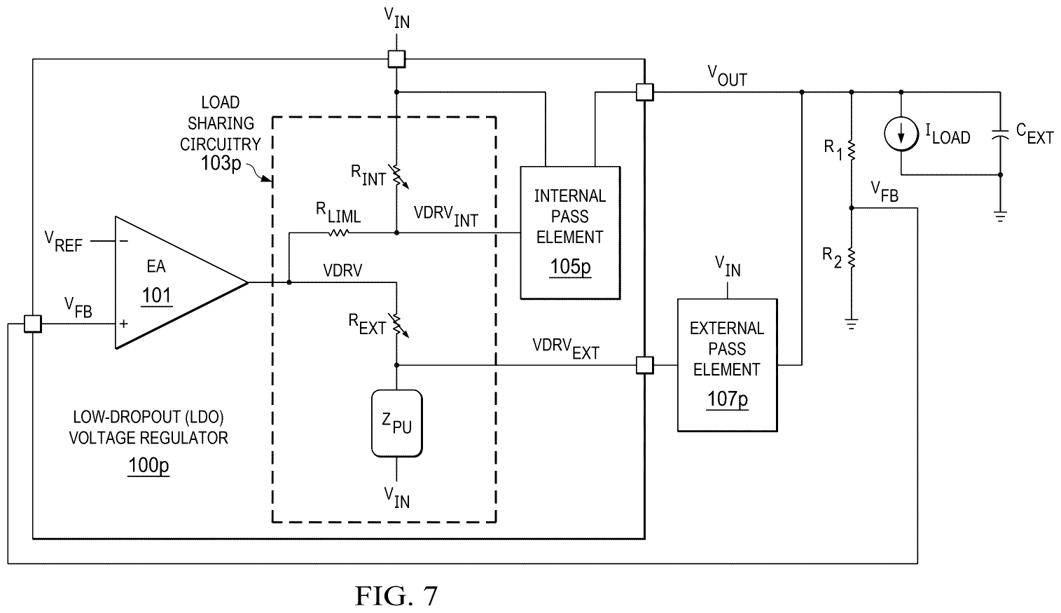

FIG. 7 is a schematic diagram of a p-type LDO voltage regulator 100p configured for load sharing, in an example. As shown, voltage regulator 100p is an example voltage regulator 100 of FIG. 1, where voltage regulator 100p is a p-type voltage regulator. In particular, voltage regulator 100p includes p-type load sharing circuitry 103p and a p-type internal pass element 105p, and is coupled with a p-type external pass element 107p. Other componentry, such as error amplifier 101, resistors R₁ and R₂, and capacitor C_{EXT}. The above relevant description of FIGS. 1 and 2A-D is equally applicable here.

With further reference to the example of FIG. 7, V_{REF} and V_{FB} are applied to the inverting and non-inverting inputs, respectively, of the error amplifier 101, which in turn generates drive signal VDRV from those inputs. The V_{REF} and V_{FB} inputs may be reversed (V_{REF} and V_{FB} are applied to the non-inverting and inverting inputs, respectively), depending on how many inverting stages are configured within amplifier 101. Each of internal pass element 105p and external pass element 107p may be, for instance, any kind of a p-type power transistor, such as a PMOS FET, or a PNP BJT, or any other type of power device suitable for a p-type pass element. The pass element configuration may be homogeneous or a hybrid configuration. An example homogenous pass element configuration is, for instance, where both internal pass element 105p and external pass element 107p are PMOS FETs. An example hybrid pass element configuration is, for instance, where one of internal pass element 105p and external pass element 107p is a PMOS FET and the other is a PNP BJT.

As similarly described above with respect to FIG. 1, load sharing circuitry 103p receives VDRV from error amplifier 101 and is configured to generate a first drive voltage VDRV_{INT} and a second drive voltage VDRV_{EXT}. In this example of FIG. 7, load sharing circuitry 103p generates the first drive voltage VDRV_{INT} and the second drive voltage VDRV_{EXT} from VDRV using a complementary pair of variable voltage dividers, also referred to herein as variable impedance dividers (used interchangeably). Each voltage divider is coupled between the output of error amplifier 101 and the input voltage V_{IN} terminal, and has its output coupled to the control terminal of one of internal pass element 105p and external pass element 107p. In more detail, a first impedance divider includes resistor R_{LMI}, and variable resistor R_{INT} serially coupled between the output of amplifier 101 and the V_{IN} terminal, and provides the first drive voltage VDRV_{INT} at its output (node between R_{LIML} and R_{INT}), which is in turn is coupled to the control terminal of internal pass element 105p. Also, a second impedance divider includes variable resistor R_{EXT} and pull-up impedance circuit Z_{PU} serially coupled between the output of amplifier 101 and the V_{IN} terminal, and provides the second drive voltage VDRV_{EXT} at its output (node between R_{EXT} and Z_{PC}), which is in turn coupled to the control terminal of external pass element 107p via an output signal terminal of voltage regulator 100. Generally, the first and second impedance dividers can be implemented with any passive and/or active components. Just as with the example n-type configuration of FIG. 3, such a configuration beneficially allows single loop control for two uncorrelated outputs as well as relatively easier compensation, by splitting one output (VDRV) into two outputs (VDRV_{INT} and VDRV_{EXT}) using load dependent voltage dividers.

As further shown in FIG. 7, the location of the variable resistance in each divider is different, and as such, the dividers may be thought of as being complementary to one another. In more detail, variable resistor R_{INT} of the first divider is coupled between the output of the first divider and the V_{IN} terminal (top position of the divider), and variable resistor R_{EXT} of the second divider is coupled between the output of amplifier 101 and the output of the second divider (bottom position of the divider). The resistance (or impedance, used interchangeably) values of R_{INT} and R_{EXT} are load dependent. Specifically, the resistances of R_{EXT} and R_{INT} reduce as I_{LOAD} increases. As I_{LOAD} increases, external pass element 107p becomes stronger, and internal pass element 105p becomes weaker.

In operation of such a p-type configuration, when load current I_{LOAD} increases, the error amplifier 101 output voltage VDRV decreases, and the resistances of R_{EXT} and R_{INT} transition (e.g., in a relatively linear fashion) from high impedance to low impedance. As variable resistor R_{INT} transitions from relatively high impedance to relatively low impedance, the current through R_{LIMI} increases thus increasing the voltage drop across R_{LIML}, which in turn decreases the gain from the error amplifier 101 output to the control terminal of internal pass element 105p. In contrast, as variable resistor R_{EXT} transitions from relatively high impedance to relatively low impedance, the current through Z_{PU} increases thus increasing the voltage drop across Z_{PU}, which in turn increases the gain from the error amplifier 101 output to the control terminal of external pass element 107p. In this manner, for p-type voltage regulator 100p, the slope of a plot of VDRV_{INT} itself, or the slope of a plot of the gain associated with the VDRV_{INT} drive path, decreases as VDRV increases in drive strength (as shown in FIGS. 2C and 2D, respectively) which in this case translates to reduction in absolute value of VDRV; also, the slope of a plot of VDRV_{EXT} itself, or the slope of a plot of the gain associated with the VDRV_{EXT} drive path, increases as VDRV increases in drive strength (as shown in FIGS. 2C and 2D, respectively). Z_{PU} may be, for example, a resistor, a current source, a degenerated natural transistor, or a degenerated depletion transistor, to name a few examples.

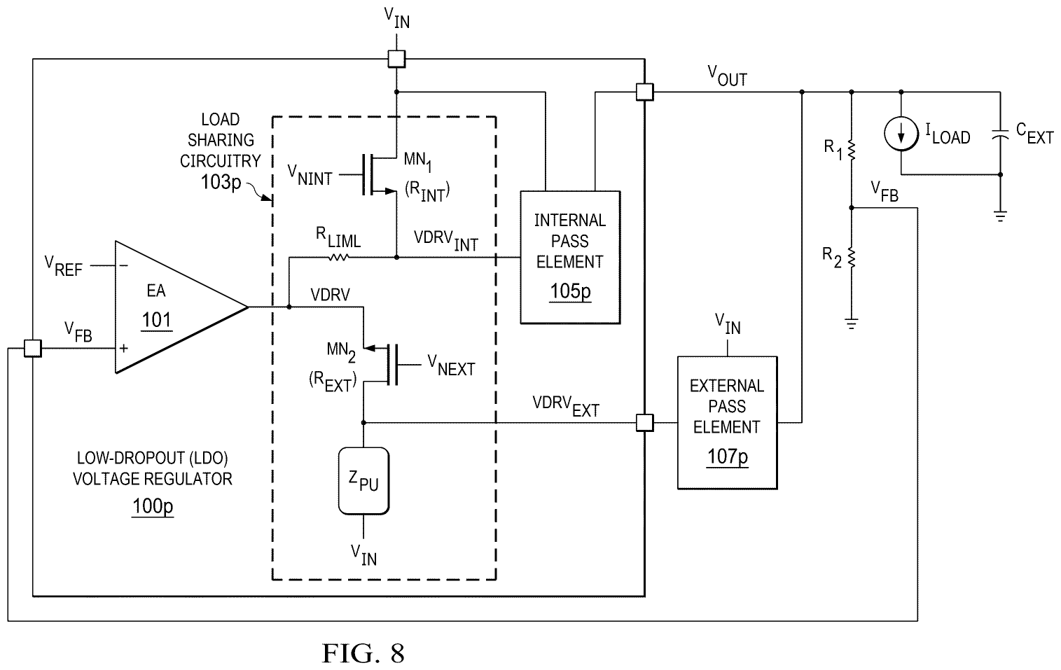

FIG. 8 is a schematic diagram of a p-type LDO voltage regulator 100p configured for load sharing, in another example. As shown, this example is similar to the example of FIG. 7, except that the variable resistors R_{EXT} and R_{INT} of load sharing circuitry 103p are implemented with n-type FETs MN₁ and MN₂. The above relevant description of FIGS. 1-2D and 7 is equally applicable here. In an example, FETs MN₁ and MN₂ may be, for instance, PMOS FETs, although other transistor technologies may be used. The drain of MN₁ is coupled to the V_{IN} terminal and the source of MN₁ is coupled to the control terminal of internal pass element 105p, and the drain of MN₂ is coupled to the control terminal of external pass element 107p and the source of MN₂ is coupled to the output of amplifier 101. The gate (control terminal) of MN₁ is coupled to a node at which V_{NINT} is provided, and the gate of MN₂ is coupled to a node at which V_{NEXT} is provided. In this example, V_{NINT} and V_{NEXT} may be fixed for the given application, and do not vary with load current; rather, it is the source voltage of FETs MN₁ and MN₂ that varies with load current in this example. Each of V_{NINT} and V_{NEXT} may be, for instance, theoretically or empirically set to reflect the constraints of the fixed current thresholds I_{STB} and I_{LIM_INT} for the given application, as described above with reference to FIG. 2A.

In operation of such a p-type configuration, when load current I_{LOAD} increases, the error amplifier 101 output voltage VDRV decreases, and the source-to-drain on resistances (RSD ON) of FETs MN₁ and MN₂ transition (e.g., in a relatively linear fashion) from high impedance to low impedance. As RSD ON of FET MN₁ transitions from relatively high impedance to relatively low impedance, the current through R_{LIML} increases thus increasing the voltage drop across R_{LIML}, which in turn decreases the gain from the error amplifier 101 output to the control terminal of internal pass element 105p. In contrast, as RSD ON of FET MN₂ transitions from relatively high impedance to relatively low impedance, the current through Z_{PU} increases thus increasing the voltage drop across Z_{PC}, which in turn increases the gain from the error amplifier 101 output to the control terminal of external pass element 107p. In this manner, for p-type voltage regulator 100p, the slope of a plot of VDRV_{INT} itself, or the slope of a plot of the gain associated with the VDRV_{INT} drive path, decreases as VDRV increases in drive strength (decreases in magnitude) (as shown in FIGS. 2C and 2D, respectively); also, the slope of a plot of VDRV_{EXT} itself, or the slope of a plot of the gain associated with the VDR V_{EXT} drive path, increases as VDRV increases in drive strength (as shown in FIGS. 2C and 2D, respectively).

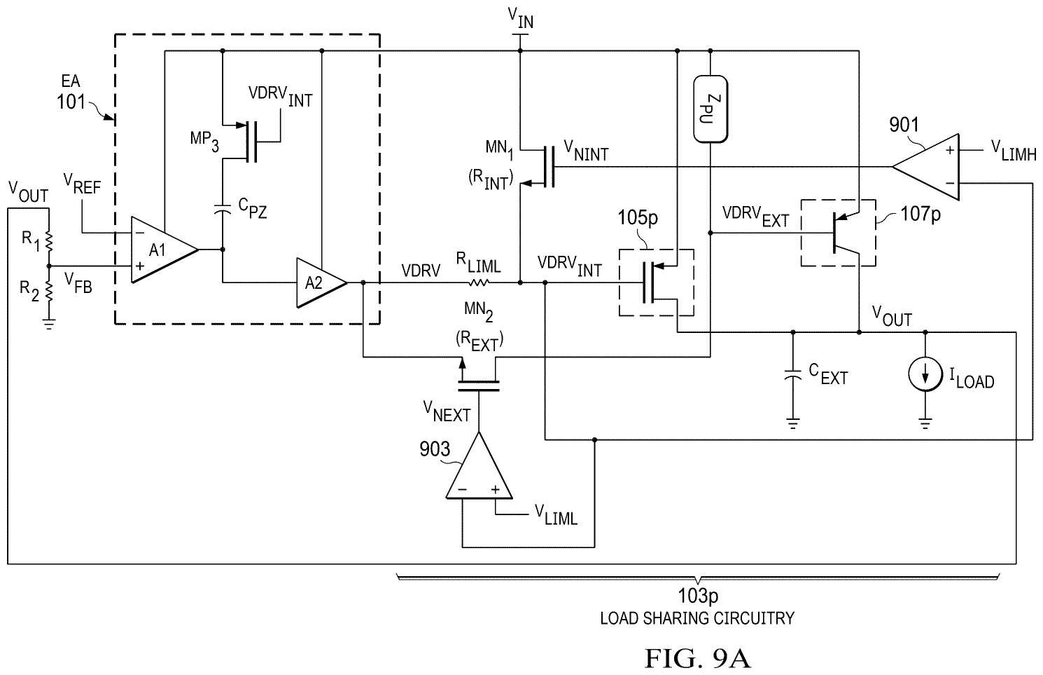

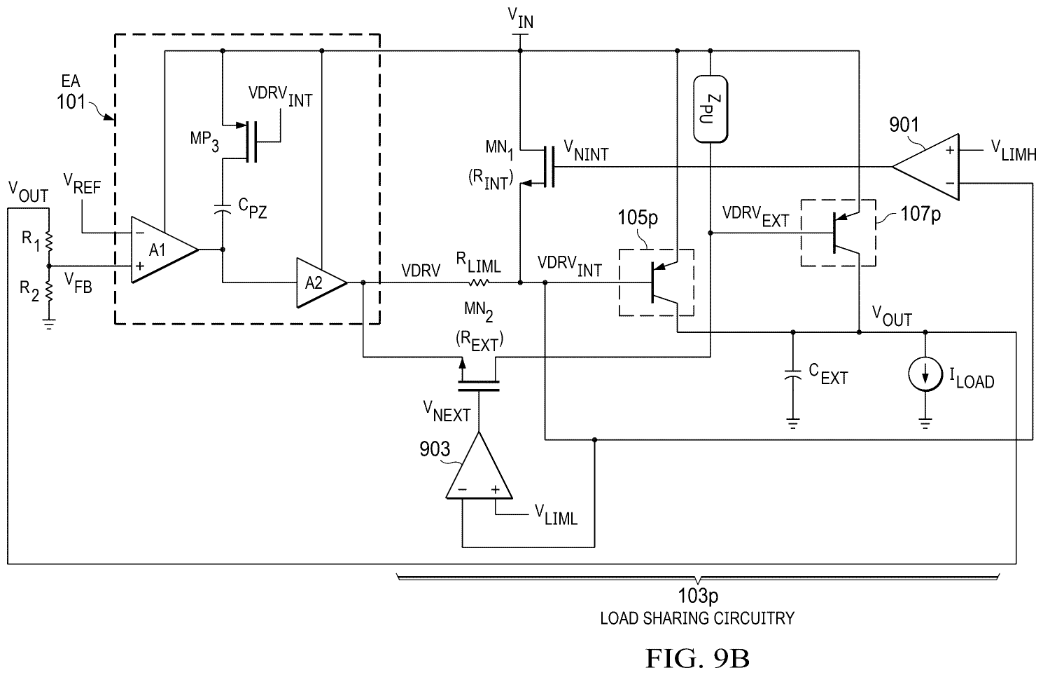

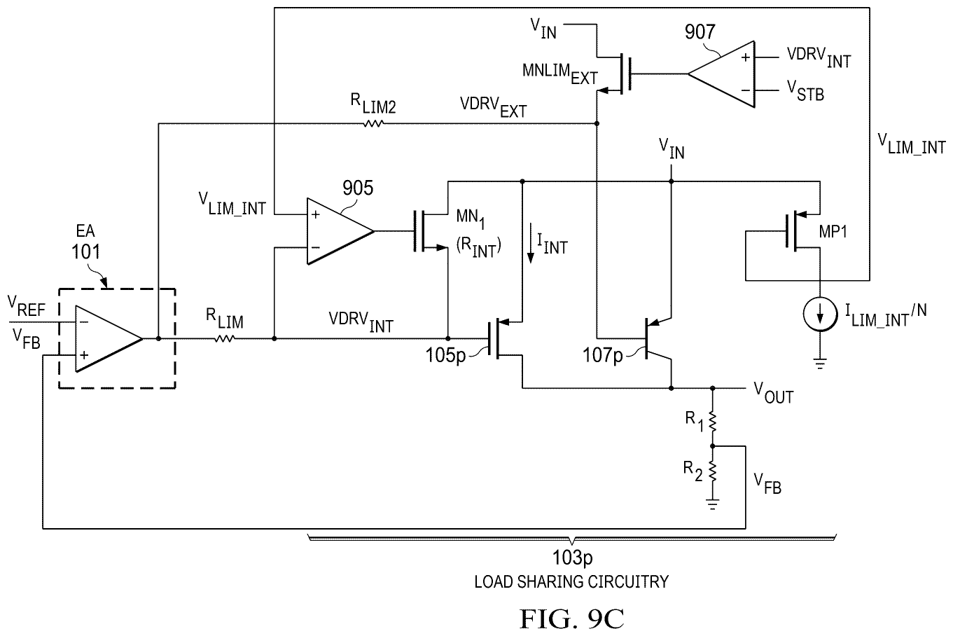

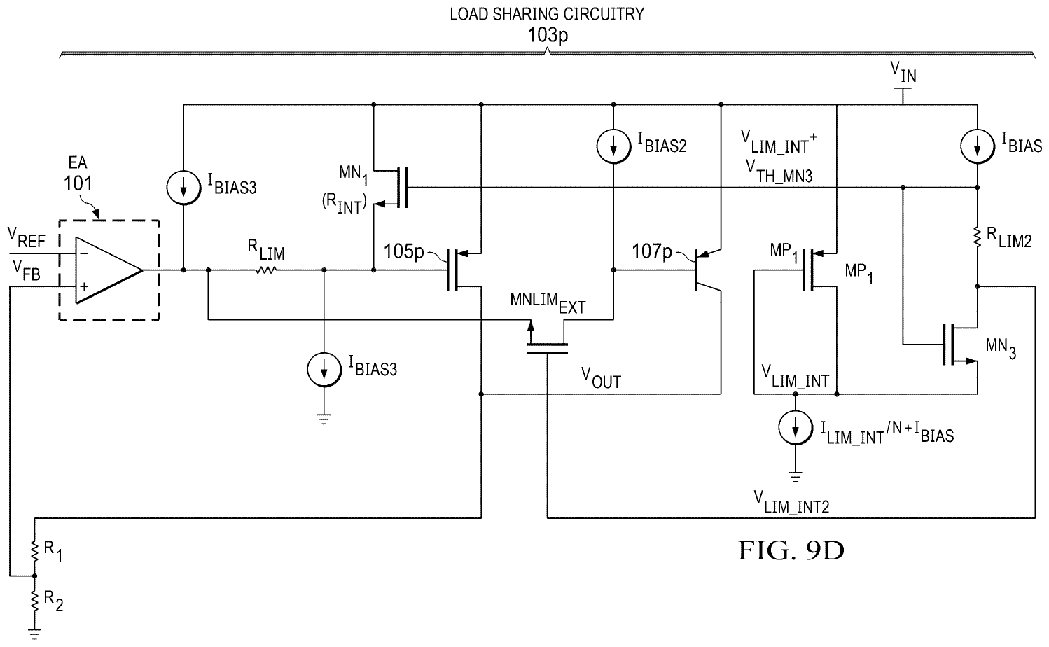

FIG. 9A is a schematic diagram of a p-type LDO voltage regulator configured for load sharing, in another example. As shown, this example is similar to the example of FIG. 8, except that an active control circuit is provided in load sharing circuitry 103p for generating the V_{NINT} and V_{NEXT}, and error amplifier 101 is configured with load dependent zero for pole zero compensation. Each of these different features is further described below. In addition, in this example, internal pass element 105p is implemented with a PMOS FET, and external pass element 107p is implemented with a PNP BJT. The source of internal pass element 105p is coupled to the V_{IN} terminal and the drain of internal pass element 105p is coupled to the V_{OUT} terminal, and the gate (control terminal) of internal pass element 105p is coupled to the output of error amplifier 101 via resistor R_{LIML}. The emitter of external pass element 107p is coupled to the V_{IN} terminal and the collector of external pass element 107p is coupled to the V_{OUT} terminal, and the base (control terminal) of external pass element 107p is coupled to the output of error amplifier 101 via variable resistor R_{EXT} (which in this example is implemented with FET MN₂). The example p-type LDO voltage regulator of FIG. 9B is similar to the example of FIG. 9A, except internal pass element 105p is implemented with a PNP BJT rather than a PMOS FET. In that example, the emitter of internal pass element 105p is coupled to the V_{IN} terminal and the collector of internal pass element 105p is coupled to the V_{OUT} terminal, and the base (control terminal) of internal pass element 105p is coupled to the output of error amplifier 101 via resistor R_{LML}. The above relevant description with respect to FIGS. 1-2 and 7-8 is equally applicable here.

As shown in this example, the active control circuit for generating V_{NINT} and V_{NEXT} includes comparators 901 and 903, wherein the inverting inputs of comparators 901 and 903 are coupled to the control terminal of internal pass element 105p, and the non-inverting inputs of comparators 901 and 903 are respectively each coupled to bias or voltage source nodes set to threshold (turn-on) voltages V_{LIMH} and V_{LIML}. An example operation is as follows. When I_{LOAD} is less than I_{STB}, VDRV is greater than V_{LIMH} and V_{LIML}, and the output signals V_{PINT} and V_{PEXT} are both low thus disabling or turning off each of n-type FETs MN₁ and MN₂, such that VDRV is equal to VDRV_{INT}, and all of I_{LOAD} is provided by internal pass element 105p. When I_{LOAD} increases, VDRV decreases, and when VDRV_{INT} at the control terminal of internal pass element 105p drops below the voltage threshold V_{LIMH}, the output signal V_{NINT} of comparator 901 transitions from low to high, thus causing the n-type FET MN₁ to turn on. This allows current to flow through R_{LIML} thus creating a voltage drop across R_{LML}, which in turn reduces the gain from the output of error amplifier 101 to internal pass element 105p. The inverse happens for external pass element 107p. More specifically, when VDRV_{INT} at the control terminal of internal pass element 105p drops below the voltage threshold (turn-on) V_{LIML}, the output signal V_{NEXT} of comparator 903 transitions from low to high, thus causing the n-type FET MN₂ to turn on. This allows current to flow through Z_{PU} thus creating a voltage drop across Z_{PU} which in turn increases the gain from the output of error amplifier 101 to external pass element 107p. This complementary action of the dividers allows for a relatively low impedance transfer of current between the two pass elements and thus facilitates system stability. In this example, rather than V_{NINT} and V_{NEXT} being fixed, V_{LIMH} and V_{LIMI}, may be fixed for the given application, and do not vary with load current. Each of V_{LIMH} and V_{LIMI}, may be, for instance, theoretically or empirically set to reflect the constraints of the fixed current thresholds I_{STB} and I_{LIM_INT} for the given application, as described above with reference to FIG. 2A.

With further shown in FIGS. 9A-B, error amplifier 101 in this example includes an error amplifier stage A1 and amplifier stage A2. In this example, each of amplifier stage A2 and buffer B are biased with V_{IN}. As further shown in this example, a pole zero compensation network, which includes capacitor C_{PZ} and FET MP₃ serially coupled with one another, is coupled between the input of stage A2 to the V_{IN} terminal. In this example, MP₃ is a scaled down replica of internal pass element 105p to assist in load tracking. In more detail, MP₃ is a PMOS FET having its drain coupled to C_{PZ} and its source coupled to the V_{IN} terminal. The gate of MP₃ receives VDRV_{INT}. In operation, when I_{LOAD} increases, VDRV_{INT} decreases which in turn decreases the resistance of FET MP₃ (or otherwise pushes MP₃ towards its low impedance or on state) and allows C_{PZ} to provide compensation. In contrast, when I_{LOAD} decreases, VDRV_{INT} increases which in turn increases the resistance of MP₃ (or otherwise pushes MP₃ towards its high impedance or off state), which effectively opens the compensation path so that C_{PZ} doesn't compete with C_{EXT} and cause instability at lower load currents (and lower switching frequencies).

FIG. 9C is a schematic diagram of a p-type LDO voltage regulator configured for load sharing, in another example. The load sharing concept is similar to examples of FIGS. 9A-B, with some differences in biasing and operation, as described here. The above relevant description is equally applicable here. As shown in this example, internal pass element 105p is implemented with a PMOS FET, and external pass element 107p is implemented with a PNP BJT, and first and second impedance dividers of load sharing circuitry of 103p are effectively provided by R_{LIM} and MN₁ (first divider) and R_{LIM2} and MNLIM_{EXT} (second divider). N-type FET MNLIM_{EXT} has its source coupled to the control terminal of external pass element 107p, and its drain coupled to the V_{IN} terminal. R_{LIM2} is coupled between the output of amplifier 101 and the control terminal of external pass element 107p, and can be, for example, a resistor as shown, or other resistive element (e.g., a transistor having a control terminal voltage that provides a source-to-drain resistance). FET MN₁ is controlled by comparator 905, which in this example has its inverting input coupled to the node between resistor R_{LIM} and the control terminal of pass element 105p, its non-inverting input coupled to the gate and drain of FET MP₁ so that it receives threshold voltage V_{LIM_INT}, and its output coupled to the control terminal of FET MN₁. FET MNLIM_{EXT} is controlled by comparator 907, which has its non-inverting input coupled to the node between resistor RLM and the control terminal of pass element 105p, its inverting input set to V_{STB} (which corresponds to the desired I_{STB}), and its output coupled to the control terminal of FET MPLIM_{EXT}. As further shown, V_{LIM_INT} is set by driving the maximum current I_{LIM_INT} (scaled by N) through FET MP₁, which has its source coupled to the V_{IN} terminal and its gate and drain coupled to the ground terminal via current source I_{LIM_INT}/N. FET MP₁ is a replica (e.g., correlated or matched) to internal pass element 105p, which is N times larger than FET MP₁ (where N is an integer of 2 or more). For instance, in some such examples, the width-to-length (W/L) ratio of internal pass element 105p is N times larger than the W/L ratio of FET MP₁, wherein width W and length L are the channel parameters (actual dimensions of the current carrying area) of the respective transistors.

An example operation is as follows. When VDRV_{INT} at the gate of internal pass element 105p is greater than V_{STB}, the output of comparator 907 is high and turns on MNLIM_{EXT}, which in turn pulls the base of external pass element 107p high, thus keeping BJT 107p turned off. This allows internal pass element 105p to carry load current I_{LOAD} until the threshold I_{STB} is met. Once VDRV_{INT} goes lower than V_{STB}, the output of comparator 907 goes low and MNLIM_{EXT} turns off, which in turn allows base current to flow from BJT 107p thus allowing BJT 107p to turn on (so it can start carrying a portion of the load current I_{LOAD}). When VDRV_{INT} goes below V_{LIM_INT}, the output of comparator 905 output goes high thereby turning on FET MN₁, which in turn causes FET MN₁ to start pushing current through R_{LIM}. This allows maintaining V_{LIM_INT} at the gate of internal pass element 105p, which in turn limits the current through internal pass element 105p to I_{LIM_INT}.

FIG. 9D is a schematic diagram of a p-type LDO voltage regulator configured for load sharing, in another example. The load sharing concept is similar to examples of FIGS. 9A-C, with some differences in biasing and operation, as described here. The above relevant description is equally applicable here. As shown in this example, internal pass element 105p is a PMOS FET, external pass element 107p is a PNP BJT, and first and second impedance dividers of load sharing circuitry of 103p are effectively provided by R_{LIM} and MN₁ (first divider) and R_{LIM2} and MNLIM_{EXT} (second divider). Similar to the example of FIG. 9C, V_{LIM_INT} is set by driving the maximum current I_{LIM_INT} (scaled by N) through FET MP₁, and FET MP₁ is a replica (e.g., correlated or matched) to internal pass element 105p, which is N times larger than FET MP₁ (where N is an integer of 2 or more). Current source I_{BIAS}, resistor R_{LIM2}, and n-type FET MN₃, arc coupled in series between the V_{IN} terminal and the V_{LIM_INT} node (drain and gate of MP₁). R_{LIM2} is coupled between I_{BIAS} and the drain of MN₃, and is further coupled between the gate and drain of MN₃. The source of MN₃ is coupled to the drain and gate of MP₁. FET MN₃ can be a replica of MN₁, so as to account for process variation of MN₁ (such that V_{LIM_INT} is subjected to one NMOS up via MN₃ and one NMOS down via MN₁), so that the corresponding bias at the gate of internal pass element 105p accurately reflects I_{LIM_INT}. In more detail, FET MN₁ has its control terminal coupled to the gate FET MN₃ so that it directly receives threshold voltage V_{LIM_INT}+V_{TH_MN3}, which is adjusted down by V_{TH_MN1} (V_{TH_MN1}=V_{TH_MN3}) before being applied to the control terminal of the internal pass element 105p. N-type FET MPLIM_{EXT} has its source coupled to the output of amplifier 101, its drain coupled to the control terminal of external pass element 107p, and its control terminal coupled to the node between R_{LIM2} and the drain of MN₃, such that it receives V_{LIM_INT2}.

An example operation is as follows. At low I_{LOAD} (connected to V_{OUT}) when VDRV is greater than (V_{LIM_INT2}-V_{TH} of MNLIM_{EXT}), then MNLIM_{EXT} is off and I_{LOAD} is supported only by internal pass element 105p. As I_{LOAD} increases, VDRV decreases, and eventually MNLIM_{EXT} turns on passing VDRV to the base of external pass element 107p, to support higher current. At the same time, MN₁ also turns on (because V_{LIM_INT2}<V_{LIM_INT}+V_{TH_MN3}), thereby reducing the gain from VDRV to VDRV_{INT}, which in turn allows external pass element 107p to carry higher current. In this manner, the variable gain divider circuitry provided by RIM, MN₁, R_{LIM2}, and MNLIM_{EXT} reduces gain for internal pass element 105p as I_{LOAD} increases, and increases gain for external pass element 107p as I_{LOAD} increases. In more detail: as I_{LOAD} increases, VDRV provided by amplifier 101 goes down, and both MN₁ and MNLIM_{EXT} turn on; when MPLIM_{EXT} turns on, it increases gain (VDRV_{EXT}/VDRV) of the VDRV_{EXT} path; and when MN₁ turns on it reduces gain (VDRV_{INT}/VDRV) of the VDRV_{INT} path. The complementary gain adjustment to the respective paths is further illustrated in FIG. 2D. As further shown in FIG. 9D, a relatively small current source I_{BIAS3} may be provided through resistor R_{LIM} forms a DC bias voltage (in parallel to the gate/base driver, amplifier 101) that may be used to provide an additional bias voltage for internal pass element 105p, which may be helpful, for instance, at very low load currents (e.g., I_{LOAD}<100 microamps). A similar benefit may be provided by current source I_{BIAS2}, coupled between the control terminal of external pass element 107p and the ground terminal. Other examples may be configured differently.

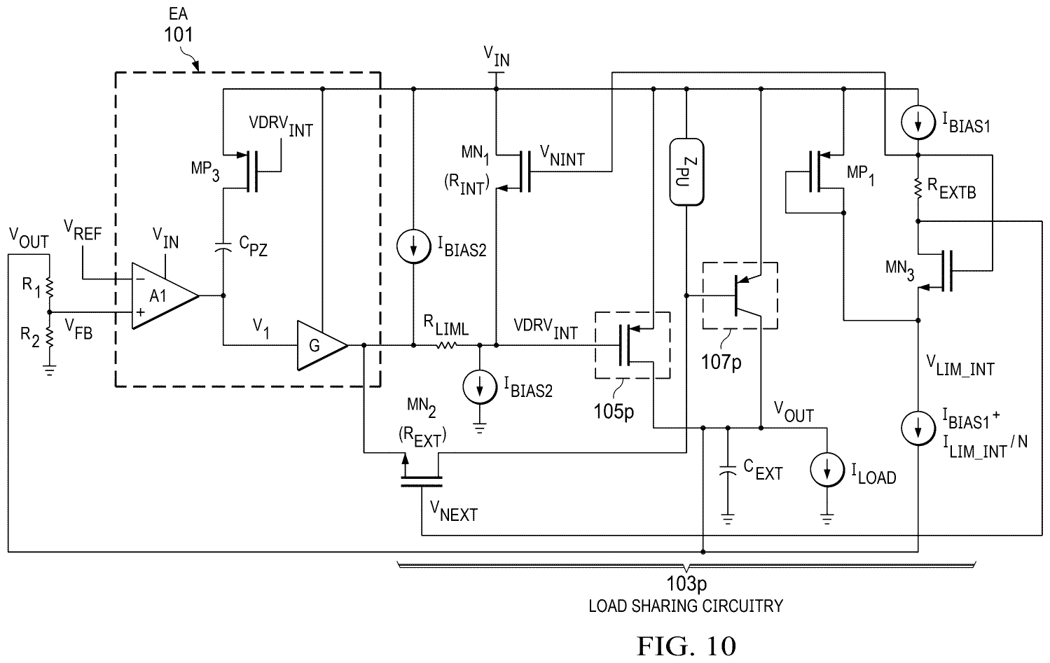

FIG. 10 is a schematic diagram of a p-type LDO voltage regulator configured for load sharing, in an example. As shown, this example is similar to the example of FIG. 9A or 9B, except that the active comparator-based control circuit for generating V_{NINT} and V_{NEXT} is effectively replaced with resistors and current source, in load sharing circuitry 103p. In more detail, the example of FIG. 9A, V_{LIMH} and V_{LIMI} are more like turn-on thresholds in a comparator representation. In contrast, in this example of FIG. 10, resistors R_{LIML} and R_{EXTB} and current source I_{BIAS1} are used to adaptively set the trip points such that FETs MN₁ and MN₂ turn on at the desired set points. In this context, PMOS FET MP₁ and NMOS FET MN₃ allow for sensing and tracking. Each of these different features is further described below. The above relevant description with respect to FIGS. 1-2 and 7-9D is equally applicable here.

With further reference to FIG. 10, FET MP₁ is coupled between the V_{IN} terminal and the V_{OUT} terminal, and has its gate coupled to its drain which is further coupled to the V_{OUT} terminal, and its source coupled to the V_{IN} terminal. FET MP₁ is a scaled down replica of internal pass element 105p, wherein internal pass element 105p is N times larger, N being an integer of 2 or more. For instance, in some such examples, the width-to-length (W/L) ratio of internal pass element 105p is N times larger than the W/L ratio of FET MP₁, wherein width W and length L are the channel parameters (actual dimensions of the current carrying area) of the respective transistors. Current source I_{BIAS1} is coupled between the V_{IN} terminal and the V_{OUT} terminal. FET MN₃ is coupled between current source I_{BIAS1} and the V_{OUT} terminal, and has its gate coupled to its drain via resistor R_{EXTB}, its source coupled to the V_{OUT} terminal, and its drain coupled to the current source I_{BIAS1}, such that R_{EXTB} is between current source I_{BIAS1} and the drain of MN₃. In some such examples, FETs MN₁, MN₂ and MN₃ may be matched or correlated with one another. Current source I_{BIAS2} through resistor R_{LIML} forms a DC bias voltage (in parallel to the amplifier 101) that may be used to provide an additional bias voltage for internal pass element 105p, which may be helpful, for instance, at very low load currents (e.g., I_{LOAD}<100 microamps). Other examples may be configured differently.

With reference to the example of FIG. 10, the expressions for the control voltages V_{NINT} and V_{NEXT} for FETs MN₁ and MN₂, respectively, are as follows.

$${V}_{NINT} = {V}_{LIM\_INT} + {V}_{GS\_MN 3} \qquad ( Equation 4 )$$

$${V}_{NEXT} = {V}_{NINT} - ( {I}_{BIAS 1} * {R}_{E X T B} ) \qquad ( Equation 5 )$$

V_{LIM_INT} is a replica bias, and that is dependent on the I_{LIM_IT} for the given application, and effectively ensures that internal pass element 105p only carries a current that is less than or equal to I_{LIM_INT}. I_{LIM_IT} represents the maximum current level that internal pass element 105p can safely handle.

In more detail, a scaled down version of the maximum current I_{LIM_INT} is provided into replica FET MP₁, which creates a replica bias V_{LIM_INT} referenced to V_{OUT}, and that is dependent on the I_{LIM_INT} for the given application. For instance, if FET MP₁ is N times smaller than pass element 105p (e.g., based on W/L ratios as described above), then the current through MP₁ is equal to I_{LIM_INT}/N. The resulting bias V_{LIM_INT} is then used to provide V_{NINT} and V_{NEXT} via resistors R_{LIML} and R_{EXTB}, FET MN₃, and I_{BIAS1}. When FETs MN₁ and MN₃ are matched, FET MN₃ effectively cancels out process variation of FET MN₁ (such that V_{LIM_INT} is subjected to one NMOS up via MN₃ and one NMOS down via MN₁), so that the corresponding bias at the gate of internal pass element 105p accurately reflects I_{LIM_INT}. Similarly, when FETs MN₂ and MN₃ are matched, FET MN₃ effectively cancels out process variation of FET MN₂ (such that V_{LIM_INT} is subjected to one NMOS up via MN₃ and one NMOS down via MN₂), so that the corresponding bias at the gate of external pass element 107p accurately reflects I_{LIM_INT}.

With further reference to the example of FIG. 10, load sensing circuitry is provided to allow for pole zero compensation and load tracking. As described above, when I_{LOAD} increases, VDRV_{INT} decreases which in turn decreases the resistance of replica FET MP₃ (or otherwise pushes MP₃ towards its low impedance or on state) and allows C_{PZ} to provide compensation. In contrast, when I_{LOAD} decreases, VDRV_{INT} increases which in turn increases the resistance of MP₃ (or otherwise pushes MP₃ towards its high impedance or off state), which effectively opens the compensation path so that C_{PZ} doesn't compete with C_{EXT} and cause instability at lower load currents.

### Load Sharing Methodology

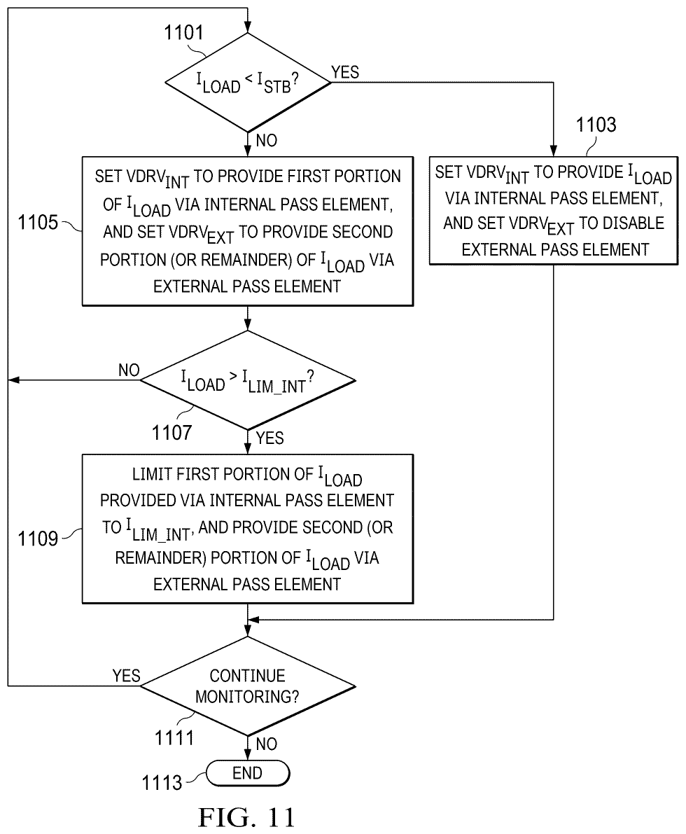

FIG. 11 is a flow diagram of a method for load sharing in an LDO voltage regulator, in an example. The methodology may be carried out, for instance, in the analog domain using the load sharing circuitry of any of the voltage regulators variously described herein with reference FIGS. 1-10 and 12A-19. Other examples of voltage regulators configured to adaptively share load current between internal and external pass elements may be used to provide similar such functionality.

As shown, the method includes a determination at 1101 as to whether the load current I_{LOAD} is less than the current threshold I_{STB}. This determination can be carried out, for example, in the analog domain using load sharing circuitry configured to implement a given I_{STB} as variously described herein. Recall from above that threshold I_{STB} is fixed for a given application, and represents the current level that the internal pass element can handle without any load sharing needed and with no stability issues.

Responsive to the load current I_{LOAD} being less than the current threshold I_{STB}, the method continues at 1103 with setting VDRV_{INT} to provide all (or substantially all) of I_{LOAD} via the internal pass element, and setting VDRV_{EXT} to turn off or otherwise disable the external pass element. This is accomplished dynamically in the analog domain via the load sharing circuitry as variously described herein. As further described above, the phrase “substantially all” in this context refers to the example case where small or otherwise acceptable amounts of load current I_{LOAD} may be leaked or otherwise sourced by the external pass element 107 (e.g., less than 1% of I_{LOAD}). In some examples, for instance, each of the internal and external pass elements has a control terminal (e.g., gate or base), and responsive to the load current I_{LOAD} being less than the current threshold I_{STB}, the method includes applying a first voltage to the control terminal of the internal pass element so that the internal pass element provides all of the load current, and applying a second voltage to the control terminal of the external pass element so that the external pass element is effectively off or otherwise provides none of the load current (or otherwise only a negligible amount of the load current). The method proceeds from 1103 to 1111 where a determination is made as to whether or not to continue monitoring. If continued monitoring is desired, then proceed to 1101 and continue with method. If continued monitoring is not desired (e.g., system powered down or offline), then the method may stop.

Responsive to the load current I_{LOAD} not being less than the current threshold I_{STB}, the method continues at 1105 with setting VDRV_{INT} to provide a first portion of I_{LOAD} via the internal pass element, and setting VDRV_{EXT} to provide a second portion (or remainder portion) of I_{LOAD} via the external pass element. The amount of current handled by each pass element varies as the overall load current I_{LOAD} varies, with such transitions happening dynamically and in the analog domain, by operation of load sharing circuitry as variously described herein.

The method further includes a determination at 1107 as to whether the load current I_{LOAD} is greater than the current threshold I_{LIM_INT}. As described above, threshold I_{LIM_INT} can be fixed for a given application, and represents the maximum current level that the internal pass element can safely handle. Responsive to the load current I_{LOAD} not being greater than the current threshold I_{LIM_INT}, the method continues to monitor the load current I_{LOAD}, by returning back to 1101 to repeat.

Responsive to the load current I_{LOAD} being greater than the current threshold I_{LIM_INT}, the method continues at 1109 with limiting the first portion of I_{LOAD} provided by the internal pass element to I_{LIM_INT}, and providing the second (or remainder) portion of I_{LOAD} via the external pass element. In some examples, for instance, each of the internal and external pass elements has a control terminal (e.g., gate or base), and responsive to the load current I_{LOAD} being greater than the current threshold I_{LIM_INT}, the method includes applying a first voltage to the control terminal of the internal pass element so that the internal pass element provides the first portion of the load current (which may be limited to the current threshold I_{LIM_INT}, if the overall load current I_{LOAD} exceeds that threshold), and applying a second voltage to the control terminal of the external pass element so that the external pass element provides none of the load current (or a negligible amount of the load current). The method proceeds from 1109 to 1113 where a determination is made as to whether or not to continue monitoring. If continued monitoring is desired, then proceed to 1101 and continue with method. If continued monitoring is not desired (e.g., system powered down or offline), then the method may stop.

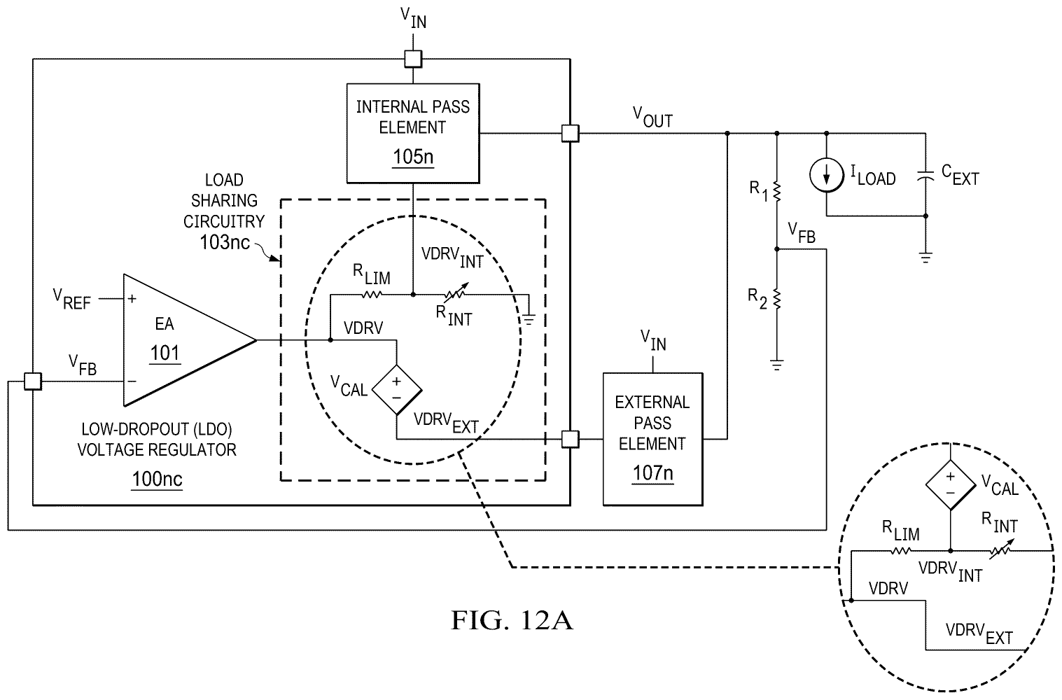

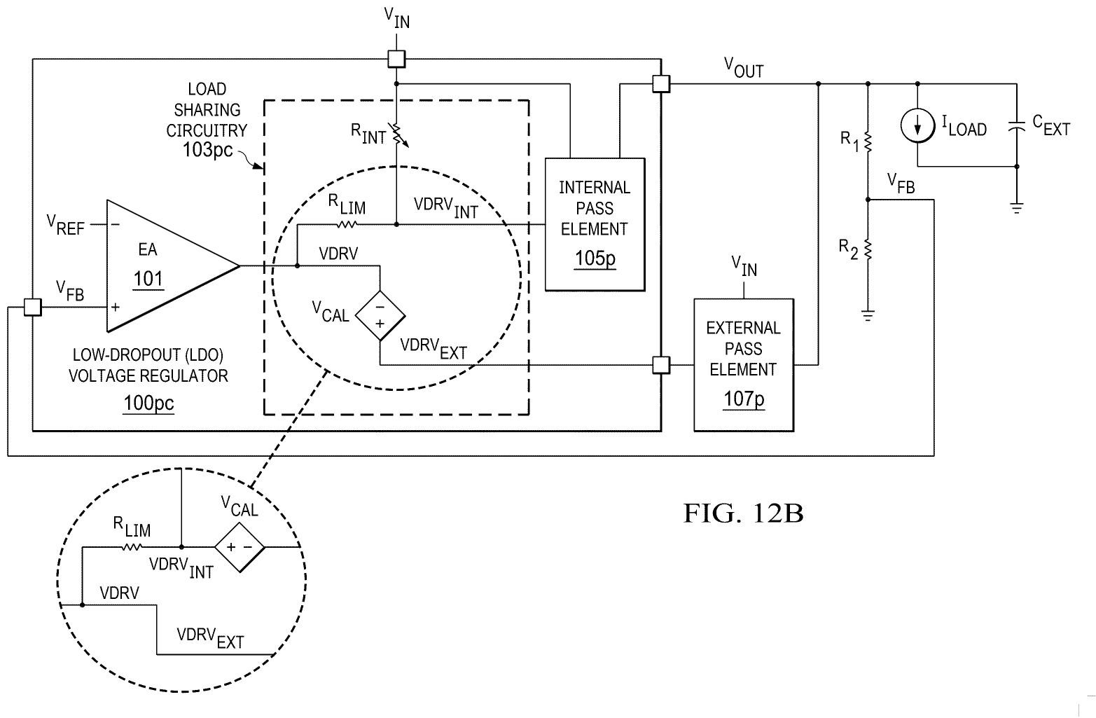

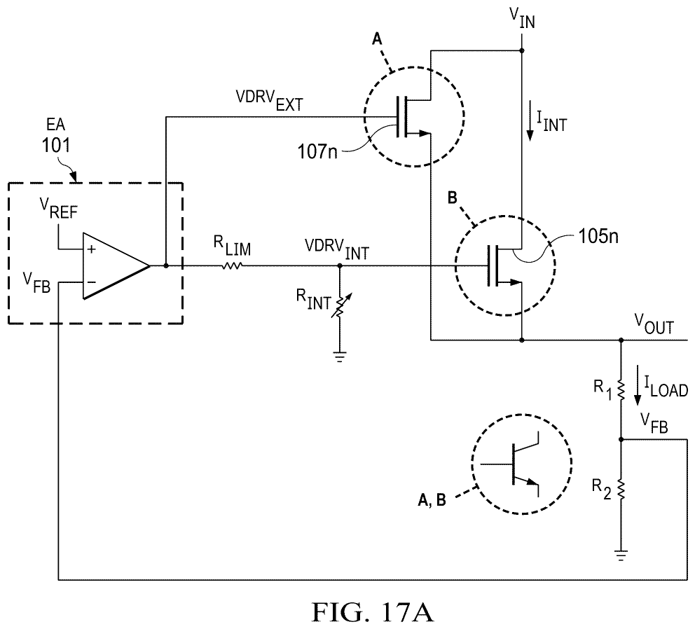

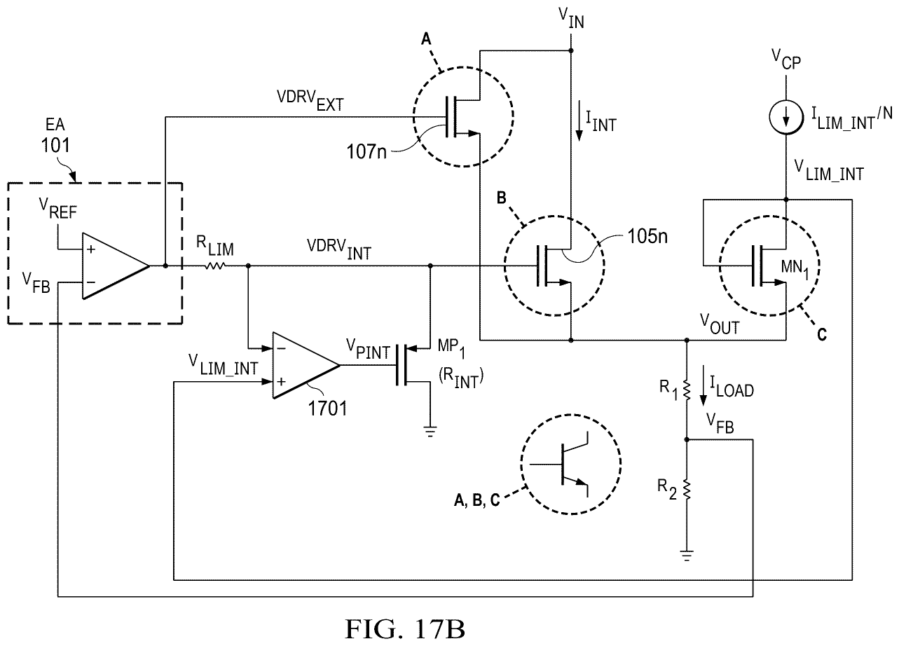

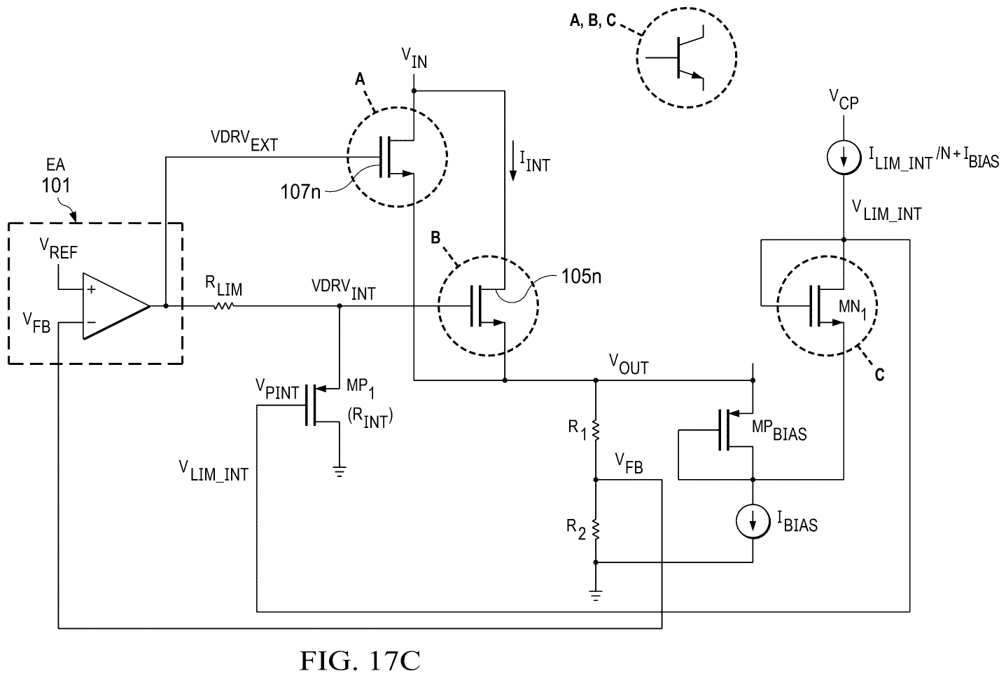

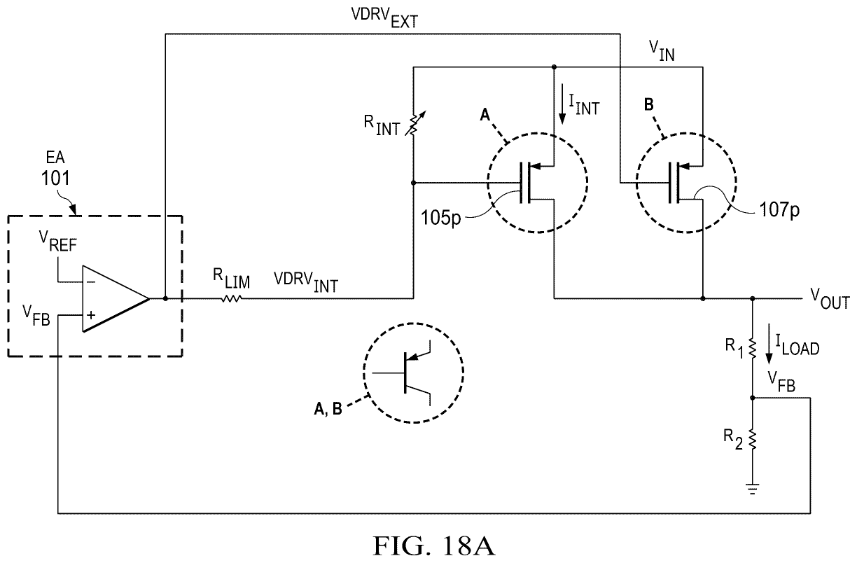

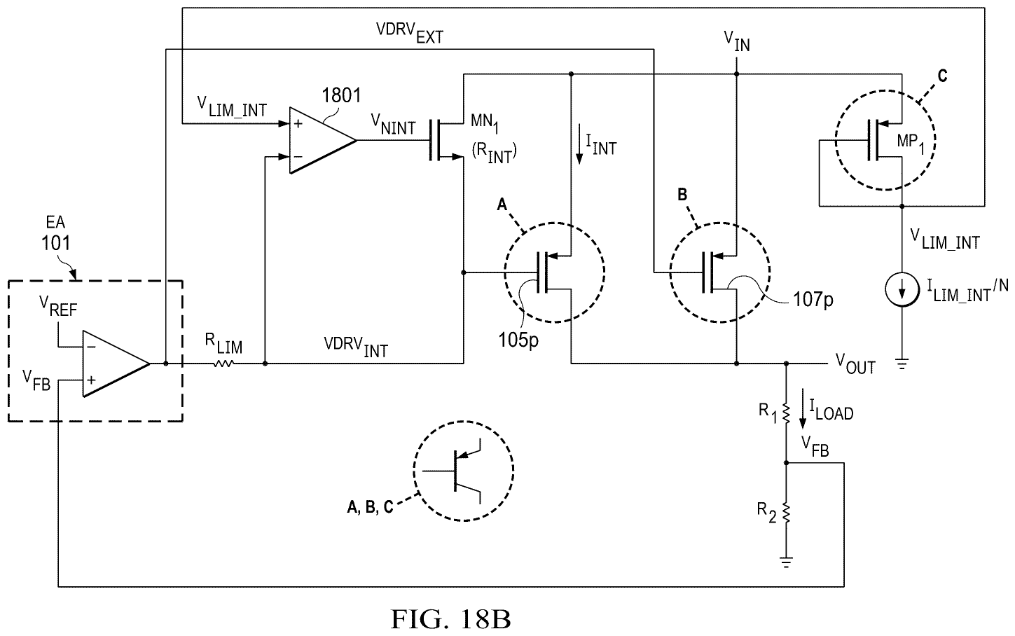

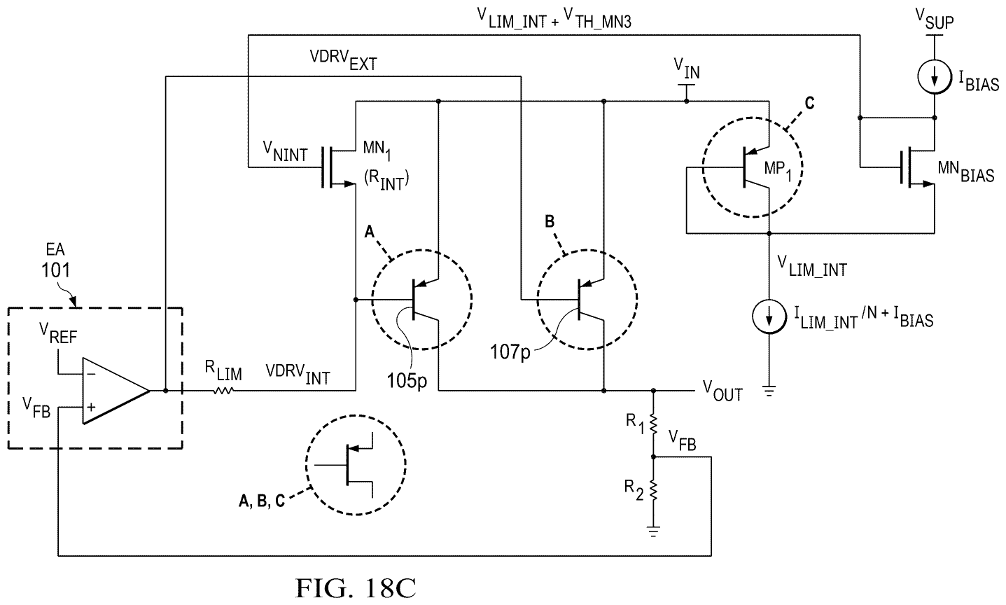

As described above, the methodology can be carried out in the analog domain using the load sharing circuitry of any of the voltage regulators variously described herein. For instance: in the n-type examples of FIG. 1 as described with reference to FIGS. 3-6, the impedance divider including R_{LIML} and R_{INT} (for FIGS. 3-5B and 6) or R_{LIM} and R_{INT} (for FIGS. 5C-D) operates to set the drive voltage VDR V_{INT} of the internal pass element, and the impedance divider including R_{EXT} and Z_{PD} (for FIGS. 3-5B and 6) or R_{LIM2} and MPLIM_{EXT} (for FIGS. 5C-D) operates to set the drive voltage VDRV_{EXT} Of the external pass element; in the p-type examples of FIG. 1 as described with reference to FIGS. 7-10, the impedance divider including R_{LIML} and R_{INT} (for FIGS. 7-9B and 10) or R_{LIM} and MN₁ (for FIGS. 9C-D) operates to set the drive voltage VDRV_{INT} of the internal pass element, and the impedance divider including R_{EXT} and Z_{PC} (for FIGS. 7-9B and 10) or R_{LIM2} and MNLIM_{EXT} (for FIGS. 9C-D) operates to set the drive voltage VDRV_{EXT} of the external pass element; in examples of FIG. 1 as described with reference to FIGS. 12A through 16, the impedance divider including R_{LIM} and R_{INT} operates to set the drive voltage VDRV_{INT} of the internal pass element, and the voltage source V_{CAL} operates to adjust the drive voltage VDRV_{EXT} of the external pass element; and in examples described with reference to FIGS. 17A through 18C, the impedance divider including R_{LIM} and R_{INT} operates to set the drive voltage VDRV_{INT} of the internal pass element, and error amplifier 101 operates to set the drive voltage VDRV_{EXT} of the external pass element, in conjunction with the constraint that the external pass element be weaker than the internal pass element.

As further described above, the internal and external pass elements can be p-type or n-type, and may be the same or different power transistor technologies (e.g., FETs, BJTs, or hybrid configuration that includes a FET and a BJT). As further described above, the internal pass element may be included in an integrated circuit chip that comprises an LDO voltage regulator, and the external pass element may be external to the integrated circuit chip. In other examples, the internal pass element may be included on a printed circuit board (PCB) or be part of a system that comprises an LDO voltage regulator, and the external pass element may be external to the PCB or system. In still other examples, both n-type and p-type circuitry as described herein may be included in an integrated circuit chip or chip set, or on a PCB or PCB set, and n-type and p-type external pass elements may be coupled thereto. Other such internal-external configurations may be used.

Load Sharing with Calibrated Voltage Source

FIG. 12A is a schematic diagram of an n-type LDO voltage regulator 100nc configured for load sharing using a calibrated voltage source, in an example. As shown, this example is similar to the example of FIG. 4, except that in load sharing circuitry 103nc, the variable impedance divider having its output coupled to the control terminal of external pass element 107n has been replaced with a calibrated voltage source V_{CAL}. In such a load sharing scheme, the control voltage VDRV_{INT} provided to the control terminal of internal pass element 105n is supplied by operation of the variable impedance divider (e.g., R_{LIM} and R_{INT}, along with biasing circuitry) as variously described above, and the control voltage VDRV_{EXT} provided to the control terminal of external pass element 107n is the voltage supplied from error amplifier 101 as adjusted by the calibrated voltage source V_{CAL}. The above relevant description with respect to FIGS. 1-6 and 11 is equally applicable here.

The value of voltage source V_{CAL} can be set to compensate for a difference in the threshold voltage of internal pass element 105n and external pass element 107n. The voltage source V_{CAL} may be in different locations of the circuit, such as shown in the dashed pull-out circle. Other locations may be used as well. In any such cases, voltage source V_{CAL} can be serially coupled between the output of error amplifier 101 and the control terminal of either internal pass element 105n or external pass element 107n. The polarity of voltage source V_{CAL} may be reversed from what is shown, depending on which of pass elements 105n and 107n is stronger (e.g., lower V_{TH} (GS) for FETs, or lower V_{TH(BE)} for BJTs) and the location of voltage source V_{CAL}, so as to adjust the control voltage at the corresponding control terminal either up or down as needed to facilitate load sharing. In some examples, a configurable voltage source may be provided at the control terminal or node of both pass elements 105n and 107n, and one of those configurable voltage sources can be set and switched into the circuit after a calibration process has been run to determine the threshold voltage difference of internal pass element 105n and external pass element 107n.

In an example, if internal pass element 105n is an NMOS FET having a threshold voltage of about 1.0 volt, and external pass element 107n is an NMOS FET or an NPN BJT having a threshold voltage of about 0.7 volts, then external pass element 107n is stronger than internal pass element 105n by about 0.3 volts. As such, external pass element 107n will engage and source more current to the load. However, applying a voltage source V_{CAL} having a value of 0.3 volts, with the negative terminal of voltage source V_{CAL}, coupled to the control terminal of external pass element 107n, effectively neutralizes or otherwise compensates for the strength difference and facilitates load sharing.

In some examples, a margin may be added to the actual difference in threshold voltage, so as to make internal pass element 105n slightly stronger than external pass element 107n. Such margin will vary from one example to the next, based on factors such as transistor technology employed (e.g., silicon versus germanium) and the absolute value of the threshold difference, but in some examples is in the range of 10-100 millivolts. For instance, and continuing with the above example, voltage source V_{CAL} could be set to 0.4 volts, which represents the 0.3 volt V_{TH} difference and a 0.1 volt margin.

FIG. 12B is a schematic diagram of a p-type LDO voltage regulator 100pc configured for load sharing using a calibrated voltage source, in an example. As shown, this example is similar to the example of FIG. 7, except that in load sharing circuitry 103pc, the variable impedance divider having its output coupled to the control terminal of external pass element 107p has been replaced with calibrated voltage source V_{CAL}. In such a load sharing scheme, the control voltage VDRV_{INT} provided to the control terminal of internal pass element 105p is supplied by operation of the variable impedance divider (e.g., R_{LIM} and R_{INT}, along with biasing circuitry) as variously described above, and the control voltage VDRV_{EXT} provided to the control terminal of external pass element 107p is the voltage supplied from error amplifier 101 as adjusted by the calibrated voltage source V_{CAL}. The above relevant description with respect to FIGS. 1-2 and 7-11 is equally applicable here.

The value of voltage source V_{CAL} can be set to compensate for a difference in the threshold voltage of internal pass element 105p and external pass element 107p. The voltage source V_{CAL} may be in different locations of the circuit, such as shown in the dashed pull-out circle. Other locations may be used as well. In any such cases, voltage source V_{CAL} can be serially coupled between the output of error amplifier 101 and the control terminal of either internal pass element 105p or external pass element 107p. The polarity of voltage source V_{CAL} may be reversed from what is shown, depending on which of pass elements 105p and 107p is stronger (e.g., lower V_{TH} (GS), or lower V_{TH} (BE)) and the location of voltage source V_{CAL}, so as to adjust the control voltage at the corresponding control terminal either up or down as needed to facilitate load sharing. In some examples, a configurable voltage source may be provided at the control terminal or node of both pass elements 105p and 107p, and one of those configurable voltage sources can be set and switched into the circuit after a calibration process has been run to determine the threshold voltage difference of internal pass element 105p and external pass element 107p.

In an example, if internal pass element 105p is a PMOS FET having a threshold voltage of about 1.0 volt and external pass element 107p is a PMOS FET or an PNP BJT having a threshold voltage of about 0.7 volts, then external pass element 107p is stronger than internal pass element 105p by about 0.3 volts. As such, external pass element 107p will engage and source more current to the load. However, applying a voltage source V_{CAL} having a value of 0.3 volts, with the positive terminal of voltage source V_{CAL} coupled to the control terminal of external pass element 107p, effectively neutralizes or otherwise compensates for the strength difference and facilitates load sharing.

Just as described with respect to FIG. 12A, a margin may be added to the actual difference in threshold voltage, so as to make internal pass element 105p slightly stronger than external pass element 107p. Such margin will vary from one example to the next, based on factors such as transistor technology employed and the absolute value of the threshold difference, but in some examples is in the range of 10-100 millivolts. For instance, and continuing with the above example, voltage source could be set to 0.4 volts, which represents the 0.3 volt difference and a 0.1 volt margin.

### Calibration Methodology and Circuitry

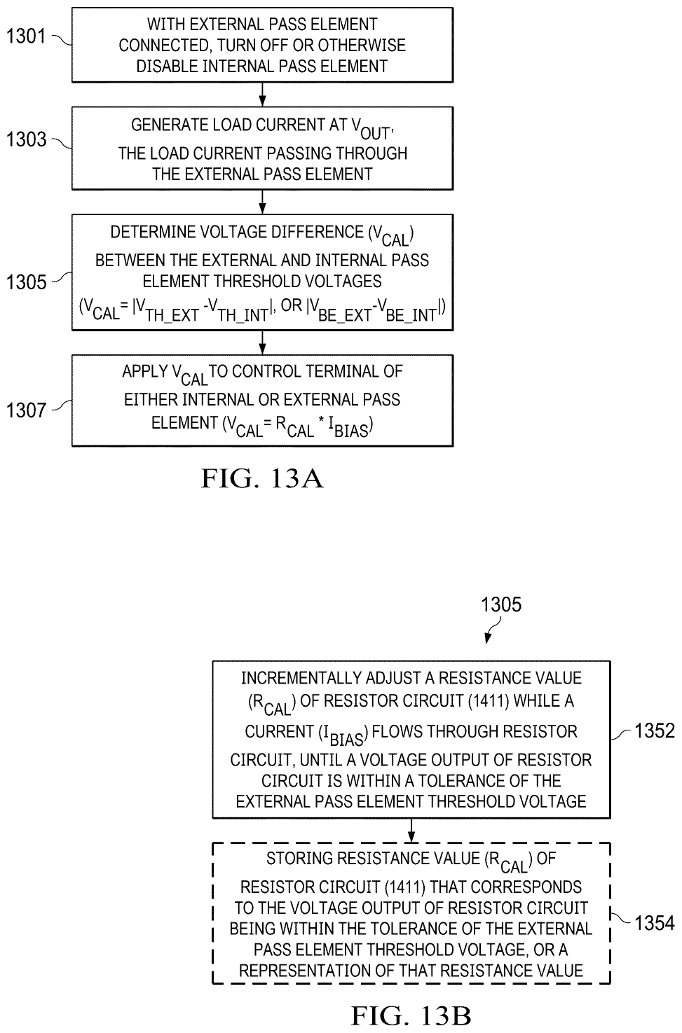

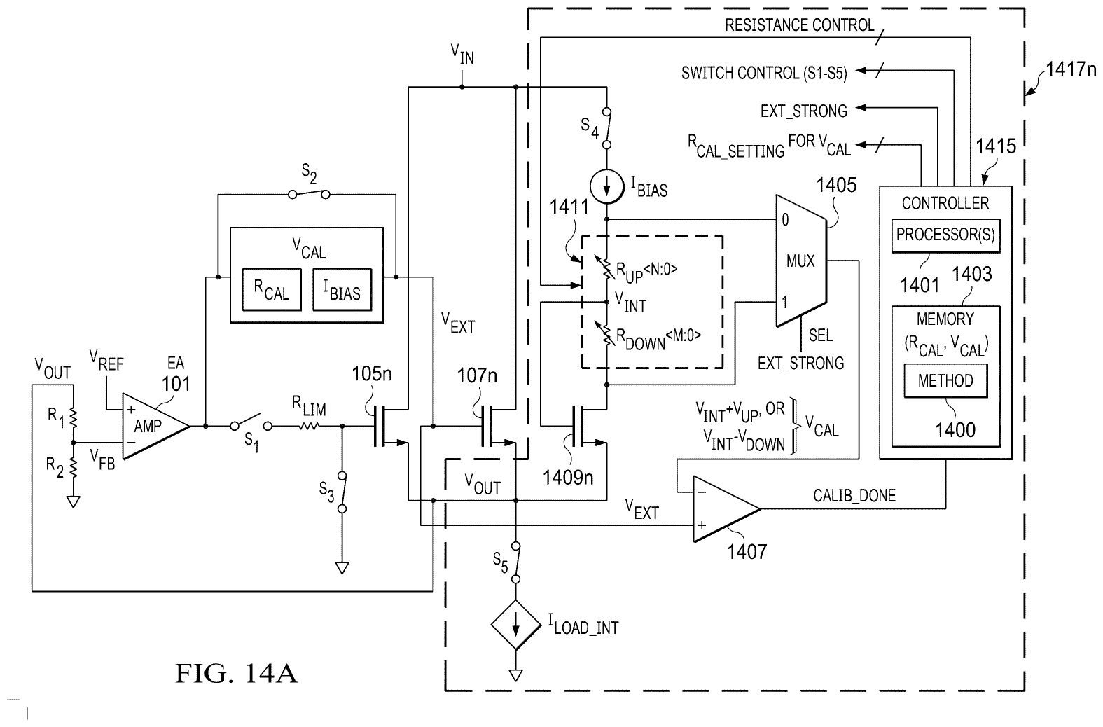

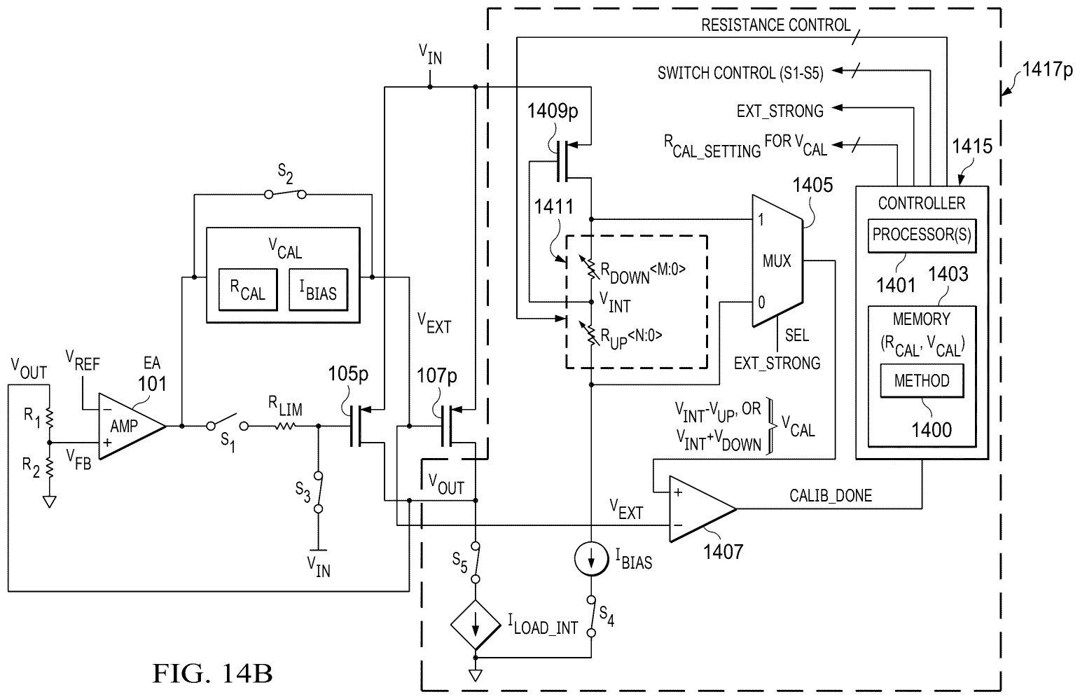

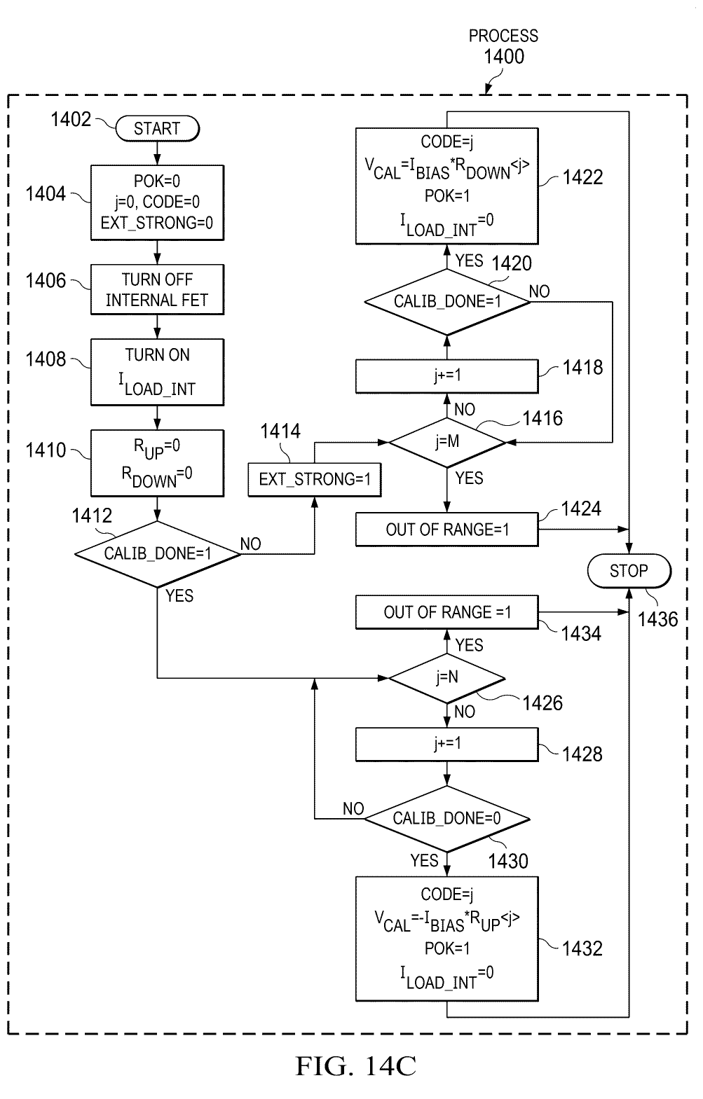

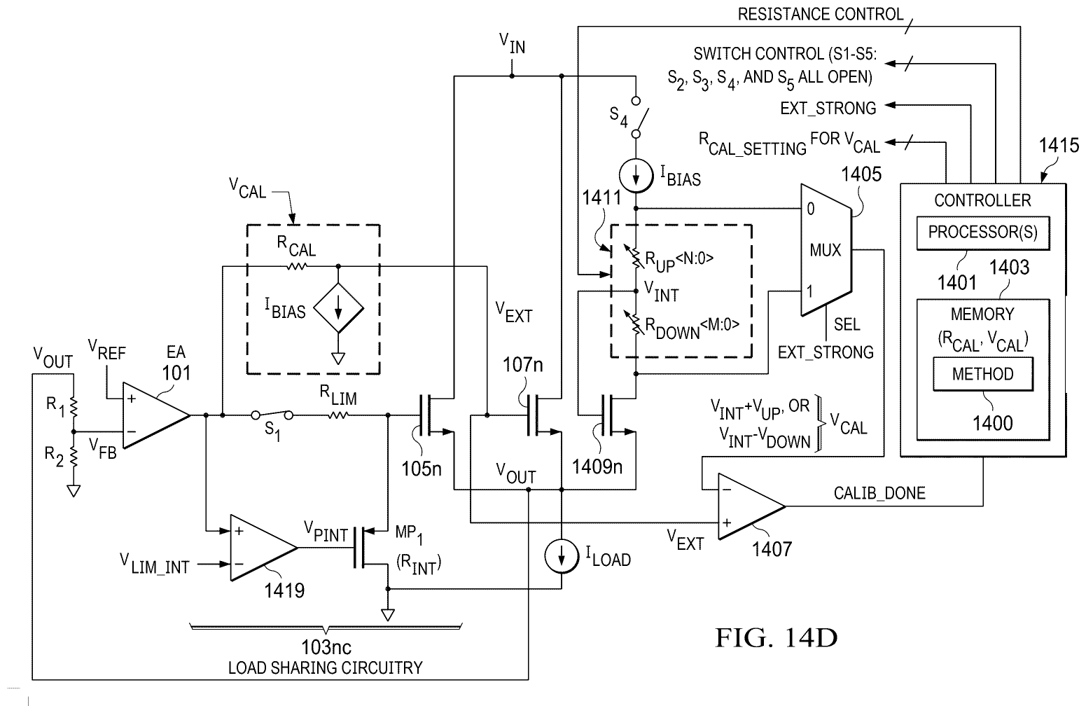

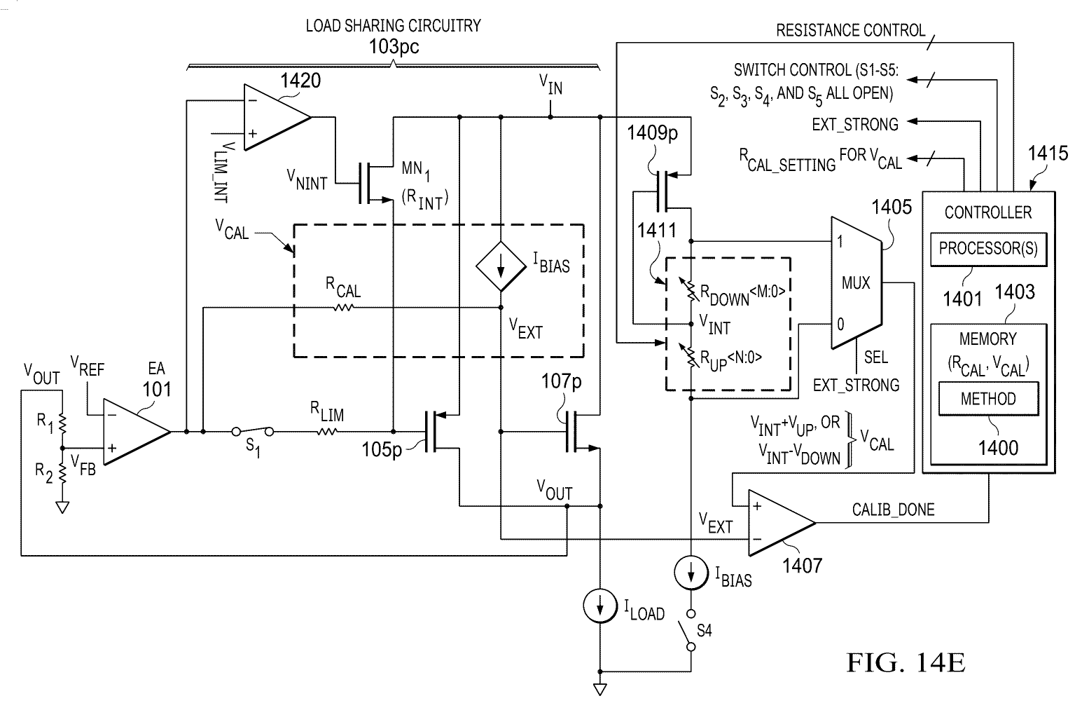

FIG. 13A is a flow diagram of a method for calibrating an LDO voltage regulator configured for load sharing, in an example. The LDO voltage regulator may be n-type or p-type. FIG. 13B is a flow diagram of a method for determining the voltage difference between external and internal pass element threshold voltages for the method of FIG. 13A, in an example. In describing the methodology of FIGS. 13A-B, brief reference is made to the example n-type LDO voltage regulator shown in FIG. 14A, and to the example p-type LDO voltage regulator shown in FIG. 14B, which are further described below. Other voltage regulators configured to adaptively share load current between internal and external pass elements may also benefit from the methodology.

As shown, with both an internal pass element and an external pass element coupled between the V_{IN} and V_{OUT} terminals of the voltage regulator, the method includes turning off or otherwise disabling 1301 the internal pass element. This can be accomplished, for instance, with one or more switching elements, such as a switch coupled between the error amplifier 101 output and the control terminal of internal pass element (e.g., S₁ of FIG. 14A or 14B), and/or a switch from the control terminal of the internal pass element to ground for n-type pass elements (e.g., S₃ of FIG. 14A) or from the control terminal of the internal pass element to a supply terminal (e.g., V_{IN} terminal) for p-type pass elements (e.g., S₃ of FIG. 14B).

The method continues with generating 1303 a load current at the V_{OUT} terminal, the load current passing through the external pass element. The load current can be, for instance, an on-chip or otherwise built-in load (e.g., I_{LOAD_INT} of FIG. 14A or 14B) configured to provide a pre-established (known) load current value. In other examples, the known load current can be provided to a terminal of the voltage regulator via an external current source, while carrying out the calibration process.

The method continues with determining 1305 a voltage difference between a threshold voltage of the internal pass element and a threshold voltage of the external pass element. This determination effectively determines which of the pass elements is stronger, meaning which of the pass elements has a lower threshold voltage V_{TH}. For example, if the pass elements are FETs (e.g., MOSFETs), then the FET having the lower V_{TH(GS)} is stronger than the other FET. Likewise, if the pass elements are BJTs, then the BJT having the lower V_{TH(BE)} is stronger than the other BJT. This voltage difference can be determined, for instance, using a comparator circuit configured to determine the absolute voltage difference between the two threshold voltages of the internal and external pass elements. FIG. 13B illustrates an example methodology for the determination at 1305, and is described in turn.

Once the voltage difference is determined, the method may further include applying 1307 the voltage difference (via voltage source V_{CAL}, such as shown in FIG. 12A or 12B) to a control terminal of the internal pass element or the external pass element, to compensate for that difference. In this manner, the voltage source V_{CAL} can be used to effectively neutralize any strength or weakness of a given pass element, so that load sharing can be carried out. As described above, the voltage difference may be adjusted by a margin (e.g., 10-100 millivolts), to favor the internal pass element being stronger than the external pass element. V_{CAL} may also be used herein to refer to the value of the voltage difference itself (as measured during calibration mode), in addition to the voltage source itself that provides that final calibrated voltage value (as used during run mode).

In some such examples, and with further reference to FIG. 13B, determining V_{CAL} at 1305 includes incrementally adjusting 1352 a resistance value of an adjustable resistor circuit (e.g., 1411 of FIGS. 14A-B) while a known current (e.g., I_{BIAS} of FIG. 14A or 14B) flows through the resistor circuit, until a voltage output of the resistor circuit is within a tolerance of the external pass element threshold voltage. For instance, in the examples of FIGS. 14A-B, the determination of when the voltage output of the resistor circuit is within a tolerance of the external pass element threshold voltage is made by comparator 1407. Briefly, and as further described below, the output of comparator 1407 transitions from a low state to a high state (or vice-versa) to signal when the voltage output of the resistor circuit is within a tolerance of the external pass element threshold voltage. As further shown in FIG. 13B, the method may further include storing 1354 the resistance value of the resistor circuit that corresponds to the voltage output of the resistor circuit being within the tolerance of the external pass element threshold voltage, or a representation of that resistance value. This resistance value is referred to herein as R_{CAL}. In some such examples, for instance, the R_{CAL} and V_{CAL} values may be stored in a controller memory or register (e.g., memory 1403 of controller 1415 in FIGS. 14A-B and 14D-E), and applying V_{CAL} at 1307 may include switching a voltage source having the V_{CAL} value into the path between the output of error amplifier and the external pass element (or the internal pass element, as the case may be). In one such example, for instance, the V_{CAL} voltage source includes a current source I_{BIAS} pumping current through a resistor that has R_{CAL} for its resistance value (e.g., V_{CAL}=R_{CAL}*I_{BIAS}, as shown in FIGS. 14A-B and 14D-E).

FIGS. 14A-B and 14D-E illustrate example LDO voltage regulators configured with a calibration circuit (1417n in FIGS. 14A and 14D, and 1417p for FIGS. 14B and 14E) for determining V_{CAL}, in an example. The LDO voltage regulator may be operated in a calibration mode (e.g., FIGS. 14A-B) or a run/normal mode (e.g., FIGS. 14D-E). In the examples of FIGS. 14A and 14D, the LDO voltage regulator is n-type, and in the examples of FIGS. 14B and 14E, the LDO voltage regulator is p-type. FIG. 14C shows an example calibration methodology that can be used in both n-type and p-type configurations. Note that features not utilized for the given operation mode may not be shown in the given figure. For instance, the example n-type calibration mode depicted in FIG. 14A does not show all the example features of the n-type load sharing circuitry 103nc depicted in FIG. 14D (e.g., R_{INT} is not shown in FIG. 14A), and the example n-type run mode depicted in FIG. 14D does not show all the example features of the n-type calibration circuitry 1417n depicted in FIG. 14A (e.g., switches S₂, S₃, and S₅ are not shown in FIG. 14D); similarly, the example p-type calibration mode depicted in FIG. 14B does not show all the example features of the p-type load sharing circuitry 103pc depicted in FIG. 14E (e.g., R_{INT} is not shown in FIG. 14B), and the example p-type run mode depicted in FIG. 14E does not show all the example features of the p-type calibration circuitry 1417p depicted in FIG. 14B (e.g., switches S₂, S₃, and S₅ are not shown in FIG. 14E). In some examples, the calibration mode can be run, for instance, at each start-up of the LDO voltage regulator, and may also be repeated periodically during longer run mode sessions. In other examples, calibration mode may be run, for instance, every Nth startup (where N is an integer of 2 or more), or otherwise less frequently, which may be desirable where a given external pass element and load will not be changed during the time period between calibrations. Run mode may engage (or re-engage) upon successful completion of calibration mode. The above relevant discussion is equally applicable here.

As further shown in the n-type example of FIG. 14A, error amplifier 101 has its output switchably coupled to both the control terminal of pass element 105n (via switch S₁ and resistor R_{LIM}) and the control terminal of pass element 107n (via a configurable voltage source V_{CAL} that can be by-passed by switch S₂). As previously described above, each of pass elements 105n and 107n are coupled between the V_{IN} and V_{OUT} terminals, and pass element 105n may be internal to the LDO voltage regulator, and pass element 107n may be external to the LDO voltage regulator. In this example, configurable voltage source V_{CAL} includes an adjustable resistor circuit (set to R_{CAL} value) and a current source I_{BIAS}.

As further shown in the n-type example of FIG. 14A, calibration circuit 1417n includes analog multiplexer (MUX) 1405, comparator 1407, replica pass element 1409n, adjustable resistor circuit 1411, an internal load I_{LOAD} INT, a current source I_{BIAS}, and controller 1415. Switches S₁-S₅ can be set for calibration mode or run mode. Controller 1415 may include, for instance, one or more processors 1401, one or more memories 1403 for storing instructions (e.g., calibration method 1400 of FIG. 14C) executable by the one or more processors 1401, and a number of input/output ports for providing and receiving data and commands. Controller 1415 may include other circuitry as well, such as one or more digital registers, clock or oscillator circuitry, line drivers, amplifiers, logical operators, and sensing circuitry. In this example, memory 1403 of controller 1415 stores calibration factors such as R_{CAL} and V_{CAL}.

As further shown in the n-type example of FIG. 14A, replica pass element 1409n, adjustable resistor circuit 1411, and current source I_{BIAS} are serially coupled with one another between the V_{IN} and V_{OUT} terminals, and can be switched in or out of the circuit via switch S₄. Adjustable resistor circuit 1411 is coupled between current source I_{BIAS} and replica pass element 1409n, and includes first and second banks of switchable resistors (R_{UP}<N: 0> and R_{DOWN}<M: 0>), respectively, with each bank allowing for an incremental increase in the resistance it provides based on the resistance control signal(s) provided by controller 1415. Adjustable resistor circuit 1411 has a first output corresponding to the first resistor bank (R_{UP}<N: 0>) and that is coupled to a first input (0) of multiplexer 1405, and a second output corresponding to the second resistor bank (R_{DOWN}<M: 0>) and that is coupled to a second input (1) of multiplexer 1405. The node between the two resistor banks (labelled V_{INT} in FIG. 14A) is coupled to the control terminal of the replica pass element 1409n, which is a scaled down replica of pass element 105n and has its source coupled to the V_{OUT} terminal and its drain coupled to the second output of adjustable resistor circuit 1411.

As further shown in the n-type example of FIG. 14A, the voltage V_{INT} at the node between the two resistor banks of adjustable resistor circuit 1411 refers to the threshold voltage V_{TH} for which replica pass element 1409n turns on to carry the known current provided by current source I_{BIAS}. Because replica pass element 1409n is scaled down replica of internal pass element 105n, V_{INT} can be used to determine the threshold voltage V_{TH} for internal pass element 105n (V_{TH_105n}). For instance, in one such example, the W/L ratio of internal pass element 105n is X times larger than the W/L ratio of replica pass element 1409n, X being an integer of 2 or more, W and L being the width and length, respectively, of the current carrying area of the channel region, and wherein each of 105n and 1409n is an NMOS FET. In such an example case, the threshold voltage V_{TH_105n} is equal to V_{INT}.

As further shown in the n-type example of FIG. 14A, the first resistor bank (R_{UP}<N: 0>) allows for up to N upward incremental adjustments of V_{INT} (e.g., V_{INT}+Vᵤₚ<n: 0>, wherein V_{CP}<n: 0> is the voltage drop across R_{UP}<n: 0>) for when internal pass element 105n is stronger than external pass element 107n, and the second resistor bank (R_{pow}><M: 0>) allows for up to M downward incremental adjustments of V_{INT} (e.g., V_{INT}-V_{DOWN}<m: 0>, wherein V_{Dowx}<m: 0> is the voltage drop across R_{powx}<m: 0>) for when external pass element 107n is stronger than internal pass element 105n. The output of analog multiplexer 1405 is coupled to the inverting input of comparator 1407, and receives the voltage presented at either the first or second MUX input, depending on the control signal EXT_STRONG applied to the SEL input. In this example, if external pass element 107n is weaker than internal pass element 105n, then control signal EXT_STRONG is set low which in turn causes the V_{CAL} voltage at the first MUX input (e.g., V_{CAL}=V_{INT}+V_{CP}<n: 0>) to be provided to the inverting input of comparator 1407. On the other hand, if external pass element 107n is stronger than internal pass element 105n, then control signal EXT_STRONG is set high which in turn causes the V_{CAL} voltage at the second MUX input (e.g., V_{CAL}=V_{INT}-V_{DOWN}<m: 0>) to be provided to the inverting input of comparator 1407. The non-inverting input of comparator 1407 is coupled to the control terminal of external pass element 107n, which provides V_{EXT}, which in this configuration is the threshold voltage of the external pass element 107n (V_{TH_107n}). If V_{EXT} is greater than or equal to V_{CAL}, then CALIB_DONE is set high (meaning internal pass element 105n is stronger than external pass element 107n); on the other hand, if V_{CAL} is greater than V_{EXT}, then CALIB_DONE is set low (meaning external pass element 107n is stronger than internal pass element 105n).

Briefly, in operation, and as further described below with further reference to FIG. 14C, calibration circuit 1417n is configured to determine the difference between V_{TH} of pass element 105n and V_{TH} of pass element 107n, by setting switches S₁-S₅ for the calibration mode, forcing a known load (I_{LOAD} INT) at the V_{OUT} terminal, and incrementally adjusting adjustable resistor circuit 1411 until the voltage V_{CAL} on the inverting input of comparator 1407 causes the comparator output signal CALIB_DONE to toggle from one state to another state (high to low, or low to high). Once CALIB_DONE toggles, the V_{CAL} value on the inverting input of comparator 1407 may be saved into memory 1403 of controller 1415, along with the corresponding R_{CAL} value of adjustable resistor circuit 1411 that yielded that V_{CAL} value. In some examples, controller 1415 may be configured to apply V_{CAL} to the control terminal of pass element 107n (or 105n, as the case may be) by, for example, applying the saved or otherwise determined R_{CAL} value into the variable resistor circuit of voltage source V_{CAL}, so that when I_{BIAS} passes through the variable resistor circuit, the voltage source generates the V_{CAL} voltage. The calibration mode may then end so that normal run mode may commence or otherwise continue, with the V_{CAL} voltage source switched in to facilitate load sharing.

As further shown in the p-type example of FIG. 14B, error amplifier 101 has its output switchably coupled to both the control terminal of pass element 105p (via switch S₁ and resistor R_{LIM}) and the control terminal of pass element 107p (via a configurable voltage source V_{CAL}, that can be by-passed by switch S₂). As previously described above, each of pass elements 105p and 107p are coupled between the V_{IN} and V_{OUT} terminals, and pass element 105p may be internal to the LDO voltage regulator, and pass element 107p may be external to the LDO voltage regulator. In this example, configurable voltage source V_{CAL} includes an adjustable resistor circuit (set to R_{CAL} value) and a current source I_{BIAS}.

As further shown in the p-type example of FIG. 14B, calibration circuit 1417p includes analog multiplexer (MUX) 1405, comparator 1407, replica pass element 1409p, adjustable resistor circuit 1411, an internal load I_{LOAD} INT, a current source I_{BIAS}, and controller 1415. Switches S₁-S₅ can be set for calibration mode or run mode. The above description of controller 1415 is equally applicable here.

As further shown in the p-type example of FIG. 14B, replica pass element 1409p, adjustable resistor circuit 1411, and current source I_{BIAS} are serially coupled with one another between the V_{IN} and ground terminals, and can be switched in or out of the circuit via switch S₄. Adjustable resistor circuit 1411 is coupled between current source I_{BIAS} and replica pass element 1409p, and includes first and second banks of switchable resistors (R_{powx}<M: 0> and R_{UP}<N: 0>), respectively, with each bank allowing for an incremental increase in the resistance it provides based on the resistance control signal(s) provided by controller 1415. Adjustable resistor circuit 1411 has a first output corresponding to the first resistor bank (R_{powx}<M: 0>) and that is coupled to a second input (1) of multiplexer 1405, and a second output corresponding to the second resistor bank (R_{UP}<N: 0>) and that is coupled to a first input (0) of multiplexer 1405. The node between the two resistor banks (labelled V_{INT} in FIG. 14B) is coupled to the control terminal of the replica pass element 1409p, which is a scaled down replica of pass element 105p and has its source coupled to the V_{IN} terminal and its drain coupled to the second output of adjustable resistor circuit 1411.

As further shown in the p-type example of FIG. 14B, the voltage V_{INT} at the node between the two resistor banks of adjustable resistor circuit 1411 refers to the threshold voltage V_{TH} for which replica pass element 1409p turns on to carry the known current provided by current source I_{BIAS}. Because replica pass element 1409p is scaled down replica of internal pass element 105p, V_{INT} can be used to determine the threshold voltage V_{TH} for internal pass element 105p (V_{TH_105p}). For instance, in one such example, the W/L ratio of internal pass element 105p is X times larger than the W/L ratio of replica pass element 1409p, X being an integer of 2 or more, W and L being the width and length, respectively, of the current carrying area of the channel region, and wherein each of 105p and 1409p is a PMOS FET. In such an example case, the threshold voltage V_{TH_105p} is equal to V_{INT}.

As further shown in the p-type example of FIG. 14B, the first resistor bank (R_{powx}<M: 0>) allows for up to M upward incremental adjustments of V_{INT} (e.g., V_{INT}+Vpowx<m: 0>, wherein V_{Dowx}<m: 0> is the voltage drop across R_{powx}<m: 0>) for when internal pass element 105p is stronger than external pass element 107p, and the second resistor bank (R_{UP}<N: 0>) allows for up to N downward incremental adjustments of V_{INT} (e.g., V_{INT}-V_{UP}<n: 0>, wherein Vᵤₚ<n: 0> is the voltage drop across R_{UP}<n: 0>) for when external pass element 107p is stronger than internal pass element 105p. The output of analog multiplexer 1405 is coupled to the non-inverting input of comparator 1407, and receives the voltage presented at either the first or second MUX input, depending on the control signal EXT_STRONG applied to the SEL input. In this example, if internal pass element 105p is stronger than external pass element 107p, then control signal EXT_STRONG is set low which in turn causes the V_{CAL} voltage at the first MUX input (e.g., V_{CAL}=V_{INT}-V_{UP}<n: 0>) to be provided to the non-inverting input of comparator 1407. On the other hand, if external pass element 107p is stronger than internal pass element 105p, then control signal EXT_STRONG is set high which in turn causes the V_{CAL} voltage at the second MUX input (e.g., V_{CAL}=V_{INT}+V_{DOWN}<m: 0>) to be provided to the non-inverting input of comparator 1407. The inverting input of comparator 1407 is coupled to the control terminal of external pass element 107p, which provides V_{EXT}, which in this configuration is the threshold voltage of the external pass element 107p (V_{TH_107p}). If V_{EXT} is less than or equal to V_{CAL}, then CALIB_DONE is set high (meaning internal pass element 105p is stronger than external pass element 107p); on the other hand, if V_{CAL} is less than V_{EXT}, then CALIB_DONE is set low (meaning external pass element 107p is stronger than internal pass element 105p).

Briefly, in operation, and as further described below with further reference to FIG. 14D, calibration circuit 1417p is configured to determine the difference between V_{TH} of pass element 105p and V_{TH} of pass element 107p, by setting switches S₁-S₅ for the calibration mode, forcing a known load (I_{LOAD} INT) at the V_{OUT} terminal, and incrementally adjusting adjustable resistor circuit 1411 until the voltage V_{CAL} on the non-inverting input of comparator 1407 causes the comparator output signal CALIB_DONE to toggle from one state to another state (high to low, or low to high). Once CALIB_DONE toggles, the V_{CAL} value on the non-inverting input of comparator 1407 may be saved into memory 1403 of controller 1415, along with the corresponding R_{CAL} value of adjustable resistor circuit 1411 that yielded that V_{CAL} value. In some examples, controller 1415 may be configured to apply V_{CAL} to the control terminal of pass element 107p (or 105p, as the case may be) by, for example, applying the saved or otherwise determined R_{CAL}, value into the variable resistor circuit of voltage source V_{CAL}, so that when I_{BIAS} passes through the variable resistor circuit, the voltage source generates the V_{CAL} voltage. The calibration mode may then end so that normal run mode may commence or otherwise continue, with the V_{CAL} voltage source switched in to facilitate load sharing.

FIG. 14C illustrates a calibration method 1400 that can be executed by a controller (e.g., processor(s) 1401 of controller 1415 of the examples shown in FIGS. 14A-B, or other suitable processor), in an example. The method 1400 can be used with either n-type or p-type pass elements and is described with further reference to FIGS. 14A-B, but may also be executed by other voltage regulator configurations that allow for comparable functionality.

The method 1400 commences at 1402, which may correspond, for instance, with start-up of the LDO voltage regulator, or a scheduled calibration according to an established protocol, or a requested calibration. At 1404, variables are initialized, which in this example includes: setting POK to 0 (to indicate calibration mode is active), initializing counter j and CODE to 0 (to allow for incrementing resistance value, and tracking number of iterations); and setting EXT_STRONG to 0, which means that the default setting for this example is that the internal pass element (105n or 105p) is stronger than the external pass element (107n or 107p). Setting POK to 0 may further cause controller 1415 to set one or more switches to place the voltage regulator in calibration mode. For instance, in the example of FIG. 14A, switch S₂ may be closed by controller 1415, to bypass the V_{CAL} voltage source (which is not used during calibration). Note that POK and CODE are not intended to convey any substantive meaning, and are just given names of variables.

At 1406, the method 1400 includes turning off or otherwise disabling internal pass element. In the example of FIG. 14A, this may be accomplished, for instance, by controller 1415 causing switch S₁ to open and switch S₃ to close, which in the n-type example of FIG. 14A allows the control terminal of pass element 105n to be grounded (which fully turns off the n-type pass element), and which in the p-type example of FIG. 14B allows the control terminal of pass element 105p to be pulled to V_{IN} (which fully turns off the p-type pass element). In another example, any such switching may be done at 1404, rather than in a separate switch call.

At 1408, the method 1400 includes turning on or otherwise enabling the internal load I_{LOAD} INT. In the examples of FIGS. 14A-B, this may be accomplished, for instance, by controller 1415 causing switches S₄ and S₅ to close, which allows known current I_{BIAS} to flow through resistor circuit 1411 and replica pass element 1409n or 1409p. In another example, any such switching may be done at 1404, rather than in a separate switch call. In still other embodiments, one or both of current source I_{BIAS} and internal load I_{LOAD_INT} may be directly enabled (and disabled) by controller 1415, rather than switched in.

At 1410, the method 1400 includes initializing the resistance of the resistor banks in resistor circuit 1411. In this example, the resistance of each bank (R_{UP}<n: 0> and R_{DOWN}<m: 0>) is initially set to zero ohms by the resistance control signal(s) generated by controller 1415 (e.g., n=0; m=0, such that each resistor of each bank is bypassed with a switch that is controlled by a corresponding resistance control signal from controller 1415). As such, the initial voltage drop across R_{UP}<n: 0> (referred to as Vᵤₚ in FIGS. 14A-B) is zero volts, and the initial voltage drop across R_{powx}<m: 0> (referred to as V_{DOWN} in FIGS. 14A-B) is also zero volts. Accordingly, the voltages provided at the first and second outputs of resistor circuit 1411 and that are applied to the MUX inputs are both V_{INT}. The voltage V_{INT} is thus the initial value of V_{CAL} that is applied to the inverting input of comparator 1407 (for n-type in FIG. 14A) or the non-inverting input of comparator 1407 (for p-type in FIG. 14B), and represents the threshold voltage of internal pass element. The voltage V_{EXT} is applied to the non-inverting input of comparator 1407 (for n-type in FIG. 14A) or the inverting input of comparator 1407 (for p-type in FIG. 14B), and represents the threshold voltage of external pass element. Thus, comparator 1407 can compare V_{INT} and V_{EXT}, and indicate which one is greater (based on the state of CALIB_DONE), thereby indicating which of the internal and external pass elements is stronger.

To this end, the method 1400 continues at 1412 with determining if CALIB_DONE is high (or low). This can be done, for instance, by way of controller 1415 receiving and interrogating the CALIB_DONE output of comparator 1407. In more detail, if CALIB_DONE is low (logic 0), then the method 1400 continues at 1414 with setting EXT_STRONG to high (logic 1). For the n-type configuration of FIG. 14A, this causes mux 1405 to provide the second output of resistor circuit 1411 (V_{INT}-V_{DOWN}) to the inverting input of comparator 1407; and for the p-type configuration of FIG. 14B, this causes mux 1405 to provide the first output of resistor circuit 1411 (V_{INT}+V_{DOWN}) to the inverting input of comparator 1407. The differences in coupling depicted in FIGS. 14A and 14B with respect to outputs of resistor circuit 1411 and the inputs of multiplexer 1405 and comparator 1407, account for the polarity inversion between n-type and p-type configurations.

The method 1400 continues at 1416 with determining if counter j has reached its maximum threshold M yet (which corresponds to the maximum resistance of the R_{DOWN} resistor bank of resistor circuit 1411. If threshold M has been reached, then an error flag is set (e.g., out of range=1) at 1424 and the calibration method 1400 stops at 1436. If, on the other hand, threshold M has not been reached, then the counter j is incremented at 1418 by controller 1415, which in turn causes the next incremental resistance value of the R_{powx} resistor bank of resistor circuit 1411 to be switched in. For the n-type configuration of FIG. 14A, this causes the value at the inverting input of comparator 1407 to incrementally decrease (V_{CAL}=V_{INT}-V_{DOWN}<m: 0>); and for the p-type configuration of FIG. 14B, this causes the value at the non-inverting input of comparator 1407 to incrementally increase (V_{CAL}=V_{INT}+V_{DOWN}<m: 0>).

The method 1400 then continues at 1420 with determining if CALIB_DONE has transitioned from low to high. Again, this can be done by way of controller 1415 receiving and interrogating the CALIB_DONE output of comparator 1407. If CALIB_DONE has not transitioned from low to high, then the method 1400 continues at 1416 with determining if counter j has reached its maximum threshold M yet. If so, then an error flag is set (e.g., out of range=1) at 1424 and the method 1400 stops at 1436. If, on the other hand, threshold M has not been reached, then the counter j is once again incremented at 1418, which in turn causes the next incremental resistance value of the R_{DOWN} resistor bank to switched in. For the n-type configuration of FIG. 14A, this causes the value at the inverting input of comparator 1407 to incrementally decrease (V_{CAL}=V_{INT}-V_{DOWN}<m: 0>); and for the p-type configuration of FIG. 14B, this causes the value at the non-inverting input of comparator 1407 to incrementally increase (V_{CAL}=V_{INT}+V_{DOWN}<m: 0>).

The method 1400 then continues at 1420 with once again determining if CALIB_DONE has transitioned from low to high. If not, the incrementing process of 1416, 1418, and 1420 repeats. If, on the other hand, it is determined at 1420 that CALIB_DONE has transitioned from low to high, then the method continues at 1422, where counter value j is saved as CODE (which can be used to set R_{CAL} of the V_{CAL} voltage source), V_{CAL} is set equal to I_{BIAS}*R_{DOWN}<j>, POK is set to 1 (to end calibration mode), and I_{LOAD_INT} is set to 0, and the method 1400 ends. In this manner, the output of comparator 1407 transitioning from a low state to a high state can be used to signal when the V_{CAL}. voltage output of the resistor circuit 1411 and multiplexer 1405 is within an acceptable tolerance of the external pass element threshold voltage V_{EXT}. The tolerance may vary from one example to the next and depends on factors such as the resolution of comparator 1407. For instance, in some examples, the output of comparator 1407 may be used to signal when V_{CAL} is within 3% of V_{EXT}, or when V_{CAL} is in the range of V_{EXT} to 0.95*V_{EXT}. or when V_{CAL} is in the range of V_{EXT} to 0.98*V_{EXT}. The method may proceed from 1422 to 1436 and stop. With the V_{CAL} voltage source in place within load sharing circuitry (as shown in FIGS. 14D-E), the run mode may commence.

Referring back to FIG. 14C at 1412, if CALIB_DONE is high (logic 1), then EXT_STRONG remains set to low (logic 0). For the n-type configuration of FIG. 14A, this causes mux 1405 to provide the first output of resistor circuit 1411 (V_{INT}+V_{UP}) to the inverting input of comparator 1407; and for the p-type configuration of FIG. 14B, this causes mux 1405 to provide the second output of resistor circuit 1411 (V_{INT}-V_{UP}) to the non-inverting input of comparator 1407. The method continues at 1426 with determining if counter j has reached its maximum threshold N yet (which corresponds to the maximum resistance of the R_{UP} resistor bank of resistor circuit 1411). If threshold N has been reached, then an error flag is set (e.g., out of range=1) at 1434 and the method 1400 stops at 1436. If, on the other hand, threshold N has not been reached, then the counter j is incremented at 1428, which in turn causes the next incremental resistance value of the R_{UP} resistor bank of resistor circuit 1411 to be switched in. For the n-type configuration of FIG. 14A, this causes the value at the inverting input of comparator 1407 to incrementally increase (V_{CAL}=V_{INT}+V_{UP}<n: 0>); and for the p-type configuration of FIG. 14B, this causes the value at the non-inverting input of comparator 1407 to incrementally decrease (V_{CAL}=V_{INT}-V_{UP}<n: 0>).

The method 1400 then continues at 1430 with determining if CALIB_DONE has transitioned from high to low. Again, this can be done by way of controller 1415 receiving and interrogating the CALIB_DONE output of comparator 1407. If CALIB_DONE has not transitioned from high to low, then the method 1400 continues at 1426 with determining if counter j has reached its maximum threshold N yet. If so, then an error flag is set (e.g., out of range=1) at 1434 and the method 1400 stops at 1436. If, on the other hand, threshold N has not been reached, then the counter j is once again incremented at 1428, which in turn causes the next incremental resistance value of the R_{UP} resistor bank to switched in. For the n-type configuration of FIG. 14A, this causes the value at the inverting input of comparator 1407 to incrementally increase (V_{CAL}=V_{INT}+V_{UP}<n: 0>); and for the p-type configuration of FIG. 14B, this causes the value at the non-inverting input of comparator 1407 to incrementally decrease (V_{CAL}=V_{INT}-V_{UP}<n: 0>).

The method 1400 then continues at 1430 with once again determining if CALIB_DONE has transitioned from high to low. If not, the incrementing process of 1426, 1428, and 1430 repeats. If, on the other hand, it is determined at 1430 that CALIB_DONE has transitioned from high to low, then the method 1400 continues at 1432, where counter value j is saved as CODE (which can be used to set R_{CAL} of the V_{CAL} voltage source), V_{CAL} is set equal to-I_{BIAS}*R_{UP}<j>, POK is set to 1 (to end calibration mode), and I_{LOAD_INT} is set to 0, and the method 1400 ends. In this manner, the output of comparator 1407 transitioning from a high state to a low state can be used to signal when the V_{CAL} voltage output of the resistor circuit 1411 and multiplexer 1405 is within an acceptable tolerance of the external pass element threshold voltage V_{EXT}. As described above, the tolerance may vary from one example to the next and depends on factors such as the resolution of comparator 1407. For instance, in some examples, the output of comparator 1407 may be used to signal when V_{CAL} is within 3% of V_{EXT}, or when V_{CAL} is in the range of V_{EXT} to 1.05*V_{EXT}. or when V_{CAL} is in the range of V_{EXT} to 1.02*V_{EXT}. The method may proceed from 1432 to 1436 and stop. With the V_{CAL} voltage source connected in place within the load sharing circuitry, the run mode may commence as shown in FIGS. 14D-E.

FIGS. 14D-E each shows an example LDO voltage regulator in run mode with V_{CAL} voltage source installed, according to examples. Controller 1415 may configure voltage source V_{CAL} to provide the V_{CAL} voltage, using the final R_{CAL} value (R_{CAL} setting) and V_{CAL} calibration factors. Controller 1415 may also open switches S₂-S₅, and close switch S₁, to allow normal run mode to commence. As further shown, a system being powered (represented as I_{LOAD}) is connected to the V_{OUT} terminal, and the internal load I_{LOAD_INT} is no longer connected in circuit or otherwise disabled.

The example n-type configuration shown in FIG. 14D is similar to the example shown in FIG. 12A, except that R_{INT} is implemented with a p-type FET MP₁, and calibration circuitry of FIG. 14A is shown (but currently switched out by switches S₂-S₅, or otherwise disabled). In addition, the FET MP₁ is controlled by a comparator 1419, which in this example has its non-inverting input coupled to the node between the amplifier 101 output and resistor R_{LIM}, its inverting input receives threshold voltage V_{LIM_INT}, and its output coupled to the control terminal of FET MP₁ (so as to provide V_{PINT}). V_{LIM_INT} can be set, for instance, as previously described above. The above relevant description is equally applicable here. As further shown, the V_{CAL} voltage source is now switched in (for run mode) and coupled between the error amplifier 101 output and the control terminal of external pass element 107n, and includes a current source I_{BIAS} and a variable resistor circuit set to the REAL value determined during calibration mode. Recall from above that current source I_{BIAS} may be the same current source I_{BIAS} used during calibration when determining R_{CAL}, or another current source that has the same I_{BIAS} value. In operation, sourcing I_{BIAS} current through resistor R_{CAL} generates the V_{CAL} voltage. For the case where external pass element 107n is stronger than internal pass element 105n, the positive terminal of the V_{CAL} voltage source can be connected to the output of amplifier 101 and the negative terminal of the V_{CAL} voltage source can be connected to the control terminal of external pass element 107n. In this way, the strength of external pass element 107n can be neutralized or otherwise reduced, to facilitate load sharing. For the case where external pass element 107n is weaker than internal pass element 105n, the negative terminal of the V_{CAL} voltage source can be connected to the output of amplifier 101 and the positive terminal of the V_{CAL}, voltage source can be connected to the control terminal of external pass element 107n. In this way, the weakness of external pass element 107n can be neutralized or otherwise reduced, to facilitate load sharing.

The example p-type configuration shown in FIG. 14E is similar to the example shown in FIG. 12B, except that R_{INT} is implemented with an n-type FET MN₁, and calibration circuitry of FIG. 14B is shown (but currently switched out by switches S₂-S₅, or otherwise disabled). In addition, the FET MN₁ is controlled by a comparator 1420, which in this example has its inverting input coupled to the node between the amplifier 101 output and resistor R_{LIM}, its non-inverting input receives threshold voltage V_{LIM_INT}, and its output coupled to the control terminal of FET MN₁ (so as to provide V_{NINT}). V_{LIM_INT} can be set, for instance, as previously described above. The above relevant description is equally applicable here. As further shown, the V_{CAL} voltage source is now switched in (for run mode) and coupled between the error amplifier 101 output and the control terminal of external pass element 107p, and includes a current source I_{BIAS} and a variable resistor circuit set to the REAL value determined during calibration mode. Recall from above that current source I_{BIAS} may be the same current source I_{BIAS} used during calibration when determining R_{CAL}, or another current source that has the same I_{BIAS} value. In operation, sourcing I_{BIAS} current through resistor R_{CAL} generates the V_{CAL} voltage. For the case where external pass element 107p is stronger than internal pass element 105p, the negative terminal of the V_{CAL} voltage source can be connected to the output of amplifier 101 and the positive terminal of the V_{CAL} voltage source can be connected to the control terminal of external pass element 107p. In this way, the strength of external pass element 107p can be neutralized or otherwise reduced, to facilitate load sharing. For the case where external pass element 107p is weaker than internal pass element 105p, the positive terminal of the V_{CAL} voltage source can be connected to the output of amplifier 101 and the negative terminal of the V_{CAL}, voltage source can be connected to the control terminal of external pass element 107p. In this way, the weakness of external pass element 107p can be neutralized or otherwise reduced, to facilitate load sharing.

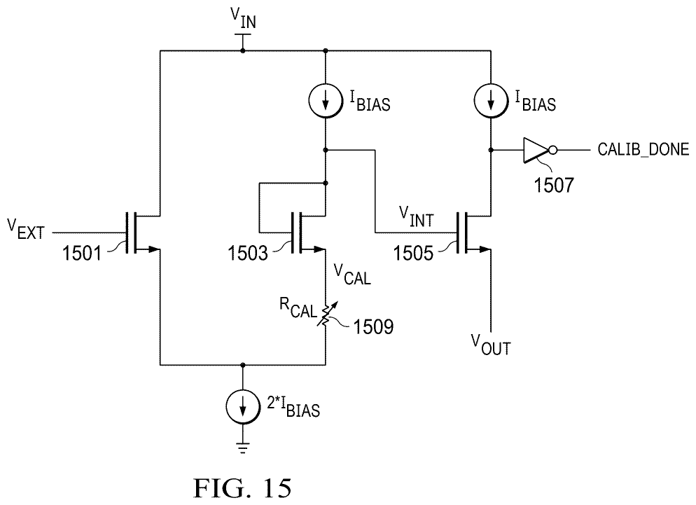

FIG. 15 is a schematic diagram of calibration circuitry configured to determine the value of the calibrated voltage source, in another example. This example circuit can be used in place of calibration circuits 1417n and 1417p to determine V_{CAL}, in cases where the external pass element 107 (either n-type or p-type) is presumed to be stronger than the internal pass element (V_{TH} 107≤ V_{TH_105}). A switching scheme can be used to engage the calibration circuitry for calibration mode, and to disengage the calibration circuitry for run mode, such as by including switches at suitable locations to switch the calibration circuit in (for calibration mode) or out (for run mode). The above relevant discussion is equally applicable here.

As shown, the calibration circuit of FIG. 15 includes a matched pair of NMOS FETs 1501 and 1503, a current source I_{BIAS}, a scaled down replica pass element 1505 (with pass element 105 being N times larger, and the above previously relevant description with respect to sizing based on W/L ratios being equally applicable here), a comparator 1507, and adjustable a resistor circuit 1509. Each of FETs 1501 and 1503 is coupled between the V_{IN} and ground terminals, with their respective drains coupled to the V_{IN} terminal, and their respective sources coupled to the ground terminal. The gate of FET 1501 receives V_{EXT}, which in this configuration is the also the threshold voltage of the external pass element 107n (V_{TH_107}). The gate of FET 1503 is coupled to the drain of FET 1503. As further shown, each of FETs 1501, 1503 and 1505 is carrying I_{BIAS} current, and adjustable resistor circuit 1509 is coupled between the drain of FET 1503 and the ground terminal. The replica FET is coupled between the V_{IN} and V_{OUT} terminals, and has its gate coupled to the drain of FET 1503. The circuit can be operated in a similar fashion to the calibration circuit 1417n and 1417p of FIGS. 14A-B, respectively. For instance, the calibration circuit can be engaged at start-up of voltage controller, and initialized so that the REAL value of resistor circuit 1509 is zero ohms. In such a configuration, the initial CALIB_DONE signal generated at the output of comparator 1507 is low. The resistance value R_{CAL} of resistor circuit 1509 can then be incrementally adjusted upward (e.g., under direction of controller 1415 or other processor), and when CALIB_DONE transitions from low to high, then the REAL value at that time can be used for the variable resistance of the voltage source V_{CAL}. In more detail, CALIB_DONE goes high when: V_{EXT}-V_{TH} 1501+I_{BIAS} (R_{CAL})+V_{TH} 1503>V_{OUT}+V_{TH_1503}. This can be simplified to: V_{EXT}=V_{OUT}+V_{GS_107}, wherein CALIB_DONE goes high when V_{GS} 107+I_{BIAS} (R_{CAL})>V_{TH_105}.

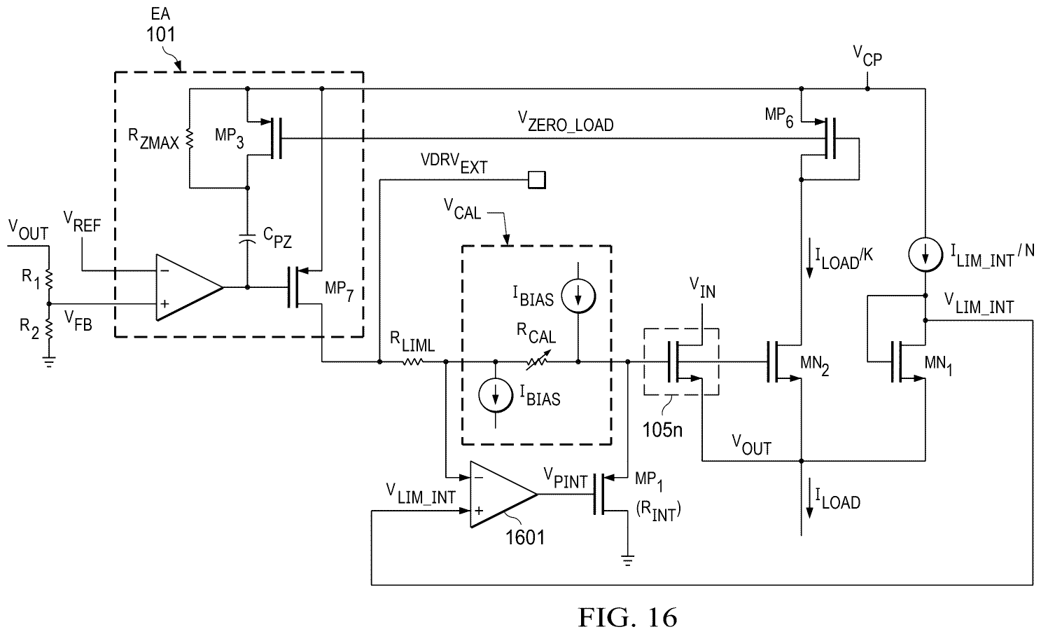

FIG. 16 is a schematic diagram of an LDO voltage regulator configured for load sharing using a calibrated voltage source, in another example. This example is similar to the example described with reference to FIG. 14D, except that load sensing and tracking circuitry is shown in FIG. 16, in an example. Also, the external pass element is not yet connected, but would be coupled between the V_{IN} and V_{OUT} terminals as shown in other figures, and with its control terminal coupled to the VDRV_{EXT} terminal as shown in FIG. 16. Also, the FET MP₁ is controlled by a comparator 1601, which in this example has its inverting input coupled to the node between resistor R_{LIM} and voltage source V_{CAL}, its non-inverting input coupled to the gate and drain of MN₁ so that it receives threshold voltage V_{LIM_INT}, and its output coupled to the control terminal of FET MP₁ (so as to provide V_{PINT}). As further shown, V_{LIM_INT} is set by driving the maximum current I_{LIM_INT} into replica FET MN₁, and replica FET MN₂ is used for load sensing, as described above. In this example, replica FET MN₁ is N times smaller than internal pass element 105n, and replica FET MN₂ is K times smaller than internal pass element 105n (e.g., based on W/L ratios as described above). In operation, VDRV_{INT} increases with I_{LOAD} until I_{LIM_INT} is reached, which in turn causes FET MN₂ to track I_{LOAD} until I_{LIM_INT} is reached, which means resistances provided by MP₆ and MN₃ also track I_{LOAD} until I_{LIM_INT} is reached, thereby enabling load tracking zero using MP₃ for pole zero compensation and enabling internal compensation for the LDO voltage regulator. In more detail, and as further described above with reference to FIG. 6, when I_{LOAD} increases, V_{ZERO_LOAD} at the drains of FETs MP₆ and MN₂ decreases which in turn decreases the resistance of FET MP₃ (or otherwise pushes MP₃ towards its low impedance or on state) and allows C_{PZ} to provide compensation for higher load currents. In contrast, when I_{LOAD} decreases, V_{ZERO_LOAD} increases which in turn increases the resistance of MP₃ (or otherwise pushes MP₃ towards its high impedance or off state), which effectively opens the compensation path so that C_{pz}. doesn't compete with C_{EXT} and cause instability at lower load currents. In this example of FIG. 16, RZMAX of error amplifier 101 may be used to provide additional biasing for compensation path. The above relevant description is equally applicable here.

As shown in this example, load sharing is accomplished using an impedance divider (R_{LIM} and MP₁) that has its output coupled to the control terminal of internal pass element 105n, as well as a voltage source V_{CAL} coupled between the error amplifier 101 output the control terminal of internal pass element 105n. Such a configuration allows for increasing the voltage at the control terminal of internal pass element 105n, rather than decreasing the voltage at the control terminal of external pass element 107n. A variation of this circuit is the same circuit, except without the voltage source V_{CAL} coupled between R_{LIM} and the control terminal of pass element 105n, and instead with a constraint that internal pass element 105n be stronger than external pass element 107n, as further explained below with reference to the examples of FIGS. 17A-C and 18A-C.

Load Sharing with Constrained External Pass Element

FIG. 17A is a schematic diagram of an LDO voltage regulator configured for load sharing using an external n-type pass element that is constrained with respect to an internal n-type pass element, in an example. This example is similar to the example of FIG. 12A, except that there is no voltage source V_{CAL} at either of the control terminals for the internal and external pass elements 105n and 107n. Instead, the output of the impedance divider (RLM and R_{INT}) is coupled to the control terminal of internal pass element 105n, and the control terminal of pass element 107n is coupled directly to the error amplifier 101 output. As further shown in the dashed pull-out circle FIG. 17A, NMOS FETs 105n and 107n can be implemented with other transistor technologies, such as NPN BJTs, or a combination of different transistor technologies (e.g., BJT and FET) as previously described above. Also, in this example, external pass element 107n is constrained to be weaker than internal pass element 105n. So, for example, if pass elements 105n and 107n are NMOS FETs, then V_{TH} (GS)_107n is constrained to be greater V_{TH} (GS)_105n; or if pass elements 105n and 107n are NPN BJTs, then V_{TH(BE)107n} is constrained to be greater V_{TH(BE)105n}; or if pass element 105n is an NMOS FET and pass element 107n is an NPN BJT, then V_{TH (BE)107n} is constrained to be greater V_{TH} (GS)_105n. More generally, the turn-on voltage of pass element 107n is constrained to be greater than the turn-on voltage of pass element 105n.

Given that the threshold voltage of pass element 107n (V_{TH}_107n) is greater than the threshold voltage of pass element 105n (V_{TH}_105n), an example operation is as follows. As load current increases, the gate-to-source overdrive (V_{GS}) from the amplifier 101 increases. The I_{LIM_INT} for pass element 105n is implemented by bounding the overdrive (e.g., |V_{GS}|) of pass element 105n using the variable-impedance voltage divider (R_{LIM} and R_{INT}) on the common gate driver output. Example equations include:

$${I}_{I N T} ∝ {V DR V}_{I N T} ; \qquad ( Equation 6 )$$

$${V DR V}_{I N T} = {V DR V}_{EXT} * RINT / ( RINT + RLIM ) , or \qquad ( Equation 7 )$$

$${V DR V}_{I N T} = 1 / [ 1 + {R}_{LI M} / {R}_{I NT} ] * {V DR V}_{EXT} ;$$

$${V DR V}_{EXT} ∝ sqrt ( {I}_{LOAD} ) ; \qquad ( Equation 8 )$$

$${V DR V}_{I N T} ∝ sqrt ( {I}_{L O A D} ) * {R}_{I N T} ; and \qquad ( Equation 9 )$$

$$If {R}_{I N T} ∝ 1 / sqrt ( {I}_{L O A D} ) after {I}_{L O A D} > {I}_{LIM\_INT} , then$$

$${V DR V}_{I N T} independent of {I}_{L O A D} after {I}_{LOAD} > {I}_{LIM\_INT} ; \qquad ( Equation 10 )$$

wherein ∝ refers to proportionality, and sqrt refers to square root, and each of the reference parameter is as previously defined above.

FIG. 17B is a schematic diagram of an LDO voltage regulator configured for load sharing using an external n-type pass element that is constrained with respect to an internal n-type pass element, in another example. This example is similar to the example of FIG. 17A, except that R_{INT} is implemented with PMOS FET MP₁. As further shown in FIG. 17B, FET MP₁ is controlled by comparator 1701, which in this example has its inverting input coupled to the node between resistor R_{LIM} and the control terminal of pass element 105n, its non-inverting input coupled to the gate and drain of FET MN₁ so that it receives threshold voltage V_{LM_INT}, and its output coupled to the control terminal of FET MP₁ (so as to provide V_{PINT}). FET MN₁ is coupled between the V_{OUT} terminal and the V_{CP} terminal (or the V_{IN} terminal in other examples not needing a higher charge pump voltage), and has its gate coupled to its drain, and its source coupled to the V_{OUT} terminal. FET MN₁ is a scaled down replica of internal pass element 105n, wherein internal pass element 105n is N times larger, N being an integer of 2 or more, and the above previously relevant description with respect to sizing based on W/L ratios being equally applicable here. As further shown, V_{LIM_INT} is set by driving the maximum current I_{LIM_INT} into replica FET MN₁. As further shown in the dashed pull-out circle of FIG. 17B, NMOS FETs 105n, 107n, and MN₁ can be implemented with other transistor technologies, such as NPN BJTs, or a combination of different transistor technologies (e.g., BJT and FET) as previously described above. Also, in this example, the external pass element 107n is constrained to be weaker than internal pass element 105n. So, for example, if pass elements 105n and 107n are NMOS FETs, then V_{TH(GS)_107n} is constrained to be greater V_{TH} (GS) 105n; or if pass elements 105n and 107n are NPN BJTs, then V_{TH(BE)107n} is constrained to be greater V_{TH(BE)105n}; or if pass element 105n is an NMOS FET and pass element 107n is an NPN BJT, then V_{TH (BE)107n} is constrained to be greater V_{TH} (GS) 105n. More generally, the turn-on voltage of pass element 107n is constrained to be greater than the turn-on voltage of pass element 105n.

Given that the threshold voltage of pass element 107n (V_{TH_107n}) is greater than the threshold voltage of pass element 105n (V_{TH_105n}), an example operation is as follows. If VDRV_{EXT} is less than V_{IIM INT}, then FET MP₁ is off (e.g., R_{INT} is an OPEN), the current through MP₁ (R_{INT}) is zero, and VDRV_{INT} equals VDRV_{EXT} (amplifier 101 output). For I_{LOAD}<I_{LIM_INT}, as I_{LOAD} increases, VDRV_{INT} increases enabling load tracking between VDRV_{INT} and V_{OUT}. As VDRV_{INT} goes greater than V_{LIM_INT}, the output of comparator 1701 (V_{PINT}) goes low and FET MP₁ starts to take current causing a drop across R_{LIM} restoring VDRV_{INT} to V_{LM_INT}. This allows higher I_{LOAD} to be fulfilled by pass element 107n. Example equations include:

$${V DR V}_{EXT} = sqr t [ ( {I}_{L O A D} - {I}_{LIM\_INT} ) / β EXT ] + {V}_{OUT} + {V}_{TH \_ 107 n} ; \qquad ( Equation 11 )$$

$${I}_{RLIM} = ( {V DR V}_{EXT} - {V}_{LIM\_INT} ) / {R}_{LI M} ; \qquad ( Equation 12 )$$

$${I}_{R L I M} ∝ s q r t [ {I}_{L O A D} / {β}_{E X T} ] / {R}_{L I M} ; ( saturation ) \qquad ( Equation 13 )$$

$${R}_{I N T} \geq {V DR V}_{I N T} / {I}_{RLIM} \geq {V}_{LIM\_INT} / {I}_{RLIM} ; and \qquad ( Equation 14 )$$

$${R}_{I N T} ∝ 1 / sqrt [ {I}_{L O A D} ] ; \qquad ( Equation 15 )$$

wherein I_{RLI} is the current through R_{LIM}, B_{EXT} is the technology parameter of pass element 107n, ∝ refers to proportionality, and sqrt refers to square root.

FIG. 17C is a schematic diagram of an LDO voltage regulator configured for load sharing using an external n-type pass element that is constrained with respect to an internal n-type pass element, in another example. This example is similar to the example of FIG. 17B, except that FET MP₁ is controlled directly by the V_{LIM_INT} voltage. As further shown in FIG. 17C, a bias circuit including FET MP_{BIAS} and current source I_{BIAS} is provided to help set V_{PINT}. In more detail, PMOS FET MP_{BIAS} can be a replica of PMOS FET MP₁ and is coupled in series with current source I_{BIAS} between the V_{OUT} and ground terminals, and has its source terminal coupled to the V_{OUT} terminal, and its gate and drain terminals coupled to the source terminal of MN₁. Also, current bias I_{BIAS} is coupled between the gate and drain of FET MP_{BIAS} and the ground terminal. In this example, the V_{PINT} signal that controls the variable impedance of MP₁ is created by compensating for (subtracting) a diode drop that is added by FET MP₁. In more detail, FET MP₁ will turn on when VDRV_{INT} is greater than (V_{LIM_INT}+VSG_MP₁-VSG_MP_{BIAS}), where VSG_MP₁ is the source-to-gate voltage of MP₁, and VSG_MP_{BIAS} is the source-to-gate voltage of MP_{BIAS}. In this manner, replica FET MP_{BIAS} provides one PMOS down (VSG) to compensate for the one PMOS up provided by MP₁. As further shown in the dashed pull-out circle of FIG. 17C, NMOS FETs 105n, 107n, and MN₁ can be implemented with other transistor technologies, such as NPN BJTs, or a combination of different transistor technologies (e.g., BJT and FET) as previously described above.

FIG. 18A is a schematic diagram of an LDO voltage regulator configured for load sharing using an external p-type pass element that is constrained with respect to an internal p-type pass element, in an example. This example is similar to the example of FIG. 12B, except there is no voltage source V_{CAL} at either of the control terminals for the internal and external pass elements 105p and 107p. As shown, the output of the impedance divider (R_{LIM} and R_{INT}) is coupled to the control terminal of internal pass element 105p, and the control terminal of pass element 107p is coupled directly to the error amplifier 101 output. Also, in this example, the external pass element 107p is constrained to be weaker than internal pass element 105p. So, for example, if pass elements 105p and 107p are PMOS FETs, then V_{TH(GS)107p} is constrained to be greater V_{TH(GS)105p}; or if pass elements 105p and 107p are PNP BJTs, then V_{TH(BE)_107p} is constrained to be greater V_{TH(BE)105p}; or if pass element 105n is a PMOS FET and pass element 107p is a PNP BJT, then V_{TH(BE)107p} is constrained to be greater V_{TH(GS)105p}. More generally, the turn-on voltage of pass element 107p is constrained to be greater than the turn-on voltage of pass element 105p. As further shown in the dashed pull-out circle of FIG. 18A, PMOS FETs 105p and 107p can be implemented with other transistor technologies, such as PNP BJTs, or a combination of different transistor technologies (e.g., BJT and FET) as previously described above.

Given that the threshold voltage of pass element 107p (V_{TH_107p}) is greater than the threshold voltage of pass element 105p (V_{TH_105p}), an example operation is as follows. As load current increases, the gate to source overdrive (V_{GS}) from the amplifier 101 increases. The I_{LIM_INT} for pass element 105p is implemented by bounding the overdrive (e.g., |V_{GS}|) of pass element 105p using the variable-impedance voltage divider (R_{LIM} and R_{INT}) on the common gate driver output. Example equations include Equations 6 through 10 above.

FIG. 18B is a schematic diagram of an LDO voltage regulator configured for load sharing using an external p-type pass element that is constrained with respect to an internal p-type pass element, in another example. This example is similar to the example of FIG. 18A, except that R_{INT} is implemented with NMOS FET MN₁. As further shown in FIG. 18B, FET MN₁ is controlled by comparator 1801, which in this example has its inverting input coupled to the node between resistor R_{LIM} and the control terminal of pass element 105p, its non-inverting input coupled to the gate and drain of MP₁ so that it receives threshold voltage V_{LIM_INT}, and its output coupled to the control terminal of FET MN₁ (so as to provide V_{NINT}). As further shown, V_{LIM_INT} is set by driving the maximum current I_{LIM_INT} through replica FET MP₁, as described above. Also, in this example, the external pass element 107p is constrained to be weaker than internal pass element 105n. So, for example, if pass elements 105p and 107p are PMOS FETs, then V_{TH(GS)107p} is constrained to be greater V_{TH(GS)105p}; or if pass elements 105p and 107p are PNP BJTs, then V_{TH(BE)_107p} is constrained to be greater V_{TH(BE)105p}; or if pass element 105n is a PMOS FET and pass element 107p is a PNP BJT, then V_{TH(BE)_107p} is constrained to be greater V_{TH(GS)105p}. More generally, the turn-on voltage of pass element 107p is constrained to be greater than the turn-on voltage of pass element 105p. As further shown in the dashed pull-out circle of FIG. 18B, PMOS FETs 105p, 107p, and MP₁ can be implemented with other transistor technologies, such as PNP BJTs, or a combination of different transistor technologies (e.g., BJT and FET) as previously described above.

Given that the threshold voltage of pass element 107p (V_{TH_107p}) is greater than the threshold voltage of pass element 105p (V_{TH_105p}), an example operation is as follows. If VDRV_{EXT} is less than V_{LIM_INT}, then FET MN₁ is off (e.g., R_{INT} is an OPEN), the current through MN₁ (R_{INT}) is zero, and VDRV_{INT} equals VDRV_{EXT} (amplifier 101 output). For I_{LOAD}<I_{LIM_INT}, as I_{LOAD} increases, VDRV_{INT} increases enabling load tracking between VDRV_{INT} and V_{OUT}. As VDRV_{INT} goes greater than V_{LIM_INT}, the output of comparator 1801 (V_{NINT}) goes low and FET MN₁ starts to take current causing a drop across RLI restoring VDRV_{INT} to V_{LIM_INT}. This allows higher I_{LOAD} to be fulfilled by pass element 107p. Example equations include Equations 11 through 15 above.

FIG. 18C is a schematic diagram of an LDO voltage regulator configured for load sharing using an external p-type pass element that is constrained with respect to an internal p-type pass element, in another example. This example is similar to the example of FIG. 18B, except that FET MN₁ is controlled directly by the V_{LIM_INT} voltage. As further shown in FIG. 18C, a bias circuit including FET MN_{BIAS} and current source I_{BIAS} is provided to help set V_{NINT}. In more detail, NMOS FET MN_{BIAS} can be a replica of NMOS FET MN₁ and is coupled in series with current source I_{BIAS} between a secondary supply voltage (V_{SUP}) terminal and the V_{LIM_INT} node (source and drain of MP₁), and has its source terminal coupled to the source and drain of MP₁, and its gate and drain terminals coupled to the control terminal of MN₁. V_{SUP} can be any suitable power supply, such as a boost converter. Also, current bias I_{BIAS} is coupled between the gate and drain of FET MN_{BIAS} and the V_{SUP} terminal. In this example, the V_{NINT} signal that controls the variable impedance of MN₁ is created by compensating for (adding) a diode drop that is subtracted by FET MN₁. In more detail, FET MN₁ will turn on when VDRV_{INT} is less than (V_{LIM_INT}-VSG_MN₁+VSG_MN_{BIAS}), where VSG_MN₁ is the source-to-gate voltage of MN₁, and VSG_MN_{BIAS} is the source-to-gate voltage of MN_{BIAS}. In this manner, replica FET MN_{BIAS} provides one NMOS up (VSG) to compensate for the one NMOS down provided by MN₁. As further shown in the dashed pull-out circle of FIG. 18C, PNP BJTs 105p, 107p, and MP₁ can be implemented with other transistor technologies, such as PMOS FETs, or a combination of different transistor technologies (e.g., BJT and FET) as previously described above.

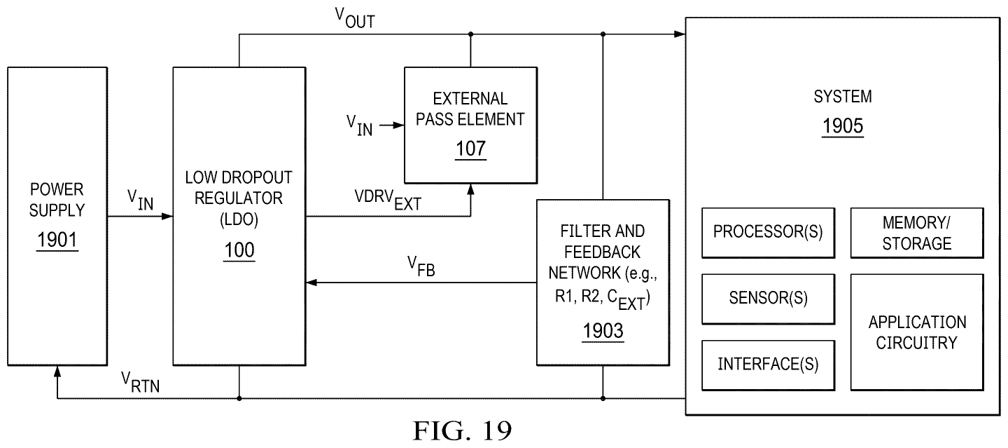

FIG. 19 is a block diagram of an electronic system that includes an LDO voltage regulator configured for load sharing, in an example. As shown, the system includes a power supply 1901, an LDO voltage regulator 100, an external pass element 107, a filter and feedback network 1903, and an application-based system 1905 that includes one or more sub-components to be powered. Other example systems may be configured differently, based on the application at hand. More generally LDO voltage regulator 100 may be used in the context of any electronic system that calls for one or more regulated power supplies.

The power supply 1901 is configured to provide the input voltage V_{IN} and may be, for instance, a battery or battery pack (e.g., automotive battery), or an unregulated power supply. LDO voltage regulator 100 may be any of the LDO voltage regulators described herein (including 100, 100n, 100p, 100nc, and 100pc, or a combination of these) or any variant thereof. The filter and feedback network 1903 may include, for instance, a resistor network including R₁ and R₂, and an output capacitor C_{EXT}, such as shown in FIG. 1. External pass element 107 is coupled between the V_{IN} and V_{OUT} terminals, and has its control terminal coupled to the output signal terminal of LDO voltage regulator 100, similar to the example circuit 10 shown in FIG. 1. The previous relevant description is equally applicable here.

LDO voltage regulator 100 and external pass element 107 may be either n-type or p-type, and may be implemented with any number of transistor technologies as variously described herein. LDO voltage regulator 100 is configured to provide load sharing with a single driver (e.g., error amplifier 101) for an internal element within regulator 100 and external pass element 107. In some such examples, first and second voltage dividers (such as shown in FIGS. 3 through 10) are used, each divider having a similar variable impedance that is arranged in complementary fashion relative to the other divider's variable impedance. The coupling of the dividers within the voltage regulator circuit, and the location of the variable impedance within a given divider, depends on the type of voltage regulator. For instance: for an n-type LDO voltage regulator (e.g., FIGS. 3-6), the first and second voltage dividers are each coupled between the error amplifier output and a ground terminal, with the first voltage divider having its output coupled to the control terminal of the internal pass element and a variable impedance in the bottom position of that divider; and the second voltage divider having its output coupled to the control terminal of the external pass element and a variable impedance in the top position of that divider. For a p-type voltage regulator (e.g., FIGS. 7-10), the first and second voltage dividers are each coupled between the error amplifier output and the input voltage terminal, with the first voltage divider having its output coupled to the control terminal of the internal pass element and a variable impedance in the top position of that divider, and the second voltage divider having its output coupled to the control terminal of the external pass element and a variable impedance in the bottom position of that divider.

In other examples, LDO voltage regulator 100 may be configured with only one variable voltage divider, along with a selectively applied calibrated voltage source, to automatically adjust the load sharing based on load current (e.g., as shown in FIGS. 12A-B, 14D-E, and 16). Calibration circuitry and methodologies for determining the value of the calibrated voltage source (e.g., as shown in FIGS. 13A-B, 14A-C, and 15) may be on-chip or otherwise internal to regulator 100, and may be operated (calibration mode), for example, at start-up of the voltage regulator. As described above, the calibration circuitry can be configured to detect the difference between the threshold or overdrive voltages of external and internal pass elements, and that voltage difference can then be used as the calibrated voltage source. Once determined, the voltage source can then be applied to the control terminal of the internal pass element or external pass element 107, so as to compensate for the strength difference in the two pass elements and facilitate load sharing during regular operation (run mode) of voltage regulator 100. That calibrated voltage source may also be used to enable load dependent pole zero compensation with an external pass element.

In still other examples, LDO voltage regulator 100 may be configured with only one variable voltage divider (e.g., to auto adjust the load sharing based on load current), wherein external pass element 107 can be constrained to be weaker than the internal pass element of regulator 100, to facilitate the load sharing (e.g., as shown in FIGS. 17A-18C).

LDO voltage regulator 100 may be configured for load tracking pole zero compensation with external pass element 107. In more detail, linear voltage regulators use type two stability compensation, where two poles and one zero with respect to the unity gain bandwidth are used to make the control loop stable. The zero is kept outside the unity gain bandwidth to boost phase with little to no impact on gain roll off. As the load current increases, the output pole moves out and the unity gain bandwidth increases. This can cause a constant frequency zero to come within the unity gain bandwidth. An LDO voltage regulator with an internal pass element can use a load tracking zero, where a replica FET (or other replica pass element) is used to mirror/track the load current so that at low loads the zero is kept at a lower frequency which keeps on moving out as the load current increases. But an LDO voltage regulator with an external pass element is unable to use a load tracking zero solution, because the pass element transfer characteristics are not known (e.g., there is no replica device for a customer-provided external pass element), and hence load current cannot be tracked by the voltage regulator. The output pole must therefore be kept outside the unity gain bandwidth (which can increase quiescent current), or external compensation component(s) must be used (which can limit bandwidth). Thus, and according to some examples described herein, voltage regulator 100 is configured for load sharing as depicted in FIGS. 1 and 2A-D. In some such cases, for instance, the internal pass element of regulator 100 carries the load current I_{LOAD} until I_{LOAD}>I_{STB}, where I_{STB} is the minimum load current where the output pole moves to greater than 10× unity gain bandwidth and the internal pole takes over. This enables load tracking zero until I_{LOAD}=I_{STB}. even when external pass element 107 is connected. After I_{LOAD} exceeds the I_{STB} threshold, external pass element 107 starts to share the load current with the internal pass element, until the current through the internal pass element (I_{INT}) reaches I_{LIM_INT}, where I_{LIM_INT} is the maximum load current that the internal pass element can carry reliably. After I_{LOAD} exceeds I_{LIM_INT}, the current through the external pass element (TEXT) is equal to about I_{LOAD}-I_{LIM_INT}.

As further shown in FIG. 19, application-based system 1905 is coupled between the V_{OUT} and V_{RTN} (e.g., ground) terminals. The configuration of application-based system 1905 will vary from one example to the next, but in this example includes one or more processors, one or more sensors, one or more interfaces, memory and storage, and application circuitry. In some examples, the electronic system is part of an automotive electronic system, such as a camera system or other sensing system (e.g., blind spot checking system). In other examples, the electronic system is part of a control system, such as a radar electronic control unit configured with radar and video interfaces (e.g., for air traffic control). In still other examples, the electronic system is part of a medical system, such as an electrocardiogram system including a non-isolated DC-DC power supply (e.g., for air traffic control).

### Further Example Embodiments

The following examples pertain to further embodiments, from which numerous permutations and configurations will be apparent.

Example 1 is a circuit, comprising: an input voltage terminal; an output voltage terminal; a feedback voltage terminal; an output signal terminal; a pass element coupled between the input voltage terminal and the output voltage terminal, and having a control terminal; an error amplifier having a first amplifier input, a second amplifier input, and an amplifier output, wherein the first amplifier input is coupled to a reference voltage terminal, and the second amplifier input is coupled to the feedback voltage terminal; and a load sharing circuit having an input, a first output, and a second output, wherein the input of the load sharing circuit is coupled to the amplifier output, the first output of the load sharing circuit is coupled to the control terminal of the pass element, and the second output of the load sharing circuit is coupled to the output signal terminal. In some such examples, the pass element is an n-type pass element.

Example 2 includes the circuit of Example 1, wherein: the load sharing circuit is configured to generate first and second drive voltages at the first and second outputs of the load sharing circuit, respectively, based on a drive voltage generated by the error amplifier; each of the first and second drive voltages is associated with a rate of change relative to changes in the drive voltage generated by the error amplifier; and the rate of change of the first drive voltage decreases as the rate of change of the second drive voltage increases.

Example 3 includes the circuit of Example 1 or 2, wherein: the load sharing circuit is configured to generate first and second drive voltages at the first and second outputs of the load sharing circuit, respectively, based on a drive voltage generated by the error amplifier; a first gain between the amplifier output and the first output of the load sharing circuit decreases relative to increases in the drive voltage generated by the error amplifier; and a second gain between the amplifier output and the second output of the load sharing circuit increases relative to increases in the drive voltage generated by the error amplifier.

Example 4 includes the circuit of any one of Examples 1 through 3, wherein: the load sharing circuit is configured to generate first and second drive voltages at the first and second outputs of the load sharing circuit, respectively, based on a drive voltage generated by the error amplifier; responsive to the first drive voltage at the first output of the load sharing circuit exceeding a first threshold voltage, the load sharing circuit is configured to decrease a rate of change of the first drive voltage relative to changes in the drive voltage generated by the error amplifier; and responsive to the first drive voltage at the first output of the load sharing circuit exceeding a second threshold voltage, the load sharing circuit is configured to increase a rate of change of the second drive voltage relative to changes in the drive voltage generated by the error amplifier.

Example 5 includes the circuit of any one of Examples 1 through 4, wherein: the circuit is configured to provide a load current to the output voltage terminal; responsive to the load current being less than or equal to a first current threshold, the load sharing circuit is configured to provide substantially all of the load current via the pass element; and responsive to the load current being greater than a second current threshold, the load sharing circuit is configured to limit current provided via the pass element, the second current threshold being greater than the first current threshold.

Example 6 includes the circuit of Example 5, wherein: responsive to the load current being greater than the first current threshold, the load sharing circuit is configured to provide a first portion of the load current via the pass element, and to control an external pass element to provide a second portion of the load current.

Example 7 includes the circuit of Example 6, and further includes the external pass element, wherein the external pass element is coupled between the input voltage terminal and the output voltage terminal, and has a control terminal connected to the output signal terminal, such that the second portion of the load current is provided by the external pass element. In some such cases, the external pass element is an n-type pass element. In some such examples, for instance, the elements of Example 1 are on or otherwise part of an integrated circuit die within an integrated circuit package (e.g., ceramic flat pack with leads, ball grid array, etc.), and the external pass element is external to that integrated circuit package. In other examples, the elements of Example 1 are on or otherwise part of a printed circuit board (e.g., single-sided, double-sided, multilayer, flexible, etc.), and the external pass element is external to that printed circuit board. Still other examples may be configured differently. To this end, the level of integration may vary from one example to the next.

Example 8 includes the circuit of Example 7, wherein: each of the pass element and the external pass element is an n-channel field effect transistor or an NPN bipolar junction transistor; or one of the pass element and the external pass element is an n-channel field effect transistor and the other of the pass element and the external pass element is an NPN bipolar junction transistor.

Example 9 includes the circuit of any one of Examples 1 through 8, wherein the load sharing circuit comprises: a first impedance divider coupled between the amplifier output and a ground terminal, the first impedance divider including an output coupled to the first output of the load sharing circuit; and a second impedance divider coupled between the amplifier output and the ground terminal, the second impedance divider including an output coupled to the output signal terminal.

Example 10 includes the circuit of Example 9, wherein: the first impedance divider includes a first variable impedance coupled between the output of the first impedance divider and the ground terminal; and the second impedance divider includes a second variable impedance coupled between the amplifier output and the output of the second impedance divider.

Example 11 includes the circuit of Example 10, wherein the first variable impedance includes a first field effect transistor (FET), and the second variable impedance includes a second FET. In some such examples, the load sharing circuit comprises: a resistor coupled between the amplifier output and a source terminal of the first FET, the resistor and the first FET providing the first impedance divider; and a pull-down circuit coupled between the output signal terminal and the ground terminal, the pull-down circuit and the second FET providing the second impedance divider. In some such examples, the resistor is a first resistor, and the pull-down circuit comprises a second resistor and/or a current source.

Example 12 includes the circuit of Example 11, wherein the resistor is a first resistor, and the load sharing circuit comprises one or more of the following: a third FET coupled between the output voltage terminal and one of the input voltage terminal or a charge pump terminal, the third FET having a gate terminal coupled to a drain terminal, and a source terminal coupled to the output voltage terminal; a fourth FET having a gate terminal coupled to a drain terminal and the gate terminal of the first FET, and a source terminal coupled to the gate and drain terminals of the third FET; a first current source coupled between the drain terminal of the fourth FET and the ground terminal; a fifth FET coupled between the ground terminal and the one of the input voltage terminal or the charge pump terminal, the fifth FET having a gate terminal coupled to a drain terminal via a second resistor, and a source terminal coupled to the one of the input voltage terminal or the charge pump terminal, wherein the drain terminal of the fifth FET is coupled to the gate terminal of the second FET; and/or a second current source coupled between the gate terminal of the fifth FET and the ground terminal. In some such examples: the pass element is the same type as the third FET, but N times larger, N being an integer of 2 or more; the first FET and the fourth FET are the same type; and the second FET and the fifth FET are the same type.

Example 13 includes the circuit of Example 12, and further includes: a buffer circuit having a buffer input and a buffer output, the buffer input coupled to a second output stage of the error amplifier; a sixth FET having a gate terminal coupled to the control terminal of the pass element and a source terminal coupled to the output voltage terminal; a seventh FET coupled between the buffer output and the sixth FET, and having a gate terminal coupled to a drain terminal and the drain terminal of the sixth FET, and a source terminal coupled to the buffer output; an eighth FET having a gate terminal coupled to the gate and drain terminals of the seventh FET, and a source terminal coupled to the second output stage of the error amplifier; and a capacitor coupled between a drain terminal of the eighth FET and a first output stage of the error amplifier.

Example 14 includes the circuit of Example 10 or 11, wherein the load sharing circuit comprises: a first comparator circuit configured to control the first variable impedance; and a second comparator circuit configured to control the second variable impedance. In some such examples: the first comparator circuit has a first comparator input coupled to the first output of the load sharing circuit, and a first comparator output coupled to the gate terminal of the first FET; and the second comparator circuit has a second comparator input coupled to the first output of the load sharing circuit, and a second comparator output coupled to the gate terminal of the second FET.

Example 15 includes the circuit of any one of Examples 1 through 8, wherein the load sharing circuit includes an impedance divider coupled between the amplifier output and a ground terminal, the impedance divider having an output coupled to the first output of the load sharing circuit. In some such examples, the amplifier output is coupled to the output signal terminal without an intervening impedance divider. For instance, the amplifier output may be coupled directly to the output signal terminal.

Example 16 includes the circuit of any one of Examples 1 through 15, wherein the pass element is a first pass element (which in some examples is, for instance, an internal pass element), the circuit comprising a second pass element (which in some examples is, for instance, an external pass element) coupled between the input voltage terminal and the output voltage terminal, and having a control terminal coupled to the output signal terminal. In some such examples (e.g., Example 15), the second pass element is weaker than the first pass element. For instance, in some such examples, each of the first and second pass elements may be, for example, an n-channel FET, and the threshold voltage of the first pass element is less than the threshold voltage of the second pass element. In other such examples, each of the first and second pass elements is an NPN BJT, and the threshold voltage of the first pass element is less than the threshold voltage of the second pass element. In still other such examples, one of the first and second pass elements is an NPN BJT, and the other of the first and second pass elements is an n-channel FET, and the threshold voltage of the first pass element is less than the threshold voltage of the second pass element.

Example 17 includes the circuit of any one of Examples 1 through 16, wherein the pass element is constrained to be stronger than any external pass element to be coupled to the output signal terminal.

Example 18 includes the circuit of any one of Examples 1 through 8 and 15 through 17, and further includes a voltage source coupled between the amplifier output and the control terminal of the pass element, or between the amplifier output and the output signal terminal.

Example 19 includes the circuit of Example 18, wherein the voltage source is configured to adjust one of a control voltage at the control terminal of the pass element upward or downward, or a control voltage at the output signal terminal upward or downward, and wherein the voltage source includes a resistor circuit having a calibrated resistance value and a current source having a current value, and wherein the current value was used to determine the calibrated resistance.

Example 20 includes the circuit of Example 18 or 19, wherein the voltage source is included in the calibration circuit and is coupled between the amplifier output and the first output of the load sharing circuit, or between the amplifier output and the second output of the load sharing circuit.

Example 21 includes the circuit of any one of Examples 1 through 20, wherein the error amplifier is configured to generate a drive voltage based on a feedback voltage at the feedback voltage terminal and a reference voltage at the reference voltage terminal.

Example 22 is a system that includes: the circuit of any one of Examples 1 through 21, wherein the pass element is a first pass element (which may be, for instance, an internal pass element); a second pass element (which may be, for instance, an external pass element) coupled between the input voltage terminal and the output voltage terminal, and having a control terminal connected to the output signal terminal. In some such examples, the system further includes a power supply coupled to the input voltage terminal, and/or a load coupled to the output voltage terminal.

Example 23 is a circuit comprising: an input voltage terminal; an output voltage terminal; a feedback voltage terminal; an output signal terminal; a pass element coupled between the input voltage terminal and the output voltage terminal, and having a control terminal, the pass element being an n-type pass element; an error amplifier configured to generate an error amplifier output voltage based on a feedback voltage at the feedback voltage terminal and a reference voltage; a first impedance divider including a first variable impedance and configured to generate a first drive voltage at the control terminal of the pass element, based on the error amplifier output voltage; and a second impedance divider including a second variable impedance and configured to generate a second drive voltage at the output signal terminal, based on the error amplifier output voltage.

Example 24 includes the circuit of Example 23, wherein: the error amplifier has a first amplifier input, a second amplifier input, and an amplifier output, wherein the first amplifier input is coupled to a reference voltage terminal, and the second amplifier input is coupled to the feedback voltage terminal; the first impedance divider is coupled between the amplifier output and a ground terminal, and includes an output coupled to the control terminal of the pass element, the first variable impedance coupled between the output of the first impedance divider and the ground terminal; and the second impedance divider is coupled between the amplifier output and the ground terminal, and includes an output coupled to the output signal terminal, the second variable impedance coupled between the amplifier output and the output of the second impedance divider.

Example 25 includes the circuit of Example 23 or 24, wherein: each of the first and second drive voltages is associated with a rate of change relative to changes in the error amplifier output voltage; and the rate of change of the first drive voltage decreases as the rate of change of the second drive voltage increases.

Example 26 includes the circuit of any one of Examples 23 through 25, wherein: a first gain between the amplifier output and the control terminal of the pass element decreases relative to increases in the error amplifier output voltage; and a second gain between the amplifier output and the output signal terminal increases relative to increases in the error amplifier output voltage.

Example 27 includes the circuit of any one of Examples 23 through 26, wherein: the circuit is configured to provide a load current to the output voltage terminal; responsive to the load current being less than or equal to a first current threshold, the circuit provides substantially all of the load current via the pass element; responsive to the load current being greater than a second current threshold, the circuit limits current provided via the pass element, the second current threshold being greater than the first current threshold; and responsive to the load current being greater than the first current threshold, the first and second impedance dividers cause a first portion of the load current to be provided via the pass element, and a second portion of the load current to be provided via an n-type external pass element.

Example 28 includes the circuit of any one of Examples 23 through 27, and further includes the n-type external pass element, wherein the external n-type pass element is coupled between the input voltage terminal and the output voltage terminal, and has a control terminal connected to the output signal terminal.

Example 29 includes the circuit of Example 28, wherein: each of the pass element and the external pass element is an n-channel field effect transistor or an NPN bipolar junction transistor; or one of the pass element and the external pass element is an n-channel field effect transistor and the other of the pass element and the external pass element is an NPN bipolar junction transistor.

Example 30 is a system comprising: a first n-type pass element coupled between an input voltage terminal and an output voltage terminal, and having a control terminal; a second n-type pass element coupled between the input voltage terminal and the output voltage terminal, and having a control terminal; an error amplifier having a first amplifier input, a second amplifier input, and an amplifier output, wherein the first amplifier input is coupled to a reference voltage terminal, and the second amplifier input is coupled to a feedback voltage terminal; a first impedance divider coupled between the amplifier output and a ground terminal, and including an output coupled to the control terminal of the first n-type pass element, the first impedance divider further including a first variable impedance coupled between the output of the first impedance divider and the ground terminal; and a second impedance divider coupled between the amplifier output and the ground terminal, and including an output coupled to the control terminal of the second n-type pass element, the second impedance divider further including a second variable impedance coupled between the amplifier output and the output of the second impedance divider.

Example 31 includes the system of Example 30, and further includes a power supply coupled to the input voltage terminal.

Example 32 includes the system of Example 30 or 31, and further includes a load coupled to the output voltage terminal.

Example 33 includes the system of any one of Examples 30 through 32, and further includes an electronic system, which may be coupled, for instance, between the output voltage terminal and the ground terminal.

Example 34 includes the system of Example 33, wherein the electronic system is an automotive electronic system. For instance, in one such example, the automotive electronic system is a camera system.

Example 35 includes the system of Example 33, wherein the electronic system is a control system. For instance, in one such example, the control system is a radar electronic control unit.

Example 36 includes the system of Example 33, wherein the electronic system is a medical system. For instance, in one such example, the medical system is an electrocardiogram system.

Example 37 includes the system of any one of Examples 30 through 36, wherein each of the first n-type pass element, the error amplifier, the first impedance divider, and the second impedance divider are included in an integrated circuit chip, and the second n-type pass element is external to the integrated circuit chip.

Example 38 is a circuit, comprising: an input voltage terminal; an output voltage terminal; a feedback voltage terminal; an output signal terminal; a pass element coupled between the input voltage terminal and the output voltage terminal, and having a control terminal; an error amplifier having a first amplifier input, a second amplifier input, and an amplifier output, wherein the first amplifier input is coupled to a reference voltage terminal, and the second amplifier input is coupled to the feedback voltage terminal; and a load sharing circuit having an input, a first output, and a second output, wherein the input of the load sharing circuit is coupled to the amplifier output, the first output of the load sharing circuit is coupled to the control terminal of the pass element, and the second output of the load sharing circuit is coupled to the output signal terminal. In some such examples, the pass element is a p-type pass element.

Example 39 includes the circuit of Example 38, wherein: the load sharing circuit is configured to generate first and second drive voltages at the first and second outputs of the load sharing circuit, respectively, based on a drive voltage generated by the error amplifier; each of the first and second drive voltages is associated with a rate of change relative to changes in the drive voltage generated by the error amplifier; and the rate of change of the first drive voltage decreases as the rate of change of the second drive voltage increases.

Example 40 includes the circuit of Example 38 or 39, wherein: the load sharing circuit is configured to generate first and second drive voltages at the first and second outputs of the load sharing circuit, respectively, based on a drive voltage generated by the error amplifier; a first gain between the amplifier output and the first output of the load sharing circuit decreases relative to decreases in the drive voltage generated by the error amplifier; and a second gain between the amplifier output and the second output of the load sharing circuit increases relative to decreases in the drive voltage generated by the error amplifier.

Example 41 includes the circuit of any one of Examples 38 through 40, wherein: the load sharing circuit is configured to generate first and second drive voltages at the first and second outputs of the load sharing circuit, respectively, based on a drive voltage generated by the error amplifier; responsive to the first drive voltage at the first output of the load sharing circuit dropping below a first threshold voltage, the load sharing circuit is configured to decrease a rate of change of the first drive voltage relative to changes in the drive voltage generated by the error amplifier; and responsive to the first drive voltage at the first output of the load sharing circuit dropping below a second threshold voltage, the load sharing circuit is configured to increase a rate of change of the second drive voltage relative to changes in the drive voltage generated by the error amplifier.

Example 42 includes the circuit of any one of Examples 38 through 41, wherein: the circuit is configured to provide a load current to the output voltage terminal; responsive to the load current being less than or equal to a first current threshold, the load sharing circuit is configured to provide substantially all of the load current via the pass element; and responsive to the load current being greater than a second current threshold, the load sharing circuit is configured to limit current provided via the pass element, the second current threshold being greater than the first current threshold.

Example 43 includes the circuit of Example 42, wherein: responsive to the load current being greater than the first current threshold, the load sharing circuit is configured to provide a first portion of the load current via the pass element, and to control an external pass element to provide a second portion of the load current.

Example 44 includes the circuit of Example 43, and further includes the external pass element, wherein the external pass element is coupled between the input voltage terminal and the output voltage terminal, and has a control terminal connected to the output signal terminal, such that the second portion of the load current is provided by the external pass element. In some such cases, the external pass element is a p-type pass element. In some such examples, for instance, the elements of Example 1 are on or otherwise part of an integrated circuit die within an integrated circuit package (e.g., ceramic flat pack with leads, ball grid array, etc.), and the external pass element is external to that integrated circuit package. In other examples, the elements of Example 1 are on or otherwise part of a printed circuit board (e.g., single-sided, double-sided, multilayer, flexible, etc.), and the external pass element is external to that printed circuit board. Still other examples may be configured differently. To this end, the level of integration may vary from one example to the next.

Example 45 includes the circuit of Example 44, wherein: each of the pass element and the external pass element is a p-channel field effect transistor or a PNP bipolar junction transistor; or one of the pass element and the external pass element is a p-channel field effect transistor and the other of the pass element and the external pass element is a PNP bipolar junction transistor.

Example 46 includes the circuit of any one of Examples 38 through 45, wherein the load sharing circuit comprises: a first impedance divider coupled between the amplifier output and the input voltage terminal, the first impedance divider including an output coupled to the first output of the load sharing circuit; and a second impedance divider coupled between the amplifier output and the input voltage terminal, the second impedance divider including an output coupled to the output signal terminal.

Example 47 includes the circuit of Example 46, wherein: the first impedance divider includes a first variable impedance coupled between the output of the first impedance divider and the input voltage terminal; and the second impedance divider includes a second variable impedance coupled between the amplifier output and the output of the second impedance divider.

Example 48 includes the circuit of Example 47, wherein the first variable impedance includes a first field effect transistor (FET), and the second variable impedance includes a second FET. In some such examples, the load sharing circuit comprises: a resistor coupled between the amplifier output and a source terminal of the first FET, the resistor and the first FET providing the first impedance divider; and a pull-up circuit coupled between the output signal terminal and the input voltage terminal, the pull-up circuit and the second FET providing the second impedance divider. In some such examples, the resistor is a first resistor, and the pull-up circuit comprises a second resistor and/or a current source.

Example 49 includes the circuit of Example 48, wherein the resistor is a first resistor, and the load sharing circuit comprises one or more of the following: a current source coupled between the input voltage terminal and the feedback voltage terminal; a second resistor coupled between the current source and the feedback voltage terminal, and having first and second resistor terminals, the first resistor terminal coupled to the current source; a third FET coupled between the second resistor and the feedback voltage terminal, the third FET having a gate terminal coupled to the first resistor terminal, a drain terminal coupled to the second resistor terminal, and a source terminal coupled to the feedback voltage terminal; and a fourth FET coupled between the input voltage terminal and the feedback voltage terminal, the fourth FET having gate and drain terminals coupled to the source terminal of the third FET, and a source terminal coupled to the input voltage terminal; wherein the gate terminal of the first FET is coupled to the first resistor terminal, and the gate terminal of the second FET is coupled to the second resistor terminal. In some such examples: the pass element is the same type as the fourth FET, but N times larger, N being an integer of 2 or more; the first FET and the third FET are the same type; and the second FET and the third FET are the same type.

Example 50 includes the circuit of Example 49, wherein the error amplifier has an output stage, the circuit comprising: a capacitor coupled between the input voltage terminal and the output stage of the error amplifier; and a fifth FET coupled between the input voltage terminal and the capacitor, and having a gate terminal coupled to the control terminal of the pass element and a source terminal coupled to the input voltage terminal.

Example 51 includes the circuit of Example 47 or 48, wherein the load sharing circuit comprises: a first comparator circuit configured to control the first variable impedance; and a second comparator circuit configured to control the second variable impedance. In some such examples: the first comparator circuit has a first comparator input coupled to the first output of the load sharing circuit, and a first comparator output coupled to the gate terminal of the first FET; and the second comparator circuit has a second comparator input coupled to the first output of the load sharing circuit, and a second comparator output coupled to the gate terminal of the second FET.

Example 52 includes the circuit of any one of Examples 38 through 45, wherein the load sharing circuit includes an impedance divider coupled between the amplifier output and the input voltage terminal, the impedance divider having an output coupled to the first output of the load sharing circuit. In some such examples, the amplifier output is coupled to the output signal terminal without an intervening impedance divider. For instance, the amplifier output may be coupled directly to the output signal terminal.

Example 53 includes the circuit of any one of Examples 38 through 52, wherein the pass element is a first pass element (which in some examples is, for instance, an internal pass element), the circuit comprising a second pass element (which in some examples is, for instance, an external pass element) coupled between the input voltage terminal and the output voltage terminal, and having a control terminal coupled to the output signal terminal. In some such examples (e.g., Example 52), the second pass element is weaker than the first pass element. For instance, in some such examples, each of the first and second pass elements may be, for example, a p-channel FET, and the threshold voltage of the first pass element is less than the threshold voltage of the second pass element. In other such examples, each of the first and second pass elements is a PNP BJT, and the threshold voltage of the first pass element is less than the threshold voltage of the second pass element. In still other such examples, one of the first and second pass elements is a PNP BJT, and the other of the first and second pass elements is a p-channel FET, and the threshold voltage of the first pass element is less than the threshold voltage of the second pass element.

Example 54 includes the circuit of any one of Examples 38 through 53, wherein the pass element is constrained to be stronger than any external pass element to be coupled to the output signal terminal.

Example 55 includes the circuit of any one of Examples 38 through 45 and 52 through 54, and further includes a voltage source coupled between the amplifier output and the control terminal of the pass element, or between the amplifier output and the output signal terminal.

Example 56 includes the circuit of Example 55, wherein the voltage source is configured to adjust one of a control voltage at the control terminal of the pass element upward or downward, or a control voltage at the output signal terminal upward or downward, and wherein the voltage source includes a resistor circuit having a calibrated resistance value and a current source having a current value, and wherein the current value was used to determine the calibrated resistance.

Example 56 includes the circuit of Example 55 or 56, wherein the voltage source is included in the calibration circuit and is coupled between the amplifier output and the first output of the load sharing circuit, or between the amplifier output and the second output of the load sharing circuit.

Example 57 includes the circuit of any one of Examples 38 through 56, wherein the error amplifier is configured to generate a drive voltage based on a feedback voltage at the feedback voltage terminal and a reference voltage at the reference voltage terminal.

Example 58 is a system that includes: the circuit of any one of Examples 38 through 57, wherein the pass element is a first pass element (which may be, for instance, an internal pass element); a second pass element (which may be, for instance, an external pass element) coupled between the input voltage terminal and the output voltage terminal, and having a control terminal connected to the output signal terminal. In some such examples, the system further includes a power supply coupled to the input voltage terminal, and/or a load coupled to the output voltage terminal.

Example 59 is a circuit comprising: an input voltage terminal; an output voltage terminal; a feedback voltage terminal; an output signal terminal; a pass element coupled between the input voltage terminal and the output voltage terminal, and having a control terminal, the pass element being a p-type pass element; an error amplifier configured to generate an error amplifier output voltage based on a feedback voltage at the feedback voltage terminal and a reference voltage; a first impedance divider including a first variable impedance and configured to generate a first drive voltage at the control terminal of the pass element, based on the error amplifier output voltage; and a second impedance divider including a second variable impedance and configured to generate a second drive voltage at the output signal terminal, based on the error amplifier output voltage.

Example 60 includes the circuit of Example 59, wherein: the error amplifier has a first amplifier input, a second amplifier input, and an amplifier output, wherein the first amplifier input is coupled to a reference voltage terminal, and the second amplifier input is coupled to the feedback voltage terminal; the first impedance divider is coupled between the amplifier output and the input voltage terminal, and includes an output coupled to the control terminal of the pass element, the first variable impedance coupled between the output of the first impedance divider and the input voltage terminal; and the second impedance divider is coupled between the amplifier output and the input voltage terminal, and includes an output coupled to the output signal terminal, the second variable impedance coupled between the amplifier output and the output of the second impedance divider.

Example 61 includes the circuit of Example 59 or 60, wherein: each of the first and second drive voltages is associated with a rate of change relative to changes in the error amplifier output voltage; and the rate of change of the first drive voltage decreases as the rate of change of the second drive voltage increases.

Example 62 includes the circuit of any one of Examples 59 through 61 wherein: a first gain between the amplifier output and the control terminal of the pass element decreases relative to decreases in the error amplifier output voltage; and a second gain between the amplifier output and the output signal terminal increases relative to decreases in the error amplifier output voltage.

Example 63 includes the circuit of any one of Examples 59 through 62, wherein: the circuit is configured to provide a load current to the output voltage terminal; responsive to the load current being less than or equal to a first current threshold, the circuit provides substantially all of the load current via the pass element; responsive to the load current being greater than a second current threshold, the circuit limits current provided via the pass element, the second current threshold being greater than the first current threshold; and responsive to the load current being greater than the first current threshold, the first and second impedance dividers cause a first portion of the load current to be provided via the pass element, and a second portion of the load current to be provided via a p-type external pass element.

Example 64 includes the circuit of any one of Examples 59 through 63, and further includes the n-type external pass element, wherein the external n-type pass element is coupled between the input voltage terminal and the output voltage terminal, and has a control terminal connected to the output signal terminal.

Example 65 includes the circuit of Example 64, wherein: each of the pass element and the external pass element is a p-channel field effect transistor or a PNP bipolar junction transistor; or one of the pass element and the external pass element is a p-channel field effect transistor and the other of the pass element and the external pass element is a PNP bipolar junction transistor.

Example 66 is a system comprising: a first p-type pass element coupled between an input voltage terminal and an output voltage terminal, and having a control terminal; a second p-type pass element coupled between the input voltage terminal and the output voltage terminal, and having a control terminal; an error amplifier having a first amplifier input, a second amplifier input, and an amplifier output, wherein the first amplifier input is coupled to a reference voltage terminal, and the second amplifier input is coupled to a feedback voltage terminal; a first impedance divider coupled between the amplifier output and the input voltage terminal, and including an output coupled to the control terminal of the first p-type pass element, the first impedance divider further including a first variable impedance coupled between the output of the first impedance divider and the input voltage terminal; and a second impedance divider coupled between the amplifier output and the input voltage terminal, and including an output coupled to the control terminal of the second p-type pass element, the second impedance divider further including a second variable impedance coupled between the amplifier output and the output of the second impedance divider.

Example 67 includes the system of Example 66, and further includes a power supply coupled to the input voltage terminal.

Example 68 includes the system of Example 66 or 67, and further includes a load coupled to the output voltage terminal.

Example 69 includes the system of any one of Examples 66 through 38, and further includes an electronic system, which may be coupled, for instance, between the output voltage terminal and the ground terminal.

Example 70 includes the system of Example 69, wherein the electronic system is an automotive electronic system. For instance, in one such example, the automotive electronic system is a camera system.

Example 71 includes the system of Example 69, wherein the electronic system is a control system. For instance, in one such example, the control system is a radar electronic control unit.

Example 72 includes the system of Example 69, wherein the electronic system is a medical system. For instance, in one such example, the medical system is an electrocardiogram system.

Example 73 includes the system of any one of Examples 66 through 72, wherein each of the first p-type pass element, the error amplifier, the first impedance divider, and the second impedance divider are included in an integrated circuit chip, and the second p-type pass element is external to the integrated circuit chip.

Example 74 is a circuit comprising: an input voltage terminal; an output voltage terminal; an output signal terminal; an error amplifier having an amplifier output; a pass element coupled between the input voltage terminal and the output voltage terminal, and having a control terminal and a threshold voltage; and a calibration circuit configured to determine the difference between the pass element threshold voltage and an external pass element threshold voltage.

Example 75 includes the circuit of Example 74, and further includes an external pass element having the external pass element threshold voltage and coupled between the input voltage terminal and the output voltage terminal, the external pass element having its control terminal coupled to the output signal terminal.

Example 76 includes the circuit of Example 74 or 75, wherein, in determining the difference between the pass element threshold voltage and the external pass element threshold voltage, the calibration circuit is configured to incrementally adjust a resistance value of a resistor circuit while a current flows through the resistor circuit, until a voltage output of the resistor circuit is within a tolerance of the external pass element threshold voltage.

Example 77 includes the circuit of Example 76, wherein the calibration circuit is further configured to store a final resistance value of the resistor circuit, or a representation of the final resistance value, the final resistance value being the resistance value that causes the voltage output of the resistor circuit to be within the tolerance of the external pass element threshold voltage.

Example 78 includes the circuit of any one of Examples 74 through 77, wherein the calibration circuit includes: an adjustable resistor circuit; and a controller configured to adjust a resistance value of the adjustable resistor circuit until the difference between the pass element threshold voltage relevant and the external pass element threshold voltage is within a tolerance, while a load is connected at the output voltage terminal.

Example 79 includes the circuit of any one of Examples 74 through 78, wherein the calibration circuit further includes: a memory configured to store a representation of a final resistance value of the adjustable resistor circuit, the final resistance value being the resistance value that causes the difference between the pass element threshold voltage relevant and the external pass element threshold voltage to be within the tolerance.

Example 79 includes the circuit of any one of Examples 74 through 79, wherein the calibration circuit includes: a load coupled between the output voltage terminal and a ground terminal; a current source coupled between the input voltage terminal and the output voltage terminal, and having a current value; a variable resistor circuit coupled between the current source and the ground terminal and having a resistance value that can be adjusted; a control circuit configured to incrementally adjust the resistance value of the variable resistor circuit while a current having the current value flows through the variable resistor circuit, until a voltage provided by the variable resistor circuit is within a tolerance of the external pass element threshold voltage; and a comparator circuit configured to determine when the voltage provided by the variable resistor circuit is within the tolerance of the external pass element threshold voltage.

Example 80 includes the circuit of Example 79, wherein the variable resistor circuit includes a first voltage output and a second voltage output, the first voltage output for providing incrementally increasing voltage values, and the second voltage output for providing incrementally decreasing voltage values, and the calibration circuit further includes: a multiplexer having first and second multiplexer inputs and a multiplexer output, the first multiplexer input coupled to the first voltage output of the variable resistor circuit, the second multiplexer input coupled to the second voltage output of the variable resistor circuit, and the multiplexer output coupled to an input of the comparator circuit, wherein the multiplexer is configured to pass voltage at its first voltage input to the multiplexer output responsive to the pass element threshold voltage being less than the external pass element threshold voltage, and wherein the multiplexer is configured to pass voltage at its second voltage input to the multiplexer output responsive to the pass element threshold voltage being greater than the external pass element threshold voltage.

Example 81 includes the circuit of Example 80, wherein the input of the comparator circuit is a first input of the comparator circuit, the comparator circuit having a second input coupled to the output signal terminal.

Example 82 includes the circuit of any one of Examples 74 through 81, wherein the calibration circuit includes: an internal load coupled between the output voltage terminal; a current source coupled between the input voltage terminal and the output voltage terminal, for providing a current; a field effect transistor (FET) coupled between the current source and the output voltage terminal, and having a source terminal coupled to the output voltage terminal; a first variable resistor circuit coupled between the current source and the FET, a first terminal of the first variable resistor circuit being coupled to the current source, and a second terminal of the first variable resistor circuit being coupled to a gate terminal of the FET; a second variable resistor circuit coupled between the first variable resistor circuit and the FET, a first terminal of the second variable resistor circuit being coupled to the second terminal of the first variable resistor circuit, and a second terminal of the second variable resistor circuit being coupled to a drain terminal of the FET; a multiplexer having first and second multiplexer inputs and a multiplexer output, the first multiplexer input coupled to the first terminal of the first variable resistor circuit, the second multiplexer input coupled to the second terminal of the second variable resistor circuit; and a comparator circuit having first and second comparator inputs and a comparator output, the first comparator input coupled to the comparator output, the second comparator input coupled to the output signal terminal, and the comparator output toggles from a first state to a second state responsive to the difference between the pass element threshold voltage and the external pass element threshold voltage being within a tolerance.

Example 83 includes the circuit of Example 82, wherein the calibration circuit further includes a controller configured to: incrementally adjust one of the first or second variable resistor circuits while the current flows through the one of the first and second variable resistor circuits, until an output voltage of the one of the first and second variable resistor circuits is within a tolerance of the external pass element threshold voltage; and responsive to the comparator output toggling from the first state to the second state, store a variable that corresponds to a current resistance value the one of the first and second variable resistor circuits.

Example 84 is a circuit comprising: an input voltage terminal; an output voltage terminal; a feedback voltage terminal; an output signal terminal; a pass element coupled between the input voltage terminal and the output voltage terminal, and having a control terminal; an error amplifier having a first amplifier input, a second amplifier input, and an amplifier output, wherein the first amplifier input is coupled to a reference voltage terminal, and the second amplifier input is coupled to the feedback voltage terminal; and a load sharing circuit having an input, a first output, and a second output, wherein the input of the load sharing circuit is coupled to the amplifier output, the first output of the load sharing circuit is coupled to the control terminal of the pass element, and the second output of the load sharing circuit is coupled to the output signal terminal, wherein the load sharing circuit includes an impedance divider coupled between the amplifier output and one of a ground terminal or the input voltage terminal, the impedance divider having an output coupled to the first output of the load sharing circuit.

Example 85 includes the circuit of Example 84, wherein: the circuit is configured to provide a load current to the output voltage terminal; responsive to the load current being less than or equal to a first current threshold, the load sharing circuit is configured to provide substantially all of the load current via the pass element; responsive to the load current being greater than a second current threshold, the load sharing circuit is configured to limit current provided via the pass element, the second current threshold being greater than the first current threshold; and responsive to the load current being greater than the first current threshold, the load sharing circuit is configured to provide a first portion of the load current via the pass element, and to control an external pass element to provide a second portion of the load current.

Example 86 includes the circuit of Example 85, and further includes the external pass element, wherein the external pass element is coupled between the input voltage terminal and the output voltage terminal, and has a control terminal connected to the output signal terminal, such that the second portion of the load current is provided by the external pass element. In some such examples, the external pass element may be external to an integrated circuit or printed circuit board that includes pass element (which may be referred to as an internal pass element).

Example 87 includes the circuit of Example 86, wherein each of the pass element and the external pass element is an n-type transistor device, or each of the pass element and the external pass element is a p-type transistor device.

Example 88 includes the circuit of Example 86 or 87, wherein: each of the pass element and the external pass element is an n-channel field effect transistor or an NPN bipolar junction transistor; or each of the pass element and the external pass element is a p-channel field effect transistor or a PNP bipolar junction transistor; or one of the pass element and the external pass element is an n-channel field effect transistor and the other of the pass element and the external pass element is an NPN bipolar junction transistor; or one of the pass element and the external pass element is a p-channel field effect transistor and the other of the pass element and the external pass element is a PNP bipolar junction transistor.

Example 89 includes the circuit of any one of Examples 84 through 88, wherein the amplifier output is coupled to the output signal terminal without an intervening impedance divider.

Example 90 includes the circuit of any one of Examples 84 through 89, wherein the amplifier output is coupled directly to the output signal terminal.

Example 91 includes the circuit of any one of Examples 84 through 90, and further includes a voltage source coupled between the amplifier output and the control terminal of the pass element, or between the amplifier output and the output signal terminal. In some such examples, the voltage source is configured to adjust one of a control voltage at the control terminal of the pass element upward or downward, or a control voltage at the output signal terminal upward or downward.

Example 92 includes the circuit of Example 91, wherein the voltage source includes: a resistor circuit having a configurable resistance; and a current source having a current value.

Example 93 includes the circuit of any one of Examples 84 through 92, and further includes a calibration circuit configured to determine the difference between a threshold voltage of the pass element and a threshold voltage of an external pass element. In some such examples (such as Example 92), the calibration circuit is configured to determine a resistance setting for the resistor circuit using the current value, in determining the difference between the threshold voltage of the pass element and the threshold voltage of the external pass element.

Example 94 includes the circuit of Example 93, wherein the calibration circuit comprises: a variable resistor circuit coupled between the input voltage terminal and the ground terminal, and having a resistance value that can adjusted; a control circuit configured to incrementally adjust the resistance value of the variable resistor circuit while a current having the current value flows through the variable resistor circuit, until a voltage provided by the variable resistor circuit is within a tolerance of the threshold voltage of the external pass element; and a comparator circuit configured to indicate when the voltage provided by the variable resistor circuit is within the tolerance of the threshold voltage of the external pass element.

Example 95 includes the circuit of any one of Examples 84 through 94, wherein the error amplifier is configured to generate a drive voltage based on a feedback voltage at the feedback voltage terminal and a reference voltage at the reference voltage terminal.

Example 96 is a system that includes the circuit of any one of Examples 84 through 95, and further includes: a power supply coupled to the input voltage terminal; and/or a load coupled to the output voltage terminal.

Example 97 is a system that includes the circuit of any one of Examples 84 through 95 or the system of Example 96, and further includes an electronic system, which may be coupled, for instance, between the output voltage terminal and the ground terminal.

Example 98 includes the system of Example 97, wherein the electronic system is an automotive electronic system. For instance, in one such example, the automotive electronic system is a camera system.

Example 99 includes the system of Example 97, wherein the electronic system is a control system. For instance, in one such example, the control system is a radar electronic control unit.

Example 100 includes the system of Example 97, wherein the electronic system is a medical system. For instance, in one such example, the medical system is an electrocardiogram system.

Example 101 is a method for calibrating a voltage regulator system, the method comprising: disabling a first pass element coupled between an input voltage terminal of the voltage regulator system and an output voltage terminal of the voltage regulator system; generating a load current at the output voltage terminal, the load current passing through a second pass element coupled between the input voltage terminal and the output voltage terminal; determining a voltage difference between a threshold voltage of the first pass element and a threshold voltage of the second pass element; and applying the voltage difference to a control terminal of the first pass element or a control terminal of the second pass element.

Example 102 includes the method of Example 101, wherein the voltage difference between the threshold voltage of the first pass element and the threshold voltage of the second pass element is determined by: incrementally adjusting a resistance value of a resistor circuit while a current flows through the resistor circuit, until a voltage output of the resistor circuit is within a tolerance of the second pass element threshold voltage.

Example 103 includes the method of Example 102, and further includes: storing the resistance value of the resistor circuit that corresponds to the voltage output of the resistor circuit being within the tolerance of the second pass element threshold voltage, or a representation of that resistance value.

Example 104 includes the method of any one of Examples 101 through 103, wherein determining the voltage difference between the threshold voltage of the first pass element and the threshold voltage of the second pass element includes: adjusting a resistance value of a variable resistor circuit until the difference between the first pass element threshold voltage and the second pass element threshold voltage is within a tolerance, while the load current is passing through the second pass element; and storing a representation of a final resistance value, the final resistance value being the resistance value that causes the difference between the first pass element threshold voltage and the second pass element threshold voltage to be within the tolerance.

Example 105 is a method for providing a load current to an electronic system, the method comprising: responsive to the load current being less than or equal to a first current threshold, providing all of the load current via a first pass element; responsive to the load current being greater than the first current threshold, providing a first portion of the load current via the first pass element and a remaining portion of the load current via a second pass element; and responsive to the load current being greater than a second current threshold, limiting the first portion of the load current provided by the first pass element to a maximum current level associated with the first pass element, the second current threshold being greater than the first current threshold.

Example 106 includes the method of Example 105, wherein the first pass element is included in an integrated circuit chip, and the second pass element is external to the integrated circuit chip. In some cases, the integrated circuit chip comprises a low-dropout (LDO) voltage regulator.

Example 107 includes the method of Example 105 or 106, wherein each of the first and second pass elements has a control terminal, and wherein: responsive to the load current being less than or equal to the first current threshold, the method includes applying a first voltage to the control terminal of the first pass element so that the first pass element provides all of the load current, and applying a second voltage to the control terminal of the second pass element so that the second pass element provides none of the load current.

Example 108 includes the method of any one of Examples 105 through 107, wherein each of the first and second pass elements has a control terminal, and wherein: responsive to the load current being greater than the first current threshold, the method includes applying a first voltage to the control terminal of the first pass element so that the first pass element provides a first portion of the load current, and applying a second voltage to the control terminal of the second pass element so that the second pass element provides a second or remainder portion of the load current.

Example 109 includes the method of any one of Examples 105 through 108, wherein each of the first pass element and the second pass element is an n-type transistor device.

Example 110 includes the method of any one of Examples 105 through 108, wherein each of the first pass element and the second pass element is a p-type transistor device.

Example 111 is a low-dropout (LDO) voltage regulator that: includes the circuit of any of Examples 1 through 21, 23 through 29, 38 through 57, 59 through 65, and 74 through 95; or is included in the system of any of Examples 22, 30 through 37, 58, 66 through 73, and 96 through 100; or is configured to carry out the method of any of Examples 101 through 110. Other examples may use other voltage regulators.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device, or a semiconductor component. Furthermore, a voltage rail or more simply a “rail,” may also be referred to as a voltage terminal and may generally mean a common node or set of coupled nodes in a circuit at the same potential.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, such as by an end user and/or a third party.

While the use of particular transistors is described herein, other transistors (or equivalent devices) may be used instead. For example, a p-channel field effect transistor (PFET) may be used in place of an n-channel field effect transistor (NFET) with little or no changes to the circuit. Furthermore, other types of transistors may be used (such as bipolar junction transistors (BJTs)). Furthermore, the devices may be implemented in/over a silicon substrate (S₁), a silicon carbide substrate (SiC), a gallium nitride substrate (GaN) or a gallium arsenide substrate (GaAs). Moreover, reference to transistor features such as gate, source, or drain is not intended to exclude any suitable transistor technologies. For instance, features such as source, drain, and gate are typically used to refer to a FET, while emitter, collector, and base are typically used to refer to a BJT. Such features may be used interchangeably herein. For instance, reference to the gate of a transistor may refer to either the gate of a FET or the base of a BJT, and vice-versa. In some examples, a control terminal may refer to either the gate of a FET or the base of a BJT. Any other suitable transistor technologies can be used. Any such transistors can be used as a switch, with the gate or base or other comparable feature acting as a switch select input that can be driven to connect the source and drain (or the emitter and collector, as the case may be).

References herein to a field effect transistor (FET) being “ON” (or a switch being closed) means that the conduction channel of the FET is present, and drain current may flow through the FET. References herein to a FET being “OFF” (or a switch being open) means that the conduction channel is not present, and drain current does not flow through the FET. A FET that is OFF, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter.

Modifications are possible in the described examples, and other examples are possible within the scope of the claims.

What is claimed is:

1. A circuit comprising:
an input voltage terminal;
an output voltage terminal;
an output signal terminal;
an error amplifier having an amplifier output;
a pass element coupled between the input voltage terminal and the output voltage terminal, and having a control terminal and a threshold voltage; and
a calibration circuit configured to determine the difference between the pass element threshold voltage and an external pass element threshold voltage.

2. The circuit of claim 1, wherein, in determining the difference between the pass element threshold voltage and the external pass element threshold voltage, the calibration circuit is configured to incrementally adjust a resistance value of a resistor circuit while a current flows through the resistor circuit, until a voltage output of the resistor circuit is within a tolerance of the external pass element threshold voltage.

3. The circuit of claim 2, wherein the calibration circuit is further configured to store a final resistance value of the resistor circuit, or a representation of the final resistance value, the final resistance value being the resistance value that causes the voltage output of the resistor circuit to be within the tolerance of the external pass element threshold voltage.

4. The circuit of claim 1, wherein the calibration circuit includes:
an adjustable resistor circuit; and
a controller configured to adjust a resistance value of the adjustable resistor circuit until the difference between the pass element threshold voltage relevant and the external pass element threshold voltage is within a tolerance, while a load is connected at the output voltage terminal.

5. The circuit of claim 4, wherein the calibration circuit further includes: a memory configured to store a representation of a final resistance value of the adjustable resistor circuit, the final resistance value being the resistance value that causes the difference between the pass element threshold voltage relevant and the external pass element threshold voltage to be within the tolerance.

6. The circuit of claim 1, wherein the calibration circuit includes:
a load coupled between the output voltage terminal and a ground terminal;
a current source coupled between the input voltage terminal and the output voltage terminal, and having a current value;
a variable resistor circuit coupled between the current source and the ground terminal and having a resistance value that can be adjusted;
a control circuit configured to incrementally adjust the resistance value of the variable resistor circuit while a current having the current value flows through the variable resistor circuit, until a voltage provided by the variable resistor circuit is within a tolerance of the external pass element threshold voltage; and
a comparator circuit configured to determine when the voltage provided by the variable resistor circuit is within the tolerance of the external pass element threshold voltage.

7. The circuit of claim 6, wherein the variable resistor circuit includes a first voltage output and a second voltage output, the first voltage output for providing incrementally increasing voltage values, and the second voltage output for providing incrementally decreasing voltage values, and the calibration circuit further includes:
a multiplexer having first and second multiplexer inputs and a multiplexer output, the first multiplexer input coupled to the first voltage output of the variable resistor circuit, the second multiplexer input coupled to the second voltage output of the variable resistor circuit, and the multiplexer output coupled to an input of the comparator circuit, wherein the multiplexer is configured to pass voltage at its first voltage input to the multiplexer output responsive to the pass element threshold voltage being less than the external pass element threshold voltage, and wherein the multiplexer is configured to pass voltage at its second voltage input to the multiplexer output responsive to the pass element threshold voltage being greater than the external pass element threshold voltage.

8. The circuit of claim 7, wherein the input of the comparator circuit is a first input of the comparator circuit, the comparator circuit having a second input coupled to the output signal terminal.

9. A circuit, comprising:
an input voltage terminal;
an output voltage terminal;
a feedback voltage terminal;
an output signal terminal;
a pass element coupled between the input voltage terminal and the output voltage terminal, and having a control terminal;
an error amplifier having a first amplifier input, a second amplifier input, and an amplifier output, wherein the first amplifier input is coupled to a reference voltage terminal, and the second amplifier input is coupled to the feedback voltage terminal; and
a load sharing circuit having an input, a first output, and a second output, wherein the input of the load sharing circuit is coupled to the amplifier output, the first output of the load sharing circuit is coupled to the control terminal of the pass element, and the second output of the load sharing circuit is coupled to the output signal terminal, wherein the load sharing circuit includes an impedance divider coupled between the amplifier output and one of a ground terminal or the input voltage terminal, the impedance divider having an output coupled to the first output of the load sharing circuit.

10. The circuit of claim 9, wherein:
the circuit is configured to provide a load current to the output voltage terminal;
responsive to the load current being less than or equal to a first current threshold, the load sharing circuit is configured to provide substantially all of the load current via the pass element;
responsive to the load current being greater than a second current threshold, the load sharing circuit is configured to limit current provided via the pass element, the second current threshold being greater than the first current threshold; and
responsive to the load current being greater than the first current threshold, the load sharing circuit is configured to provide a first portion of the load current via the pass element, and to control an external pass element to provide a second portion of the load current.

11. The circuit of claim 10, further comprising the external pass element, wherein the external pass element is coupled between the input voltage terminal and the output voltage terminal, and has a control terminal connected to the output signal terminal, such that the second portion of the load current is provided by the external pass element.

12. The circuit of claim 11, wherein each of the pass element and the external pass element is an n-type transistor device, or each of the pass element and the external pass element is a p-type transistor device.

13. The circuit of claim 11, wherein:
each of the pass element and the external pass element is an n-channel field effect transistor or an NPN bipolar junction transistor; or
each of the pass element and the external pass element is a p-channel field effect transistor or a PNP bipolar junction transistor; or
one of the pass element and the external pass element is an n-channel field effect transistor and the other of the pass element and the external pass element is an NPN bipolar junction transistor; or
one of the pass element and the external pass element is a p-channel field effect transistor and the other of the pass element and the external pass element is a PNP bipolar junction transistor.

14. The circuit of claim 9, wherein the amplifier output is coupled directly to the output signal terminal.

15. The circuit of claim 9, wherein the amplifier output is coupled to the output signal terminal without an intervening impedance divider.

16. The circuit of claim 9, comprising a voltage source coupled between the amplifier output and the control terminal of the pass element, or between the amplifier output and the output signal terminal.

17. A method for calibrating a voltage regulator system, the method comprising:
disabling a first pass element coupled between an input voltage terminal of the voltage regulator system and an output voltage terminal of the voltage regulator system;
generating a load current at the output voltage terminal, the load current passing through a second pass element coupled between the input voltage terminal and the output voltage terminal;
determining a voltage difference between a threshold voltage of the first pass element and a threshold voltage of the second pass element; and
applying the voltage difference to a control terminal of the first pass element or a control terminal of the second pass element.

18. The method of claim 17, wherein the voltage difference between the threshold voltage of the first pass element and the threshold voltage of the second pass element is determined by: incrementally adjusting a resistance value of a resistor circuit while a current flows through the resistor circuit, until a voltage output of the resistor circuit is within a tolerance of the second pass element threshold voltage.

19. The method of claim 18, comprising: storing the resistance value of the resistor circuit that corresponds to the voltage output of the resistor circuit being within the tolerance of the second pass element threshold voltage, or a representation of that resistance value.

20. The method of claim 17, wherein determining the voltage difference between the threshold voltage of the first pass element and the threshold voltage of the second pass element includes:
adjusting a resistance value of a variable resistor circuit until the difference between the first pass element threshold voltage and the second pass element threshold voltage is within a tolerance, while the load current is passing through the second pass element; and
storing a representation of a final resistance value, the final resistance value being the resistance value that causes the difference between the first pass element threshold voltage and the second pass element threshold voltage to be within the tolerance.
